(19) United States
(12) Patent Application Publication
(10) Pub. No.: US 2019/0242562 A1
(43) Pub. Date: Aug. 8, 2019

(54) The Power Station has Built-In LED-Unit(s) and USB Charger(s) for Desktop

(71) Applicant: TSENG-LU CHIEN, WALNUT, CA (US)

(72) Inventor: TSENG-LU CHIEN, WALNUT, CA (US)

(21) Appl. No.: 16/270,844

(22) Filed: Feb. 8, 2019

Related U.S. Application Data
(63) Continuation-in-part of application No. 15/972,798, filed on May 7, 2018, now Pat. No. 10,230,880.
Application No. 15/972,798 is a continuation-in-part of application No. 15/466,196, filed on Mar. 22, 2017.
Application No. 15/466,196 is a continuation-in-part of application No. 13/863,073, filed on Apr. 15, 2013, now abandoned.
Application No. 13/863,073 is a continuation-in-part of application No. 14/548,561, filed on Nov. 20, 2014.
Application No. 14/548,561 is a continuation-in-part of application No. 13/161,643, filed on Jun. 16, 2011, now Pat. No. 8,783,936.
Application No. 13/161,643 is a continuation-in-part of application No. 14/642,169, filed on Mar. 9, 2015.
Application No. 14/642,169 is a continuation-in-part of application No. 12/950,017, filed on Nov. 19, 2010, now Pat. No. 8,998,462.

(51) Int. Cl. F21V 23/02; F21V 19/02; F21V 19/00; F21S 6/00; H02J 7/00; F21V 17/02

(52) U.S. Cl. CPC F21V 23/023; F21V 19/02; F21V 17/02; F21S 6/003; H02J 7/0044; F21V 19/0015

(57) ABSTRACT

The desk or table or bed-side table top power-station or LED light device has fixed or detachable LED light-source(s) or LED-bulb(s) to supply at least one of area, indicator, status, accent, night light, sleep light, wake-up or back light illumination, and at least one of conductive-metal piece to supply or offer or charge AC or DC or AC-&-DC power the be-charged or be-supplied other products by built-in at least one of USB-charging-port(s) or Outlet-Port(s) or both. The said device has at least one optional additional function(s) to supply (1) air-flow/air-freshener/humility, (2) time/AM-PM/date/week/month/year/weather related data powered by separated DC battery, (3) illuminated cosmetic mirror(s) having at least one surface(s) with preferred magnify-times to enlarge be-reflected object(s) image, (4) wireless digital data including at least one of video or audio transmitting and/or receiving and/or display and/or replay, (5) wireless or wired to play audio, music, sound, (6) supply 2^{nd} or more LED illumination by motion/radar/photo sensor, or power fail, IC circuit for pre-determined design, (7) Incorporate with wireless blue-tooth, wifi, Zway, Zigbee, wifi and download APP software for setting, adjustment, program, taking, communication, (8) has built-in image or/and audio catching device including at camera or DV, or (9) other additional function(s) available from market place. The said desk top item or desk top power-station or desk top LED light device(s) get AC power source by AC-plug-wire and go through built-in or outside transformer AC-to-DC circuit and at least one of built-in DC-to-DC circuit(s) to get at least one or more same or different DC-current with USB-charging-port(s) needed; to distribute, arrange, supply to at least one of (i) LED light source, (ii) USB-charging port(s), (iii) at least one of additional function(s) operated by DC power select from (a) at least one of air-flow related items, (b) at least one of DC-to-DC distribute or arrange the separated DC battery power to time related items, (c) at least one of audio items to play music, sound, voice, (d) at least one of lighted cosmetic mirror, (e) at least one of time and alarm related item has AC-plug wire to supply AC power to built-in outlet(s) and desired DC power source to supply power to time related display, (f) at least 2^{nd} LED light source for accent or night or power fail or motion sensor or area/indicator/charging status/countdown sleep light/wake-up light functions. Wherein, the said desk top power-station or power-strips or LED light or time related items or alarm time items or cosmetic-mirror or air-flow light device has installation-kit to fix or install the desk or table or cabinet top items on anywhere of desk, table, side-bed table. (19g) and a plurality of additional receiving means, which may include a USB-unit(s) (19h), outlet-unit(s) (19i) (19j), internet-unit(s), adaptor-unit(s), other light means, or another light source with appropriate parts and accessories, or any conventional available receiving means, the USB-module having at least more than 2 surface(s) (e.g., surface (18c) on one side and the USB-unit(s) on the other side), each surface with its own special design.

FIGS. 43-49 show all kinds of desk top items which offer function(s), effects(s), performance(s) to people's eyes, nose, mouth, and ears so that people stay nearby for

a period of time as they work, rest, sleep, or stand. The desk top items each have LED means and a USB-unit(s) to charge other electric or digital data device(s) and are arranged to generate, exhibit, or provide light beams, a projected image, a time image, a clock, illumination, music, a power source, electric signals, photos, digital signals, air flow at a desired temperature, moisture, steam, smells, liquid, coffee/tea, and/or food, or to serve as any other conventional device that people will stay around for period of time while their other devices are charging. At least one of the desk top items may include an object which allows people to easily to reach, touch, operate, or manage the device, and in which LED means or an LED device are installed on or within a substrate(s), location, or place where people will stay for period of time, such
as a desk, table, bed, chair, land, grass, or wherever else people like to work, rest, sit, stand, or a take nap. As noted above, the desk top items may offer electric signals to carry out functions related to people's eyes, ear, nose, mouth, or body, such as illumination, sound, images, brightness, visual effects, smell, water, liquid, food, wind, moisture, airflow or any conventional functions of electric devices with built-in LED means, such as LED lighting, a clock, projector machine, film, digital photo frame, time display, air freshener, electric perfume freshener, moisturizer, electric fan, electric heater, electric steam spreader, electric cooler, electric air conditioner, or other conventionally available items that can be placed to let people easily reach, touch, operate, or manage the objects.

The desk top items of FIGS. 21-49 may be powered by a direct current (DC) power source or alternating current (AC) power source having appropriate electric parts and accessories or components, such as circuit means, IC means, sensor means, a motion sensor, timer means, time delay means, timer, resilient means, conductive means, transformer means, inverter means, adaptor means, wire means, prong means, UL listed adapter means, PIR means, infrared means, master power control means, and/or AC power outlet-unit(s) to offer electric power at a voltage (Volt) and amperage (Amp or ma) sufficient to achieve a desired charging time. The USB-unit(s) only serve as a power source for charging other electric or digital device(s) and do not have an electric data transfer function. If a plurality of USB-units are provided, the USB-units can be arranged to have different output power to charge different electric or digital data device(s). If additional outlet-units are provided the outlet-units may be AC outlet-unit(s) that serve as an AC power source.

Electric or digital data device(s) that may be charged by the USB-unit(s) include an MP3 or MP4 player, smart phone, computer, iPhone™, iPad™, video game, digital visual equipment, communication equipment, and other consumer electric products. The USB-unit or USB-module of the illustrated desktop items may be turned on or turned off for a predetermined time by switch means, sensor means, timer means, photo sensor means, motion means, time delay means, and/or master control power means. All receiving means in the desk top items, including USB-units or USB modules, may have a removable cover to allow kids or others to safely touch the items and prevent dust, or water from getting into the receiving means. The USB-unit or USB-module to charge other electric or digital device(s) can be removable from the desk top items and carried with people to use when people leave the desk top items. For this purpose, the USB-unit(s) or USB-module(s) can be disassembled from the desk top items and re-assembled into the said desk top items by quick connector means, adaptor means, assembly means, or fixing means, with each of the USB-unit(s) or USB-module(s) having its own safety certification(s) so that the individual USB-unit(s) or USB-module(s) can be tested by safety authorities and sold separately.

The USB-unit(s) includes an electric charging unit which has a USB-female receiving means to receive a USB-male prong to deliver electric power from the USB-female receiving means to the other device's USB-male prong. The preferred USB-female receiving means gets power from a power source and uses its circuit means to convert or transform the electric power to a desired waveform, voltage, and current sufficient to charge other electric or digital device(s) through the USB male means. The items of these embodiments may be in the form of LED lighting, an LED desk lamp, LED table lighting, LED lava light, LED projection light, LED time piece, LED electric fan, LED air freshener, LED indicator coffee machine, LED indicator sound device, and LED visual device. Although preferred embodiments of the present invention have been described in detail, it will be appreciated that alternative, same function, or equivalent items or devices may still fall within the scope of the current invention.

This application is a continuation-in-part of U.S. patent application Ser. No. 12/950,017, filed Nov. 29, 2010, Ser. No. 13/161,643, filed Jun. 16, 2011, and Ser. No. 12/117,227, filed May 27, 2011.

### Patent Filing History:

The current invention is continuously filing of co-pending filing

(#CCC-1=2010) U.S. Ser. No. 12/950,017 multiple surfaces LED light filed on Nov. 29, 2010 with rotating device has LED light device(s) and USB device and Outlets device built-in on the rotating substrate with more than one surface to offer multiple functions.
(# CCC-2010) U.S. Ser. No. 12/950,017 Filed Nov. 19, 2010 (Now is U.S. Pat. No. 8,998,462) FIGS. 40, 42, 43, 46-49 is identical with (# CCC) drawing and said current invention is CIP of the (# CCC) without any argument.

Which is continuously filing for

(# UU-2010) FIGS. 15a, 15b, 15c drawing is identical with co-inventor earlier parent filed case
(#UU-2010) U.S. Ser. No. 12/938,628 filed on Nov. 3, 2010 drawing and the said desktop power station (162) is as parent filed case without any question.
(#R-2007) U.S. Ser. No. 11/806,285, and (Inventor's #R) filed on May 31, 2007 which also a multiple functions LED light device which are the continuously filing of the
(#B-2005) U.S. Pat. No. 7,318,652 for multiple functions Wall Cover filed on Mar. 31, 2005. The current invention is continuously filing of
(#F-2005) U.S. Pat. No. 7,651,365 filed on Jan. 15, 2005 which is CIP of Oct. 1, 2004. It also the CIP of
(# A-2004) U.S. Pat. No. 7,810,985 file on Mar. 31, 2005 but it is CIP of Oct. 1, 2004 filing date too. All these patented or pending case all related to the Light source with Outlets device(s) which are part of the current invention features and got U.S. patents issues or co-pending. It is appreciated the all listed above patented or co-pending cases still treat as fall within the scope of current invention application and apply the priority terms for the current invention filing.

The current invention also continuously filing for

(#FFF-2011) U.S. Ser. No. 13/117,227 filed on May 27, 2011 for Universal Module has USB-Unit(s) or/and Outlet-unit(s) for variety of electric or digital-data device. This application is a continuation of
U.S. patent application Ser. No. 14/444,703, filed Dec. 31, 2013, which is a continuation of
U.S. patent application Ser. No. 13/161,643 filed on Jun. 16, 2011 now is U.S. Pat. No. 8,783,936 is incorporated by reference herein. This application is a continuation of
(#GGG-2011) U.S. patent application Ser. No. 13/161,643, filed Jun. 16, 2011 now is U.S. Pat. No. 8,783,936 incorporated by reference herein.

This application is subject matter in common with the inventor's

(#FFF-2011) U.S. patent application Ser. No. 13/117,227 filed on May 30, 2011, and entitled “Universal module of USB-unit or Outlet-units for electric or digital data device(s).”

The current invention is continuously filing of co-pending filing

(#CCC-2010) U.S. Ser. No. 12/950,017 Multiple surfaces has USB and LED light filed on Nov. 29, 2010 with rotating device has LED light device(s) and USB device and Outlets device built-in on the rotating substrate with more than one surface to offer multiple function.

This application also has subject matter in common with the inventor's

(#I-1=2009) U.S. patent application Ser. No. 12/502,661 filed on Jul. 14, 2009, Jan. 1, 2013 issued (Later than parent filing date)
(#J-2=2012) Ser. No. 12/292,580 filed on Nov. 21, 2008, Nov. 6, 2012 issued (Later than parent filing date)
(#M-1=2009) Ser. No. 12/566,322 filed on Sep. 24, 2009, Pending case
(#K-2006) Ser. No. 11/498,874 filed on Aug. 4, 2006, Pending case.
(#L-2013) Ser. No. 11/527,629 filed on Sep. 27, 2006, Oct. 1, 2013 issued (Later than parent filing date)
(#HH-2009) Ser. No. 12/622,000 filed on Nov. 19, 2009, May 17, 2013 issued (Later than parent filing date)
(#II-2009) Ser. No. 12/624,621 filed on, Nov. 6, 2012 issued (later than parent filing date)

This filing case is Continue of following parent filing case:

This application is a continuation of

(#GGG-11) U.S. Ser. No. 14/951,872 filed on Nov. 25, 2015, which is CIP of
(#GGG-10) U.S. Ser. No. 14/875,675 filed on Oct. 5, 2015 which is CIP of
(#GGG-9) U.S. Ser. No. 14/870,601 filed on Sep. 30, 2015 which is CIP of
(#GGG-8) U.S. Ser. No. 14/834,613 filed on Nov. 10, 2015 which is CIP of
(#GGG-7) U.S. Ser. No. 14/834,823 filed on Aug. 25, 2015 which is CIP of
(#GGG-6) U.S. Ser. No. 14/834,557 filed on Aug. 25, 2015 which is CIP of
(#GGG-5-1) U.S. Ser. No. 14/858,838 filed on Sep. 18, 2015 now is allowanced wait for issued, which is CIP of
(#GGG-5) U.S. Ser. No. 14/833,935 filed on Aug. 24, 2015 which is CIP of
(#GGG-4C) U.S. Ser. No. 14/827,810 filed on Aug. 17, 2015 which is CIP of
(#GGG-4) U.S. Ser. No. 14/827,810 filed on Aug. 17, 2015 now is U.S. Pat. No. 8,931,947 issued on Jan. 13, 2015 which is CIP of
(#GGG-3C) U.S. Ser. No. 14/643,026 filed on Mar. 10, 2015 which is CIP of
(#GGG-3) U.S. Ser. No. 14/144,703 filed on Dec. 31, 2013 which is CIP of
(#GGG-2C) U.S. Ser. No. 14/548,626 filed on Nov. 20, 2014 now U.S. Pat. No. 9,182,111 issued on Nov. 10, 2015 which is CIP of
(#GGG-2) U.S. Ser. No. 14/105,717 filed on Dec. 13, 2013 now U.S. Pat. No. 8,911,137 issued on Dec. 16, 2014 which is CIP of
(#GGG-1C) U.S. Ser. No. 14/548,861 filed on Nov. 20, 2014 which is CIP of
(#GGG-1) U.S. Ser. No. 14/105,607 filed on Dec. 13, 2013 now U.S. Pat. No. 8,915,608 issued on Dec. 23, 2014 which is CIP of
(#GGG-2011) U.S. Ser. No. 13/161,643 filed on Jun. 16, 2011 now is U.S. Pat. No. 8,783,936 issued on Jul. 22, 2014

The current invention are continuously filing of co-pending filing

U.S. Ser. No. 12/950,017 filed on Nov. 29, 2010 (#CCC) Multiple surface LED light with rotating kits has LED light device(s) and USB device and outlets device.

Which is continuously filing for

U.S. Ser. No. 11/806,285 filed on May 31, 2007 (#R-2007) A multiple function LED light device including the LED Plug-in light device has built-in additional functions including having conductive piece to supply power to other device such as outlet and/or USB and/or other additional other functions.

Which is continuously filing for

U.S. Pat. No. 7,318,652 filed on May 31, 2005 (#B-2005) A Multiple function wall cover

Which is continuously filing for

U.S. Pat. No. 7,651,365 filed on Jan. 15, 2005 (#F-2005)

Which is continuously filing for

U.S. Pat. No. 7,810,985 filed on Oct. 1, 2004 (#A-2004)

Which is continuously filing for

The current invention also continuously filing for

U.S. Ser. No. 13/161,643 filed on Jun. 16, 2011 for desk top items with LED means has USB-unit(s) or USB-Module (s) to charge other electric or digital data device.

Which is Continuously filing for

U.S. Ser. No. 13/117,227 filed on May 27, 2011 for universal module has USB-unit(s) or/and outlet-unit(s) for variety of electric or digital-data device(s). The current invention is continuously filing of co-pending filing U.S. Ser. No. 12/950,017 (#CCC) Multiple surface LED light filed on Nov. 29, 2010 with rotating device has LED light device(s) and USB device and Outlets device built-in on the rotating substrate with more than one surface to offer multiple function.

The (#CCC) U.S. Ser. No. 12/950,017 Filed Nov. 19, 2010 (Now is U.S. Pat. No. 8,998,462) is continuously filing for

(#R) U.S. Ser. No. 11/806,285, and (Inventor's #R) filed on May 31, 2007 which also a multiple functions LED light device
which are the continuously filing of the
U.S. Pat. No. 7,318,652 (Inventor's #B) for multiple functions Wall Cover filed on Mar. 31, 2005.

The current invention is continuously filing of

U.S. Pat. No. 7,651,365 (Inventor's #F) filed on Jan. 15, 2005
which is CIP of Oct. 1, 2004. It is the CIP of
U.S. Pat. No. 7,810,985 (Inventor's # A) file on Mar. 31, 2005 but it is CIP of Oct. 1, 2004 filing date too.

All these patented or pending case all related to the Light source with Outlets device(s) which are part of the current invention features and got U.S. patents issues or co-pending. It is appreciated the all listed above patented or co-pending cases still treat as fall within the scope of current invention application and apply the priority terms for the current invention filing.

The current invention also continuously filing for (Inventor's #FFF) U.S. Ser. No. 13/117,227 filed on May 27, 2011 for Universal Module has USB-Unit(s) or/and Outlet-unit(s) for variety of electric or digital-data device.

And this filing case is Continue of following parent filing case:

This application is a continuation of U.S. patent application Ser. No. 14/444,703, filed Dec. 31, 2013, which is a continuation of U.S. patent application Ser. No. 13/161,643, filed Jun. 16, 2011, now U.S. Pat. No. 8,783,936, each of which is incorporated by reference herein.

### BACKGROUND

Prior U.S. patents that are not in the name of the current inventor and that disclose lighting and/or charging devices include the following:
(Prior 1) U.S. Pat. No. 7,736,033 (Bhart) discloses a lamp base with an electric device recharge receptacle that can be inserted into a cigarette lighter socket built into the lamp base. The lamp base converts input AC current into automobile current (12 Volt), and then the electric device recharge receptacle inserted into the automobile cigarette lighter socket converts the 12 VDC input current to USB output current (5 Volt). This means that Bhart's device needs at least two expensive circuit/transformers to obtain the USB charger's output current (5 VDC) from 120 VAC wall outlets. This is not economical and the 12 Volt DC current output by the cigarette lighter socket is useless for household use. In contrast, the current invention directly installs a USB charger unit, which transforms the input-end 120 VAC to output-end 5 VDC and is therefore more practical.
(Prior 2) U.S. Patent Publication No. 2011-0177703 (Lin) discloses a rotatable and concealable device with power outlets and a manual switch. The power outlets are 120 VAC outlets that directly supply the 120 VAC current when another device's plug means are connected with the outlet's receptacle. This publication fails to disclose any USB charger concept, circuit, design and application, and therefore is not related to the current invention, which involves a USB charger that uses an overlay to sit on an existing lamp base and thereby offer a multiple power type power station with a lot of features.
(Prior 3) U.S. Pat. No. 7,897,277 (Meyer et al.) discloses a rechargeable battery cartridge which uses batteries as backup power for all kinds of lamps, mainly for power fail applications. This has nothing to do with USB ports or USB charger applications, and therefore is totally different than the current invention, which involves (1) USB ports+(2) USB charging+(3) an outlet supply power source+(4) an LED light and universal lamp base to fit all kinds of existing lamp bases so as not to occupy any new desk top space because (5) the Universal Desk base is overlaid on top of the existing lamp base.
   Furthermore, the current invention has (6) LED lights incorporated with the above listed features (1) (2) (3) (4) (5) so that it becomes a unique practical universal power station because (7) the current invention does not only supply one kind of power to charge different electric or digital-data device(s).
(Prior 4) U.S. Pat. No. 6,474,823 (Agata et al.) discloses a laptop computer with a top illumination light but no USB circuitry for converting current from an AC power source into DC current to charge a DC 5 Volt USB device. The computer input-end current is 120 Volt AC, but it is already transformed into output-end 5V DC current without the need for a USB charger circuit inside the computer, so that the computer's external transformer directly delivers 5V DC current to the USB port. As a result, the computer system of Agata et al. is not same as current invention's desktop item, in which the input-end 120V AC current is transformed by internal USB charger circuitry to obtain the 5V DC output.
   The total circuit and concept is different because the computer of Agata uses an external transformer which does not belong to the computer itself to transform the 120 V outlet power into 5V DC current outside the computer. The computer itself has a 5V DC input-end current and the output-end current of the USB ports is also 5V DC, proving that the computer itself has no USB charger circuit inside since an external transformer can only offer 600 ma while the USB port of the invention features 1.0 Amp, 2.1 Amp, or 3.1 Amp charging outputs, and it is not possible for a computer to output more power than it inputs.
(Prior 5) U.S. Pat. No. 6,554,621 filed on Jul. 14, 2000 Magalit et al.
   '621 teach a cable apparatus for use in a conjunction with a computer system have socket disposed in the rear thereof in order to accommodate at least one cable without occupying a workspace of a user of computer system, and frequently disconnected peripheral unit which includes a second socket via which a peripheral unit is frequently connected to the computer system and frequently disconnected therefrom. '621 for the V.S. current invention power station or desktop items only supply power including DC and/or AC current to USB charge port(s) or outside AC operated products without any digital data including photo, image, document transfer so nothing to do with any data delivery. So '621 is nothing to do with the current invention for desktop hand-reachable distance to get the DC power from USB port(s) or get AC power from AC-outlets.
(Prior 6) US Prior art U.S. Pat. No. 6,211,581 Farrant
   '581 teach a power bar with remote control or with master control functions. The said Power bar have the AC outlet to supply the power and USB-hub to delivery the digital data. '581 filed on 1998 before any i-phone USB charging port(s) shown on people. Farrant '581 shown; A. From Column 5 line 24 to 33 shown (15) is A USBA-type receptacle (or USB B-type not shown) is incorporated within the power bar unit 10 allow the power bar 10 to be controlled via USB protocol. Also, the receptacle (15) allows the remote to control unit (22) to control the power bar unit (10) via a universal Serial Bus connection.
   B. From Column 7 line 17 to line;
      (#30) is an USB hub 30 which is either built-in or detachable. By combining the bub (30) and the power bar unit 10, only a single composite cord 65 (Combining a power cord 63 with a SUB cable 67) is needed to connect between a peripheral device (e.g. Printer (71). This clear said '581 has only (30) hub to delivery digital data not the power supplier USB charge port(s).
   C. The current invention only supply AC power through outlet(s) or USB-port and have LED area and/or indicator light do not have out-of-date VGA socket (92) or more advanced HDMI port or more advanced display-port(s). Also, the current invention do not delivery any digital data including audio or video through the USB-hub. Also, the current invention do not have any other PC related parts and accessories including CPU and related chip or interface.
(Prior 7) U.S. prior art US Application Ser. No. US 2006-027-8816 Filed on Jun. 9, 2006 Parent file don Jun. 9, 2005 Booty
   '816 shown the portable mountable indoor lamp having a position able lamp head and motion and light sensors which can be aimed. '816 is a batter operated indoor lamp (10) have (Battery compartment (14), selector 8. switch (16), animable sensor assembly (18). A gooseneck (20) extend from the base (12). The '816 coupled to one or more batteries (28). V.S. the current invention is
   (7-1) powered by AC current by AC plug-wire to outlet.
   (7-2) have the circuitry including built-in or outside transformer AC-to-DC circuit.
   (7-2) at least one of DC-to-DC circuit to change the AC-to-DC output DC or Separated DC battery change to 2^{nd} or more same or different DC current
   (7-4) the current invention supply the at least one of AC and/or DC current and LED illumination.
   (7-5) The current inventio only limited to install on desk top, surface, walls, legs overlay or under lay the desk surface.
   The '816 is portable mountable indoor lamp powered by batteries, so it is totally different on The application, power, electric circuitry, power source. So, '816 is nothing to do with current invention.
(Prior 8) U.S. Prior art US Application Ser. No. 2011-008-4660 filed on Mar. 11, 2010 McSweyn
   '660 shown the wall charger with removable charger parent filed case 61/249,933 filed on Oct. 8, 2009 which is later than co-inventor U.S. application Ser. No. 11/806,285 filed on May 31, 2007 which is CIP of U.S. application Ser. No. 10/883,747 filed on Jul. 6, 2004. The co-inventor '285 is for Plug-in wall outlet LED light have conductive piece to supply power. One of Child case U.S. application Ser. No. 14/739,397 file don Jun. 15, 2015 allowanced on Nov. 21, 2018 and issued on Jan. 22, 2018 for claims 1-8 and 10-12. The '397 parent filed case is Ser. No. 11/806,285 filed on May 31, 2007. The claims 1-8 and 10-12 had all the '660 description for USB ports (1) cigarette
   plug have 12 Volt DC input from AC-to-DC circuit and cigarette plug have one other DC-to-DC circuit to change from 12V DC to 5 Volt DC to supply USB charge port needed 5V DC. (2) The wall plug-in AC-to-DC circuit directly to supply 5 Volt DC to 2^{nd} USB charge ports to supply 5 Volt DC to charge other products. V.S. Both (1) and (2) USB still fall within the '660 and its parent filed case '285 filed on May 31, 2007 claim and scope.
   So, The '660 US prior art is not proper for the much earlier co-inventor filed case.
(Prior 9) U.S. Prior art U.S. Pat. No. 8,545,039 filed on May 18, 2010 and parent filed on Apr. 20, 2007
   '039 shown the Bulb lamp base with cigarette plug unit to get the lamp base built-in AC-to-DC current at 12 Volt or 24 volt DC current and the said cigarette plug unit has built-in other DC-to-DC circuit to change from 12 or 24 Volt DC current to USB charge ports needed 5 Volt DC to allow charge other products.
   From '039 show the bulb lamp at column 6 line 26 to 36 shown the illumination element (50) is 110 to 120 VAC with 10-20 amp is one of incandescent bulb. It also can prove from the FIG. 3 shown the plug (56) and wire (54) get the into the lamp base at (58) and inner wire (60) directly to the top illumination element (50) to confirm the illumination element (50) is AC powered incandescent bulb which is not same as current invention LED area and/or indicator light illumination. So, the circuit compare with current invention for LED light source is totally different.
   Further, the current invention the said AC-to-DC and at least one of DC-to-DC circuit all are installed within the desktop items or desktop power station. Not like '039 one of the DC-to-DC is built-in cigarette plug. Not inside the desk top lamp base.
   So, '039 is totally different with current invention.

Hereafter, the current invention related to extension cord or power strip for desktop application has following features as below;
A. It offers the most convenient way to use USB, power outlets, or LED unit(s) on a desk surface:

The current invention places a power station on the desktop and eliminates people bend waist to use the heavy-duty extension cord on the floor from the wall outlet, and the resulting strain caused by multiple times bend waist or knee down floor because extension-cord or power-strip have heavy weight.

The update design for all market-available extension cords with built-in outlets or other features including USB ports, audio-ports, video-ports, Internet-ports, or other electric's ports. However, there is no any design to arrange extension-cord or power-strip or power-station put on the desktop for easily access all related operation. Especially, the extension-cord or power-strip or power station has outlets need to meet safety authority requirement for power cords to be 10, 12, 14, or 16 gauge so it is heavy cord weight so need installation kit to fix the extension-cord or power strips or power station install on desk surface, walls, legs or underlay or overlay of the desk top surface. So, people can charge DC current for the phone or electric device or consumer products or get AC current to laptop or other AC operated product on desktop to prevent bend waist or knee down to get DC and/or AC power from floor extension-cord, power strip or wall-mounted plug-in power station is the main purpose for current invention features.

Furthermore, the old days no people really need to put such an extension-cord, power-strip, power station or outlet device on a desktop because old days people do not use laptop or mobile phone at all, so people only needs to access the device during the few times that one plugs or unplugs electric or electronic devices. This might occur only one time, so no people really need to place the existing simple outlet extension cord or power strip or power station on the desk including top, surface, walls, edge, legs of the desk including working or side-bed desk or other table people use.

However, after people have laptop computer and mobile phone and other wireless communication device(s), people do need charge or get AC and/or DC power from power source daily for many times.

The current invention has built-in USB ports and/or LED light devices beside the outlet-unit(s) which will likely need to be connected to USB/Outlet related power station devices many time(s) per day or at least once every other day because cellphone/mobile phone/smart phone/iPad/panel communication or other portable computer device(s) need to be frequently charged from USB ports or outlet ports, so the current invention offers the most convenient way to put the USB-ports and/or outlet and LED units on the desk top to prevent people from having to bend the body and knee down to connect to a grounded multiple function extension cord or wall mounted USB ports. Thus, the current invention offers the most convenient way for people to get power from built-in outlets, USB ports, and utilize the functions of built-in LED units just on a desk including top, edge, walls, legs or underlay/overlay for desk top surface.

This is the major concept for the current invention.

(Concept 1) The invention enables simple installation of a power station or products on a desk including top, surface, walls, edge, legs or underlay/overlay the desk surface by installation kit(s).
(Concept 2) The power station utilizes concepts described in the following patent applications of the inventor in order to provide the capability to supply power and charge the majority of electric, digital-data, audio, video, or Internet device(s) on a desktop without the need to bend one's body toward the ground frequently in order to connect to a power source:
U.S. patent application Ser. No. 13/117,227 (#FFF-2011), which discloses a universal module having built-in USB-units or outlet-units for electric or digital data device(s).
U.S. patent application Ser. No. 12/502,661 (#I-1=2009); Ser. No. 11/806,285 (#R-2007);
Ser. Nos. 12/292,580; 12/566,322 (#M-1=2009); Ser. No. 11/498,874 (K-2006); Ser. No. 11/527,629 (#L-2013);
Ser. No. 12/622,000 (#HH-1-2009); and Ser. No. 12/624,621 (#II-2009), which disclose a sealed-unit with uniform dimensions and shape to fit into the same uniform dimension compartment of a variety of LED light devices.

The current invention simple to change the wall mounted LED light device has built-in outlet(s), and/or USB-unit(s) and LED light get power from the AC outlet to the AC Plug-wire to get same AC outlet AC power source to become the desktop power station and all the outlet(s) and/or USB-ports at the easily hand-reachable distance to let people prevent to bend body or knee down to get easily access the USB-ports and Outlet-ports.

The current invention should be read as alternative or replaceable or equal function while make a simple change the wall plug-in prong to AC-plug wire with installation kits to fix the said power station or extension cord with built-in LED area and/or indicator light illumination.

The current invention change all parent filed plug-in outlet by prong multiple functions LED light to AC-plug-wire, this simple change can therefore also apply for all kind of desktop items including at least one of a power strip/extension-cord, power station has built-in at least one of outlet device, power station has at least one of protection circuit or functions including surge protection device, desktop power or adaptor device, desk top USB and/or outlet charging device(s), power station for charging smart phone related device(s), computer related device(s), and/or consumer electric device(s).

(Feature 1) The current invention has at least one of a USB-unit or outlet-unit of desktop items or power station which has AC-plug-wire to get AC power source, which is not same as earlier discussed some parent filed case apply prong to get AC power described in the inventor's above-listed other patent applications.
(Feature 2) The USB-unit or outlet-unit of the current invention both offer power from desk top items or desktop power station which located at hand-reachable distance of the desk, table, flat surface and/or have built-in variety of additional functions or additional devices so as to supply or charge the variety of electric devices in good power condition for people to use.
(Feature 3) The desktop item or desktop power station or desktop extension cord or desktop power strips with installation-kit to install on desk anywhere have built-in at least one of USB-unit or outlet-unit of the current invention have their own related circuit, conductive piece(s), contact piece(s), receiving port(s) specification, output-ends, input-ends, electric parts and accessories to supply electric power through outside an USB-wire or USB-cable to the receiving-end(s) or receiving-port(s) of be-charged or be-supplied power electric devices or products.
(Feature 4) The current invention has a preferred or universal specification including type A, B, C, Mini, Micro or other preferred specification of the USB-units or outlet-units those preferred having the most compact size to enable each of the USB-units or outlet-units or any combination of the USB-units and outlet-units; to fit into all kinds of electric device(s) export-port and/or receiving-port(s), including LED light devices, power strips, surge protectors, communication devices, computer devices, consumer electric devices, smart phone devices, panel computer devices, etc. Not same as other US prior art only have out-of date single male plug to receive only one fixed specification receiving port of be-charged products which lack of the universal to fit all kind of different brand or size of the export-end and/or receiving-end.
(Feature 5) The desktop power station or desktop items has built-in USB-units or outlet-units of the current invention have passed all related safety standards and have issued certifications.
(Feature 6) The current invention may include a module having one or more USB-units and/or outlet-units and have preferred any combination of one or more than one of the following components: a conductive wire, conductive plate, conductive piece(s), contact piece(s), USB-cable, USB-wire, resilient conductive piece, printed circuit, flexible circuit, related electric parts and accessories, fixing kit, positioning system, and installation kits; to enable to connection with other be-charged or be-supplier power products.
(Feature 7) The desktop item or desktop power station have different number or specification or configurations for charging or supplying power to other products, such as at least one of
1 USB-unit.
1 Outlet-unit
1 USB-unit with 1 USB-port,
1 USB-unit with 2 USB-ports+1 outlet-unit,
1 USB-unit with 2 USB-ports+2 outlet-units,
More than 1 of outlet-unit(s),
More than 1 of USB-unit(s)
or
any combination of USB-units and outlet-units to enable meet different desktop items or desktop power station for different location or different application needed.
   (Feature 8) The desktop items or desktop power station may also have the following preferred or different specifications of USB charge capacity to charge different be-charge products, including: The USB port may have different current outputs, including 500 ma, 1 Amp, 1.1 Amp, 2.2 Amp to enable the two USB-ports to charge different electric devices such as an iPhone, which needs to have 1 Amp, or an iPad, which needs 2.1 Amp.

If people want to charge on iPhone plus one iPad at the same time, at least a 3.1 Amp module will be needed. This will be very expensive.

If people want to charge one iPhone or one iPad at different times, the standard module can have one 1 Amp port and one 1.1 Amp port, which equals 2.1 Amp total, so the cost will be cheaper.

If People want to charge only one iPhone, only one USB-unit with one port which has only 1 Amp will be required for the most economical product.

Hence, the standard module should not be limited to one specification.

(Feature 9) The feature of configuring the standard of USB-unit as a sealed-unit that has its own issued safety certification and fits into the uniform compartment of any other electric device eliminates the need to apply for each different electric devices' UL or ETL or CSA safety certification and saves a lot of time for tooling development and safety testing for each different electric device. This will reduce a lot of costs for research and development and tooling, as well as the time and fees required to apply for the safety certifications.
(Feature 10) As compared to the arrangement described in the inventors' (# FFF-2011) U.S. patent application Ser. No. 13/117,227, entitled “Plug-in outlet of USB-unit or Outlet-unit for electric or digital data device,” the current invention provides a simpler installation-kit(s) to change from plug-into wall outlet device to a desktop item with LED(s) having USB-units and/or outlets to charge a variety of electric or digital data devices by replacing the inventor's co-pending application plug-in prong to AC-plug wire to get same AC outlet AC power source(s). This is simple change prong to AC-plug-wire and add the installation-kit(s). It is very simple to just add the Outlets and/or USB-unit into all kind of desktop items such as desk top lamp, reading light, clock, digital clock, time display, alarm clock, cosmetic mirror, audio device, Bluetooth speaker, sound device, baby cam, security light, plug-in night light, floor lamp, fan, living room lamp, accent light or all other electric or electronic device people will use and install on desktop or kitchen or living room all should fall within the current invention scope, spirit, concept and claim coverage. One simple example and some of parent filed case already is US patents as below;
(#GGG-11) U.S. Ser. No. 14/951,872 filed on Nov. 25, 2015, which is CIP of
(#GGG-10) U.S. Ser. No. 14/875,675 filed on Oct. 5, 2015 which is CIP of
(#GGG-9) U.S. Ser. No. 14/870,601 filed on Sep. 30, 2015 which is CIP of
(#GGG-8) U.S. Ser. No. 14/834,613 filed on Nov. 10, 2015 which is CIP of
(#GGG-7) U.S. Ser. No. 14/834,823 filed on Aug. 25, 2015 which is CIP of
(#GGG-6) U.S. Ser. No. 14/834,557 filed on Aug. 25, 2015 which is CIP of
(#GGG-5-1) U.S. Ser. No. 14/858,838 filed on Sep. 18, 2015 now is allowanced wait for issued, which is CIP of
(#GGG-5) U.S. Ser. No. 14/833,935 filed on Aug. 24, 2015 which is CIP of
(#GGG-4C) U.S. Ser. No. 14/827,810 filed on Aug. 17, 2015 which is CIP of
(#GGG-4) U.S. Ser. No. 14/827,810 filed on Aug. 17, 2015 now is U.S. Pat. No. 8,931,947 issued on Jan. 13, 2015 which is CIP of
(#GGG-3C) U.S. Ser. No. 14/643,026 filed on Mar. 10, 2015 which is CIP of
(#GGG-3) U.S. Ser. No. 14/144,703 filed on Dec. 31, 2013 which is CIP of
(#GGG-2C) U.S. Ser. No. 14/548,626 filed on Nov. 20, 2014 now U.S. Pat. No. 9,182,111 issued on Nov. 10, 2015 which is CIP of
(#GGG-2) U.S. Ser. No. 14/105,717 filed on Dec. 13, 2013 now U.S. Pat. No. 8,911,137 issued on Dec. 16, 2014 which is CIP of
(#GGG-1C) U.S. Ser. No. 14/548,861 filed on Nov. 20, 2014 which is CIP of
(#GGG-1) U.S. Ser. No. 14/105,607 filed on Dec. 13, 2013 now U.S. Pat. No. 8,915,608 issued on Dec. 23, 2014 which is CIP of
(#GGG-2011) U.S. Ser. No. 13/161,643 filed on Jun. 16, 2011 now is U.S. Pat. No. 8,783,936 issued on Jul. 22, 2014
   (Feature 11) These co-pending or parent filed cases cover all kind of desktop item has existing functions and people use for daily which can add the USB-port(s) and/or Outlet-port(s) to become USB and/or Outlet desk top items as above discussed. It is appreciated all the co-inventor co-pending and parent filed cases all scope, concept, spirit, text, drawing, brief description, details description all should still be consider is part of the current invention concept, scope, claims coverage range.
   (Feature 12) To upgrade all the desktop items to add the USB and/or Outlet ports as above discussed is easily because some of the desk top items with LED means have plenty of room/space to accommodate the bigger size of the USB-unit(s) or USB-module(s) and reduce the cost of the related electric components, parts, or accessories to make it more attractive to the consumer.
   (Feature 13) The term USB-unit refers to an electric charging unit which has a USB-female receiving end(s) or port(s) to receive a USB-male plug of separated USB-wire to supply electric power from the USB-female receiving end(s) or port(s) through the 2 male plug of USB-wire to another device's USB-female receiving end(s) or port(s) to charge the other product(s) inside rechargeable battery or energy storage unit(s). The power station or desktop items preferred USB-female receiving end(s) or port(s) gets power from a power source and has at least one of the AC-to-DC, and/or at least one of DC-to-DC circuit to convert the input electric power into a at least one of preferred same or different DC voltage to supply to at least one of USB-port (s) with USB conforming voltage and current to charge the other device through the USB-male plug of USB-wire, and also supply to LED(s) for desired area/indicator light and/or preferred additional built-in power station or desktop additional function(s).
   (Feature 14) The term USB-module refers to a desktop power station or desktop item(s) which has at least
   one of USB-female receiving end(s) or port(s) but also has multiple receiving end(s) or port(s) in preferred combination of a power outlet-female receiving end(s) or port(s), USB-female receiving end(s) or port(s), adaptor's female receiving end(s) or port(s), or any conventional female receiving end(s) or port(s) to form one desktop items or desktop power station which has more than one female receiving end(s) or port(s) to offer the same or different types of electric power output though the different female receiving means within the one body. The USB-module connects with a power source and circuit to offer the at least one of same or different DC current having desired electric power having a predetermined current type, voltage, and current to charge other devices when the female receiving end(s) or port(s) is connected with male prong means of each style of the USB male plugs or contactors or conductive piece(s) to charge the be-charged products or supply power to other additional functions.
   (Feature 15) The term desktop items or desk top power station within the hand-reach distance while people sit or near-by desk or table or closet refer to objects which allow people to easily reach, touch, operate, or manage charging or supplying power to be-charged or be-supplier products or items and in which the above-described USB-unit(s) and/or outlet-unit(s) are installed, within the item or on a substrate. The items are positioned at any location where people will stay for a period of time, such as a desk, table, bed, chair, land, grass or wherever people work, rest, or take a nap, or at any place where people might use a computer, laptop computer, i-Phone™, i-Pad™, or i-Cloud™ device, such as a table, desk, bed, laptop stand, laptop support, laptop cushion, or on any similar surface which allows people to work, sleep, or lay down for a period of time so can charge the other electric or digital data device(s).
   (Feature 16) By providing desk top items with built-in LED(s) having the USB-units built-in, electric power can be supplied to all other electric or digital data devices so that there is no need to bend the body to find the power source under the table, which is normally farther away than the distance to the desktop items having LED(s).
   (Feature 17) Hence, this offers good convenience for people while they work, rest, or even take a nap, so that they can easily use the USB-unit(s) or USB-module of the desktop item with LED means to charge their small phone, computer, i-Phone™, i-Cloud™, i-Pad™, or any other electric or digital data device(s) while they work, rest, sleep or take a nap.
   (Feature 18) A primary purpose of the universal USB is any type or specification from market place including Type, A, B, C, Micro, Min or others USB which described in the inventor's co-pending applications is to make the be-charged products as small as possible in size so that can fit into as many as applications' limited housing size as possible so as to be easily carry the USB wires, be-charged or be-supplier power products.
   (Feature 19) However, the smallest, slimmest, or most compact size of the current invention's charge device inside the desktop power station or desktop items has built-in USB-unit(s) or outlet-unit(s) or USB-module will be too expensive. For example, the iPhone's or iPad's wall charger device has built-in desired number of USB-unit is very small in size such as type C or micro or mini USB and needs a very compact transformer or inverter with super big power output, so that it is very expensive to provide a USB-unit, outlet-unit, or USB-module that can fully charge another electric or digital data device(s).
   (Feature 20) On the other hand, in order to get 2010 new definition for quickly charger USB specification of a USB-3.0 standard having 2.1 amp output from the USB-unit(s), one can simply use a larger size for the electric components or parts and accessories such as a transformer or inverter, thereby obtaining the same big power output at a lower cost that allows a consumer to save pocket money.
   (Feature 21) This is possible because of the large size of the desktop items or desktop power station in which the USB-unit, outlet-unit, or USB-module is installed. The desktop items may include a LED desk lamp, a desktop clock have LED or LCD displayer, desktop radio, desk top fan or airflow device, desktop LED lighting, LED reading light, LED wall reading light, LED head lighting, LED book light, electric LED lighted picture display, LED motion/radar detector light device or light bulb, LED night light with an AC-to-DC circuit and/or at least one of DC-to-DC circuit to change the AC power source to at least one of DC current, or an built-in or outside adaptor/transformer with AC-plug-wire, LED project light with an AC to DC power source or adaptors with AC-plug wire, LED electric candle set with an AC to DC power source or adaptors with AC-plug wire or USB-input-receiving-end(s), or any LED device which meets the above definition of a desktop item or desktop power station. The current invention all USB-unit or USB-ports are designed only for charging purposes and preferred not for digital data delivery for current invention not like some other prior art have USB-Hub which delivery the digital video or audio or documents which prefer not apply for the current invention for cost consideration, because had these data delivery will increase a lot of cost and no need to do so because all mobile phone, laptop, i-pad had all perfectly parts to operate all these digital data. The alternative or replacement application may consider with data delivery.
   (Feature 22) The current desktop items may have preferred additional functions, performance, or effects
   including LED or 2^{nd} LED light beams or function(s), LED project light to project lighted images, time images, a clock, a time related piece(s), a alarm time related piece(s), mirror to reflect object with LED illumination, music, audio or sound related products, AC and/or DC power source, wireless transmitting and/or receiving electric signals, wireless or wife with download APP software to make function, setting, adjustment, lighted photos device, delivery of digital signals including sound, light, music, smell or any conventional market available functions, performance or effects that will cause people keep the desktop item nearby for a period of time so as to charge other electric or digital data device(s). These additional function(s) is one of the example for marketing existing desktop items, It is appreciated these is only examples and should not limited for these examples to cover all market existing desktop items which has its functions, features, cosmetic value and people will put on desk, table, kitchen, living room for at least one of reason.
   (Feature 23) A power station, wherein said installation kits includes at least one of
(i) a suction cup, air-adhesive piece
(ii) screw, nail, pin, sharp metal piece,
(iii) holder, frame, tray, base, anti-skip pad,
(iv) Glue, chemical compound
(v) double sided tape,
(vi) magnet piece,
(vii) catch, press-n-tight kits
(vii) hook-and-loop fastener,
(viii) increase weight element(s).
or
(ix) desire combination selected from tape, suction cups, adhesive-piece, glue, double side tape, magnetic, catcher, hook-and-loop tape(s), chemical compound, frame, holder, tray, base, anti-skip pad, press-n-tight kits, weight piece, or increasing weight piece(s).
   (Feature 24) The current invention for desktop items or power station having USB charge function(s), the power station includes built-in or outside AC-to-DC for converting the desire AC current to at least one DC current, and/or at least one of DC-to-DC circuit including separated DC power source to supply the at least one of same or different with USB charge port(s) needed DC current to at least one of USB charger, Outlet(s), LED(s), and optional or preferred built-in additional/existing function(s).
   (Feature 25) A power station is a desktop LED accent light which has desired LED illumination with preferred at least one of functions for color or brightness or timer or trigger-system at least have one of color changing, color selection, sleep setting, conductive/dimmer/setting/selective and on-off switch, and built-in at least one of charging or input-power USB-Port(s). And, the desk top item has at least one circuitry to control the said LED light for color or brightness or timer or trigger-system including at least one of color changing, color selection, sleep setting, conductive/dimmer/setting/selective and on-off switch, and built-in at least one of charging or input-power USB-port(s).

### BRIEF DESCRIPTION OF THE DRAWINGS

FIG. 1 is an isometric view showing rotation of a rotatable LED light according to a first preferred embodiment of a multiple surface LED light which has a first surface having an LED element(s) installed in a recess. When an external force is applied to the LED light, it rotates to expose a second surface, which is fixed in position by locking kit to offer people outlets for a power source, or/and internet socket, or/and a phone socket to offer people convenient functions at the same location as the LED light. A single location of the surface can have multiple electric applications, which will save a lot of space, especially for a working table or under cabinet light fixture.

FIGS. 2A and 2B, and FIGS. 3A and 3B show one application of the first preferred embodiment in which the multiple surface LED light has been applied to a desktop, furniture, ceiling, walls, door, or surface by itself without any other main objects, substrates, or housing unit, i.e., the multiple surface LED light is directly installed in a building, house, big furniture, ceiling, wall, door, closet, or cabinet, without the need for a power strip, LED light fixture, light device, or light bar.

FIGS. 4, 5, 6A, 6B, 7, 8, 9, 10,10A, 10B, 10C, and 11 show applications of the first preferred embodiment in which the extendable or transformable multiple function LED light has built-in USB or/and outlet with prong to plug-into wall outlet. It is preferred the similar extendable, changeable, transformable construction been applied to other main objects, other substrates, or other housing means, and in which the main objects, substrates, or housing are individual existing desktop power station or desk top items or extension cord, or power strips related products of current invention, including the current invention discussed power strips, light fixtures, extension cords (such as the one disclosed in the inventor's U.S. Pat. No. 7,824,185), wall outlet devices, LED light devices (as disclosed in the inventor's U.S. Pat. No. 7,618,150), foldable devices or extendable devices (as in the inventor's U.S. Pat. No. 7,722,230), removable devices (as in the inventor's U.S. Pat. No. 7,726,839), or transforming devices (as in the inventor's U.S. Pat. No. 7,726,841). All these existing products can change the construction or design and become very useful and practical items having more functions than the original products, which should make them more valuable for people.

FIG. 12 includes perspective views of a co-pending parent filing LED light device have universal module to fit into the Plug-in Power station having built-in outlet-unit(s) or USB-unit(s) for a variety of electric or digital data devices, to which the principles of the present invention may be applied just change the plug-in prong to AC-plug wire with desk installation-kits become the current invention scope for desktop item or desktop power station applications.

FIGS. 13 and 14 show a co-pending parent filed cases which is one of preferred second embodiment which is a multiple functions Plug-in by prong LED light has a built-in at least one of outlet-unit(s) and/or USB-unit(s) and a built-in LED light, as well as holder, support, prong or cable/wire arrangement construction; that is one of plug-in wall device. The current invention has all these features just change the plug-in prong to AC-plug wire with desktop installation kits, that instantly to change current invention scope including a desktop power station, desktop items, desktop extension-cord. The the second embodiment thereby offering a very practical a USB-charger, and outlet AC power source to supply 120 Volt 60 HZ current, LED area/indicator light illumination, and/or other additional function(s) outlet to people.

FIGS. 15A-15C show a third parent filed case which has preferred embodiment which has different high and low outlet-unit(s) and/or USB-unit(s) on one power strip, and in which other electric devices such detachable LED light-unit(s) can be put on the lower outlet-unit(s) or USB-unit(s) to provide a specially designed multiple function power strip. It can be powered by a battery as in FIG. 15B or use a cable with a prong-plug as in an extension cord or power strip. Each of the outlet-unit(s) or USB-unit(s) can be rotatable if required as described in the inventor's issued or co-pending U.S. patents and patent applications. The said USB-unit(s) or Outlet(s) of this preferred embodiment can put on the desk top surface with installation-kits to fix on position to let people can operate within hand-reachable distance without bend body, This is the other preferred application and construction for desktop power station or desktop items of the current invention makes it most simple to change from original prong plug-into wall to AC-Plug wire like the above discussed to create desktop power station with built-in USB and outlet(s) and LED illumination where the LED illumination is one of detachable, movable, plug-in by prong LED light with desired light functions so make the said desk top power station become one of multiple function devices.

FIGS. 16A-16C show overlay or underlay the said desktop power station on top or bottom of the said existing desktop item. The said overlay or underlay power station has built-in outlet-units with preferred rotatable orientation features according to another preferred embodiment. It has AC-plug wire so can be directly plugged into a wall outlet to get AC power as an existing extension cord/power strip to get power on desktop item while the overlay or underlay power station is fix on top or base of the desktop items. All outlet operation is on the desktop surface where is far away from the wall. The one of alternative application of the current invention arranges some of the outlet-unit(s) to become USB-unit(s) and/or add more LED(s) for including LED area or LED indicator light, so as to have extra functions or features, or applies the universal module to make it most simple to use groove (173) or super big size housing of (170) to overlay the smaller base of existing desktop items, so can have desktop power station has built-in USB ports, outlet ports, LED(s) become 3 functions in one desktop item or desktop power station.

FIGS. 17A-17D, 18A, 18B, 19A, 19B, and 20A-20C show an embodiment that provides different power sources for a variety of consumer electric device(s) through the addition of USB-units or outlet-units as required. FIG. 13 shows an extension cord or power strip which has a plurality of the outlets and USB-units. The most important feature of this preferred embodiment is the inclusion of a master control function, which means that when an outside electric device is plugged into the master control outlet, it turns on/off other electric device(s). The master outlets will be activated and turn on/off all the other outlet(s) or USB-unit(s) so that people do not need to individually turn on/off each other outlet's related electric device(s). It also will cut off power to all other outlets or USB-units when the master control outlet has be disconnected from the other electric device. This feature can be added to the current universal module having outlet-units and/or USB-units.

FIGS. 21-45, 45-1, and 46-49 show co-pending filed parent filed case which further preferred embodiments of desktop items with LED(s) illumination having USB-unit(s) to charge other electric or digital data device(s).

FIG. 21 shows two USB-units and one outlet-unit in a front view. This embodiment has 12 LEDs powered from a USB plug-wire or alternative to powered from a AC-plug-wire or outside transformer.

FIG. 22 a preferred embodiment side view of the is This side view of a desktop item with LED(s) light source to charge other electric or digital data device(s), and which has one USB-unit and two outlet-units on the side of the base. This embodiment also includes 12 LEDs powered from a USB plug-wire or alternative to powered from a AC-plug-wire or outside transformer.

FIG. 23 shows a preferred embodiment which has three USB-units with different power outputs or share the total current to charge different electric or digital data devices. The USB-units may have minimum 1,000 ma or 2,100 ma or higher to charge different electric or digital data devices, such as an iPhone and iPad, to meet the different requirements for charging current. The power input is from outside transformer.

FIG. 24 shows a preferred embodiment which has two USB-units and one outlet-unit to allow people to charge or supply power to an iPad or iPhone and power a laptop computer or other device that can get power from the USB-units or Outlet-unit.

FIG. 25 shows a preferred embodiment of a desktop item which is a LED lighting fixture with adjustable arms to position the LEDs at a desired height, orientation, direction, and angle to get the best illumination to people. The built-in one USB-unit and one outlet-unit has a lower cost than other configurations having a plurality of USB-units and outlet-units as discussed above. The desktop item is powered by an adaptor that includes a transformer supplied with 120 Volt AC current from a wall outlet, which is different than the embodiment of FIG. 21, which is powered by a USB plug and wire.

FIG. 26 shows a preferred embodiment powered by solar power stored inside rechargeable batteries and incorporate with booster circuit to raise rechargeable battery voltage to higher enough to supply power to the USB output-end, so as to provide enough power to charge other electric or digital data device(s) through the built-in USB-unit(s) and outlet-unit(s).

FIG. 27 shows a preferred embodiment which also uses solar power, although it could also be powered by any other market-available power source, including solar power, wind power, chemical power, battery power, a generator, a transformer, an adaptor, an inverter, an inductor, etc. and incorporate with booster circuit to raise rechargeable battery voltage to higher enough to supply power to the USB output-end

FIG. 28 shows a preferred embodiment which has a thicker or higher base to provide a bigger space for accommodating larger electric parts and accessories and save a lot of cost compared to super compact slim, or miniature electric parts and accessories. Furthermore, the thicker or higher base can also accommodate a rotating USB-unit(s) or USB-module having a first surface that presents a decorative appearance when the USB-unit(s) or USB-module is not being used. This embodiment includes features shown in FIG. 8 for a plurality of USB-units and other numbers of receiving end(s) or port(s) on the second or additional surfaces of the USB-module. Further details of the rotating USB module can be understood from the FIGS. 10C, and 11. The USB port(s) and outlet port(s) and LED light illumination may further include features disclosed in the inventor's co-pending (#FFF-2011) U.S. patent application Ser. No. 13/117,227.

FIGS. 29-31 show preferred embodiments in which the desktop items with LED(s) that also have a thicker or higher base to accommodate rotating USB-modules that include a plurality of USB-unit(s) and a plurality of other receiving end(s) or port(s) to increase the number of functions, features, effects, and/or performances. The USB-module has at least more than one surface to change the desired surface for certain purposes. The more than one surface of the USB-module means can be any number from 2 to N.

FIG. 33 shows a preferred embodiment in which the Desk Top item has a super big base size so that a plurality of rotating USB-modules can be installed to enable a group of people to charge their electric or digital devices at the same time, such as in a train station, bus station, airport, meeting room, hotel lobby . . . etc. Such a desktop item has a super big and high base with a plurality USB-modules and may be called a charging harbor.

FIG. 34 shows a preferred embodiment in which the desktop item with LED light source has a USB-unit(s), USB-module, or outlet-unit(s) and/or other additional function(s) built-in the base or post or bar or body to allow people to charge other electric or digital devices with extra additional function(s). The desktop item may include any of a radio, time piece, weather station display, air-flow, bladeless fan, blue-tooth speaker, audio device, camera device, data storage device, fruit blender, food machine, liquid machine, LED lighting, sensor light, 2^{nd} LED light, night light, sleep light, light fixture, projector assembly, electric fan, heater or any conventional items with LED area and/or indicator and/or charging status light, and USB-unit(s) or USB-module(s) built-in to allow people to charge other electric or digital data device(s) while they stay a period of time nearby or stay beside the desktop items.

FIGS. 35-37 show preferred embodiments in which different LED light source arrangement, those are used for LED lighting in the preferred embodiments of the above-described drawings or in another LED desk lamp or LED lamp for a desktop including the LED light source(s) install on a geometric housing with angle, orientation, height adjustment and LED(s) arrange in matrix, dot matrix, donut, linear to get bigger areas light minimum to illuminate A4 or B2 of Full Size of newspaper with height above the people sitting eye locations or others by adjust assembly to get best illumination.

The Light for reading can have color, brightness, functions changing, selection, setting, countdown time for reading, working, sleeping for multiple functions.

FIGS. 38, 39, 41, 44, 45, and 45-1 show details of the rotatable USB-module with at least one of the USB-unit(s) and a plurality of receiving ends or ports having any combination of USB-unit(s), outlet-unit(s), internet-unit(s), adaptor-unit(s), other LED light source(s) or other DC powered light sources with appropriate parts and accessories, or any conventionally available receiving ends or ports, the USB-Module having at least more than two surfaces and each surface having its own special design.

FIGS. 40, 42, 43, 46-49 show all kinds of desktop items which offer existing functions, effects, and performances to people's eyes, nose, mouth, ears and body to let people can see, can smell, can eat, can hear, can feel, can sense. The said all marketing available functional or decorative desktop items can easily to install the said USB-unit(s) and/or outlet-unit(s) to make the said all desktop items become desktop power station while have the installation kits to keep the desktop items on desired position without fall down for desk or table or higher surface while the impact force applied to the said desktop power station or desk top items with built-in USB or Outlets.

The desktop items charge the people phone or supply power to laptop computer while people working, reading, resting, standing nearby desktop items or power station for a period of time. The said desk top items its have existing functions which can add into geometric shape design of desktop power station to make the geometric shape power station has built-in desktop items existing functions and built-in USB-unit(s) and Outlet-unit(s) and LED light illumination. All the functions of the existing desktop items preferred is one of the so-called additional functions except the USB-unit(s), Outlet-unit(s), and LED illumination(s).

### DETAILED DESCRIPTION

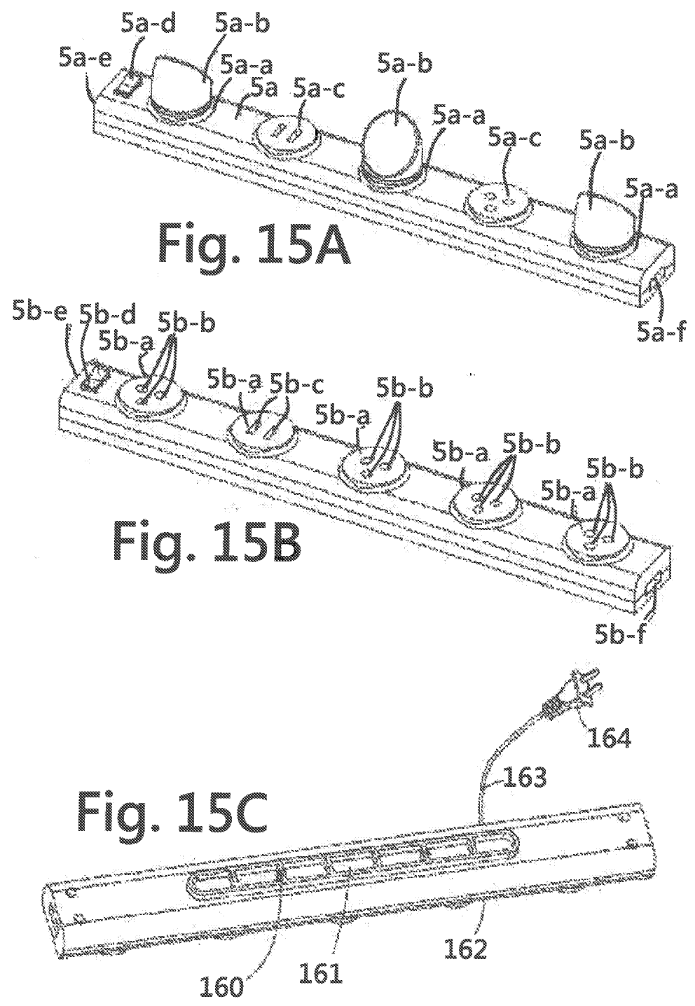

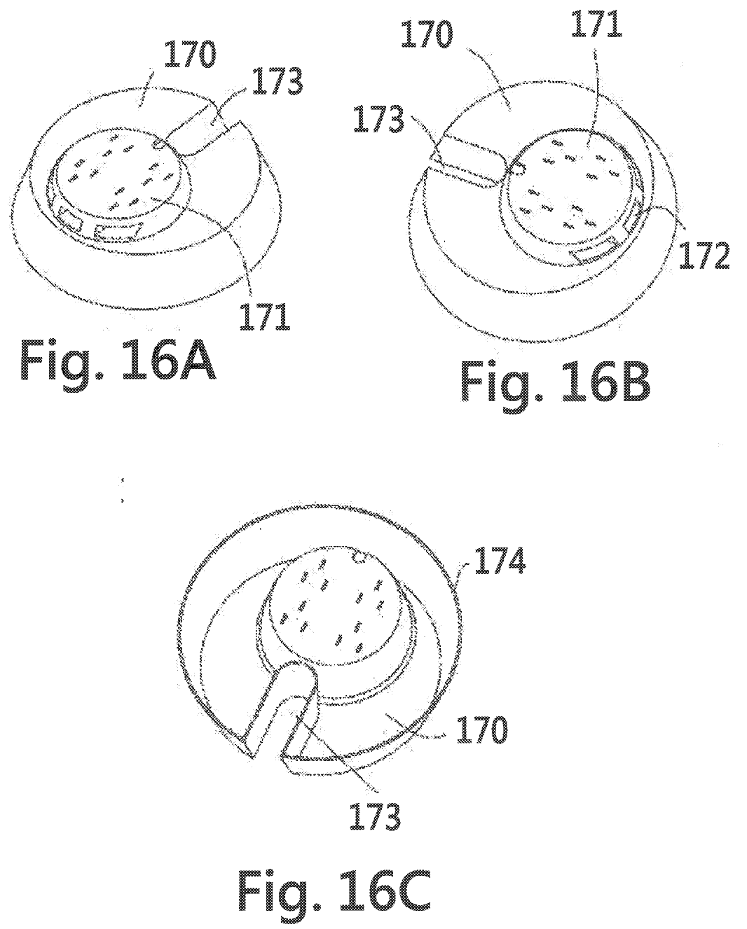

As shown in FIGS. 16A-20C, The housing (170) for the power station or for the assembled-unit (170) can be designed to fit within or be built into existing desktop products (not shown). Because the said housing (170) is big size then base of the existing desk top so can overlay. If the existing desktop items has bigger base, the said housing (170) can put underlay of the base of existing desktop items.

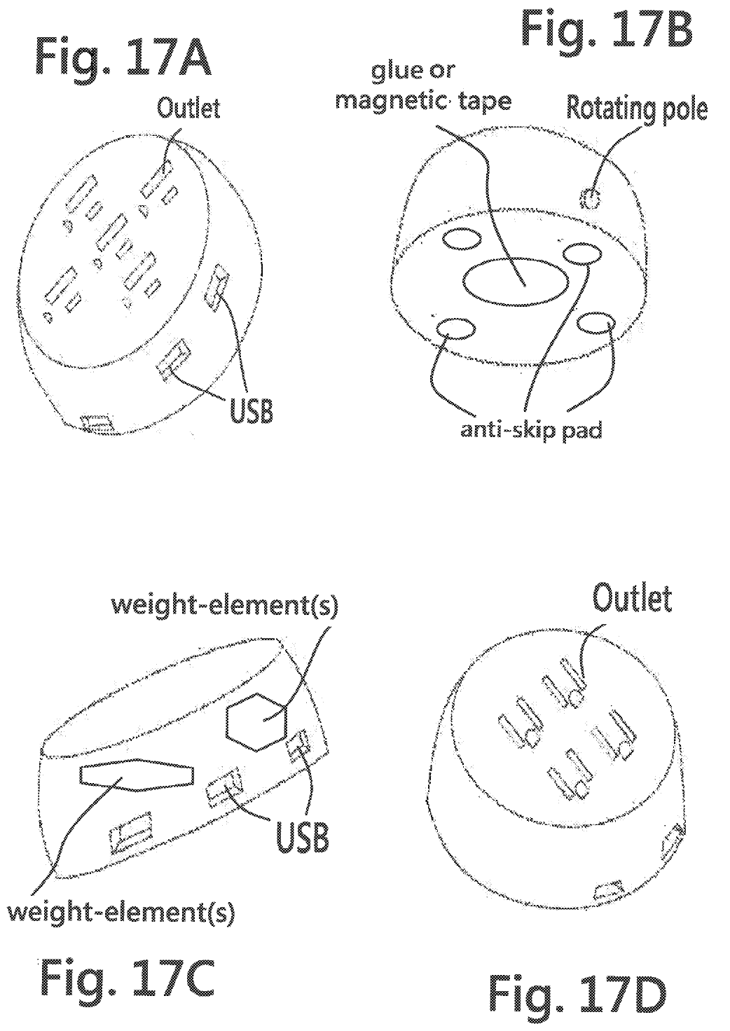

In this embodiment, the power station has an outlet(s) (171) and/or USB-unit (FIGS. 17A, 17C, 17D) so can charge other products by USB wire. The alternative the said USB-unit(s) and/or outlet-unit(s) and LED illumination can fit into the housing (170) with rotating features to change from Surface 1 to Surface 2 and select which surface female end(s) or port(s) is needed to use. The different surfaces have different combinations of LED-units, outlets, or USB-unit(s) or LEDs for illumination. The housing (170) may be arranged to installation of a lamp post while the housing have an open slot so as to overlay the lamp base and put the post fit the slot or opening. For example, a housing (170) of desktop item or desk top power station can include a cut-out or slot (173) as shown in FIGS. 16A to 16C. The slot (173) allows the desk lamp post to be located near the housing (170) center. The housing (170) overlay the existing desk lamp base by forming a contour of the housing and housing have sufficient height to allow the housing is fully overlay the existing desk lamp base. As a result, the power station (171) does not require any additional space on the desktop surface other than that occupied by the desk lamp. Also, this embodiment offers people a power station that can be reached by hand without the need to reach down to the floor to in order to utilize the USB-charger(s) and outlet(s), and furthermore has an LED-unit on a desired one of the surfaces or on all surfaces. The cut-out slot (173) can include a decorative piece or elastic soft material such as a sponge or other elastic material to fill up any space left after insertion of a lamp post into the slot.

As shown in FIGS. 15A to 15C, show one power station (5a-e) in an extension-cord configuration may be installed on the desk surface by an attachment kit, fixing kits, screws, double sided tape or foam tape, glue, chemical compound, tape with magnetic, magnetic-piece, suction cup, anti-skip pad or other conventional parts or kits to prevent the power station, which may include multiple charger(s) and outlets, from moving due to the length and heavy weight of the electric cord or outside impact strength apply to desktop power station or desk top item. The extension cord desk top power statin has the Outlet(s) (5a-a) (5b-a) and LED light (5a-b) (5b-b) and USB-port (5a-c) (5b-c). The said LED light (5a-b) (5b-b) is plut-into outlet (5a-a) (5b-a) to get AC current into the said LED light to supply illumination. The said LED light is detachable and have built-in AC-to-DC circuit inside while outlet(s) supply the AC current. The alternative the said LED light can be built-in the desk top power station and LED light connect with the power station by flexible tube for angle adjustment still fall within the current invention the LED light is connect or built-in with the desktop power station. It is appreciated the current filed case FIGS. 15a, 15b, 15c drawing is identical with co-inventor earlier parent filed case (#UU-2010) U.S. Ser. No. 12/938,628 filed on Nov. 3, 2010 drawing and the said desktop power station (162) is as parent filed case without any question.

FIGS. 17A and 17B show a preferred embodiment of a power station having 5 outlets and 3 USB-ports connected to an inner circuit assembly to offer power from the outlets and USB-charger to other electric devices. The unit has additional weight element(s) to help overcome the power station's electric cord's weight or vibration or impact-strength applied to the desktop power station or desktop items, so the power station can be installed on a desk top without moving or changing position when the weight of the electric-cord (not shown) exerts force on the power station.

FIG. 17C shows a desktop power station only having 3 USB-ports. The heavy electric-cord is not shown.

FIG. 17D shows a desktop power station with 4 outlets and 2 USB-ports. The heavy electric-cord is again not shown.

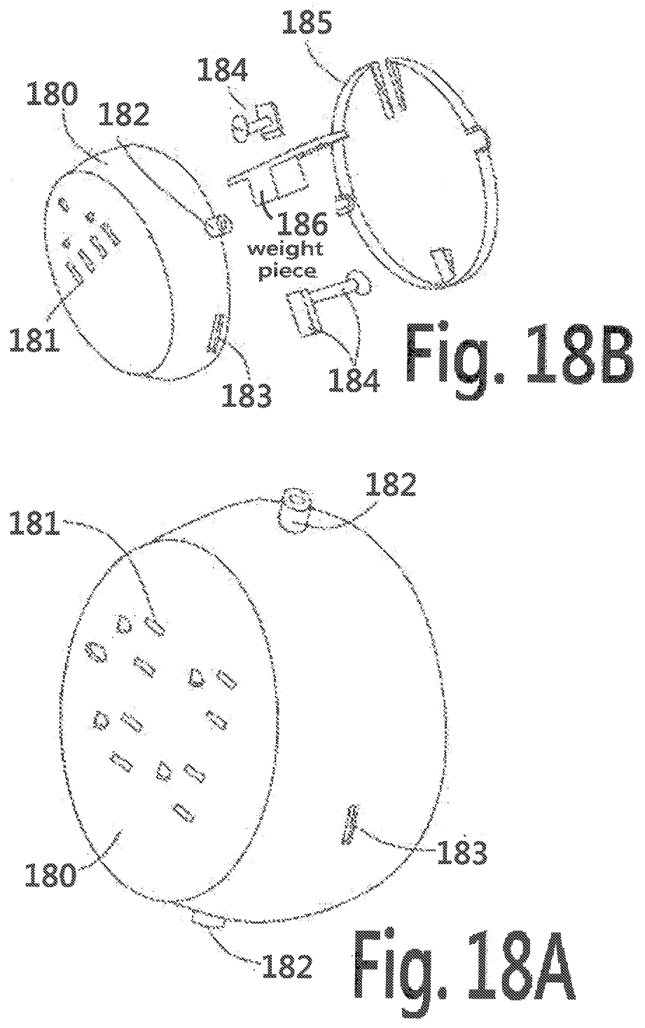

FIGS. 18A and 18B show a desktop power station (180) having optional a rotating configuration (182) (184), fixing piece including magnetic-tape (not shown), and heavy-weight elements (square unit). The rotating configuration (184) (182) enables different surfaces having different combinations of outlets, USB ports, LED-units. The USB ports (183) connect to an inner circuit (not shown) for USB charger. The outlets (181) may have surge protection or MOV circuitry to protect desktop power station (180) or desktop items (180) from an ultra-high voltage input. Also, the power station (180) may have heat-ventilation assembly built-in to the power station. The heavy weight elements (square unit) can prevent the power station from being pulled or moved by the very heavy electric cord's weight and falling down to the floor or ground. This desktop power station (180) enables people to use the USB port(s) (183) or outlet's (181) power source easily by keeping the power station (180) with a hand-reachable distance with no need to bend one's body to a lower position, a low-profile wall, or the ground in order to take advantage of non-desktop multiple functions.

FIGS. 19A and 19B show housing means having an opening to allow installation of the rotatable power station and a slot to install the lamp post with cosmetic-means to cover fill-in any remaining space in the slot after the lamp post is installed.

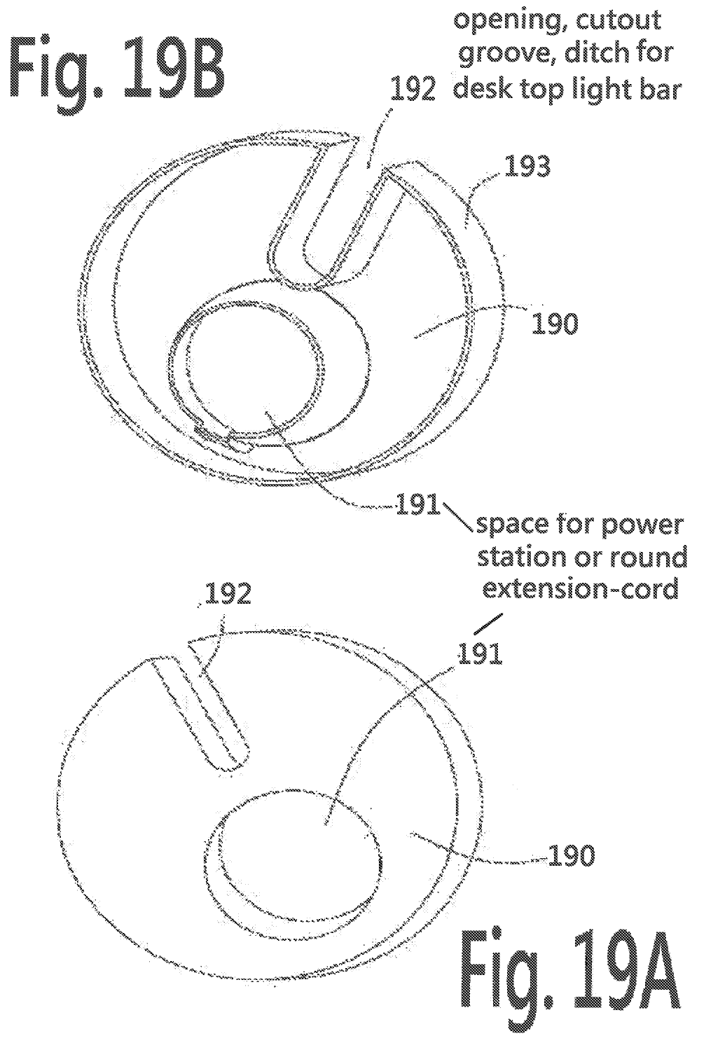

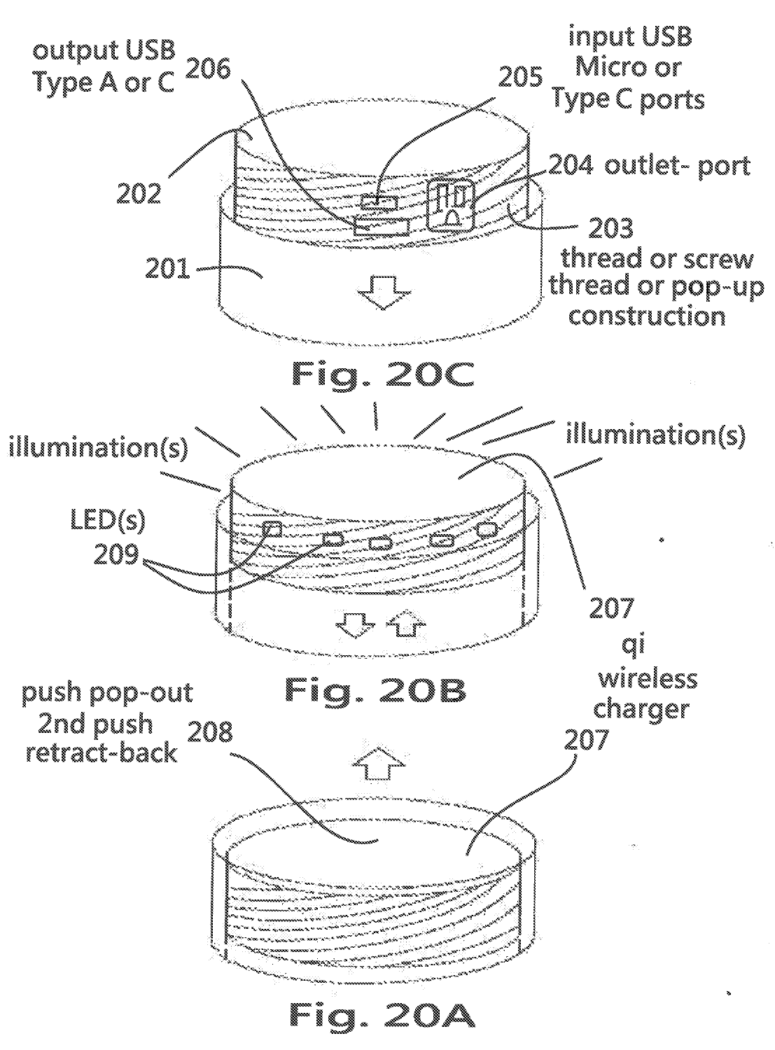

FIGS. 20A to 20C show a preferred embodiment in which the housing (190) has an added contour or edge-wall height (193) so as to fit all kinds of lamp base thicknesses. From FIGS. 20A, 20B, 20C show a screw-thread is provided on an interior side of the housing (190) to raise the housing (190) unit and make the inner space become higher so as to fit all different thicknesses of the lamp base as FIG. 20C to FIG. 20B to FIG. 20A and make the housing (190) overlay install on a majority of market-available lamp or other desktop items bases with sufficient height, size, and dimensions. Other adjustment of height, width, and radius may also be included and will still fall within the scope of the current invention scope to allow changes in 3 dimensions and thereby allow different size lamp bases to fit within the current invention's housing means.

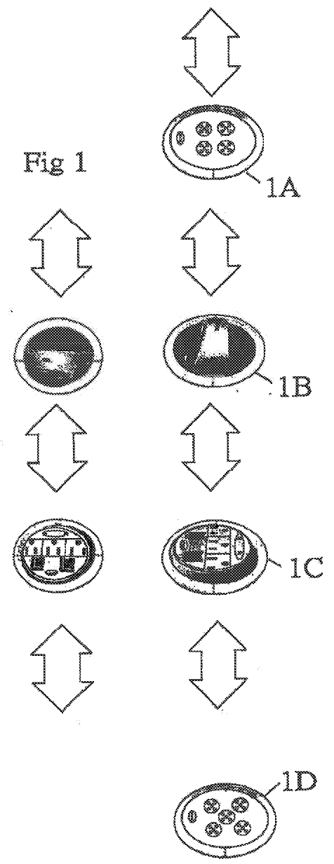

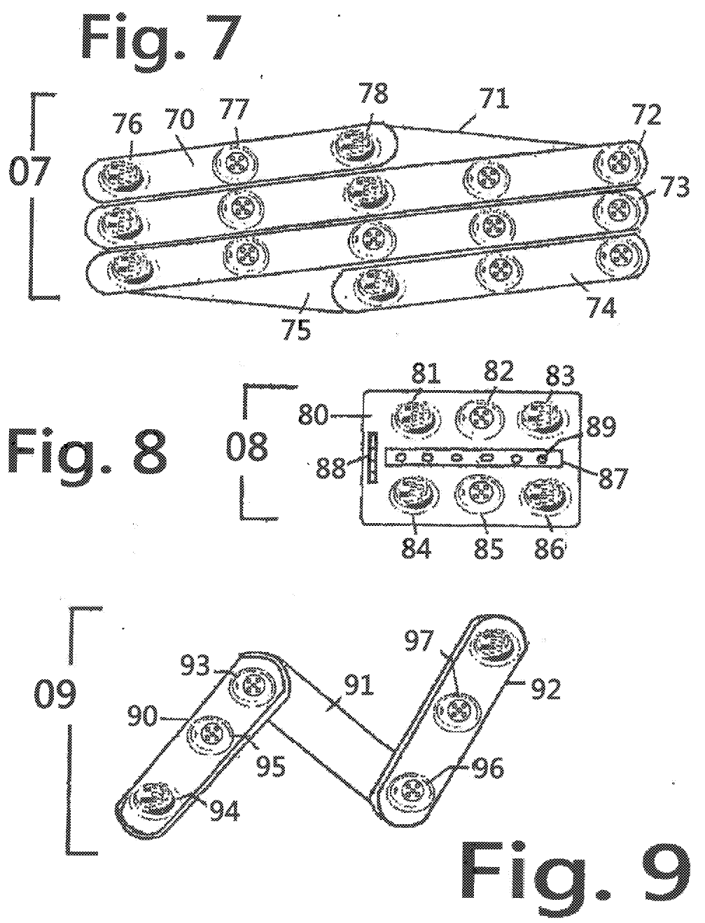

The preferred embodiments may use features described in the inventor's co-pending U.S. patent application Ser. No. 12/950,017, Multiple Surface LED Light and filed on Nov. 29, 2010, which discloses a rotating device having LED light devices, USB devices, and outlets devices included on different surfaces of a rotating substrate to offer multiple functions, as illustrated in FIGS. 1, 2A, 2B, 3A, 3B, 4, 5, 6A, 6B, 7-10, 10A, 10B, and 11.

The inventor's U.S. patent application Ser. No. 11/806,285 filed on May 31, 2007, also discloses a multiple function LED light device, while the inventor's U.S. Pat. No. 7,318,652 discloses a multiple function wall cover and was filed on Mar. 31, 2005. Other patents of the inventor that disclose feature those may be used in the present invention include U.S. Pat. No. 7,651,365, filed on Jan. 15, 2005, and U.S. Pat. No. 7,810,985, filed on Mar. 31, 0005.

The current inventor also may use features disclosed in the inventor's co-pending (#GGG-2011) (#GGG-2011) U.S. patent application Ser. No. 13/161,643, filed Jun. 16, 2011 now is U.S. Pat. No. 8,783,936 incorporated by reference herein. The parent filed case U.S. patent application Ser. No. 13/161,643, filed on Jun. 16, 2011, for a desktop item with LED light source and an USB-unit(s) or USB-module(s) to charge other electric or digital-data devices.

The current invention may also use features described in the inventor's co-pending (# FFF-2011) U.S. patent application Ser. No. 13/117,227, filed on May 27, 2011, which discloses a universal module having a USB-unit(s) or/and an outlet-unit(s) for a variety of electric or digital-data devices, as shown in FIGS. 12.13, 14 which is identical drawing of (#FFF-2011), so the (#FFF-2011) is parent filed case of current invention. The current invention have all USB-ports, outlets, LED light and just change the power input from plug-in prong to AC-plug wire to simple change f source rom wall plug-in device to desktop installation power station.

The current desktop power station while applied for a lamp-base of desktop lighting can use any of the built-in LED light source(s), USB-port(s), Outlet-port(s) described in the above-mentioned co-inventor patent applications and patents, as well as optional rotating features, locking features, and USB charger system. All these desktop power stations or desktop items having an input-end current of 120 Volt AC, which is the same as a house outlet's current, and an output-end of USB charging port having voltage of 5 VDC and minimum output-current through USB port(s) is 1.0 Amp, or 2.1 Amp, or 2.4 Amp, or N-Amp (N is any number), or any multiple or combination thereof, which is supplied by an internal USB charger circuit. This is not possible for an electric device or digital device having an external transformer to export minimum 1.0 Amp before USB 3.0 announced specification before 2010. And, before 2010 without the USB 3.0 new specification so output current from a laptop computer only limited the laptop maximum output is only 500 ma, so that it is not possible to obtain a 5 VDC output having minimum current for higher than 1.0 Amp, 2.1 Amp, 2.4 Amp or larger. For laptop USB charging arrangements such as the one disclosed in U.S. Pat. No. 6,474,823, which can only supply a 0.5 Amp current. Such a small current has the disadvantage of greatly increasing charging time for devices such as a smartphone. To charge an i-Phone by 500 ma input-current, It could take almost day to charge at such low current. The present invention also differs from the arrangement disclosed in U.S. Pat. No. 7,736,033, which has a 120 VAC (household current input) and a 12 VDC (automotive cigarette lighter current) output, and then requires a further adapter to convert the cigarette lighter circuit output from 12 VDC to 5 Volt DC (DC to DC). The US prior art as above discussed 2011-008-4660 Mcsweyn that requiring a different, troublesome, and costly design that is unsuited for a lamp base application. The invention is also different from the arrangement disclosed in U.S. Patent Publication No. 2011-017-7703, which includes rotatable and concealable outlet devices that only include an on-off toggle switch and lacks all of the features of the present invention. Similarly, U.S. Patent and Patent Publication Nos. U.S. Pat. No. 7,897,277, 2009-0225486, and 2010-008-4651 all disclose arrangements that lack all of the features of the present invention.

The current invention may also have any of the following 21 features or combinations of features, as follows:

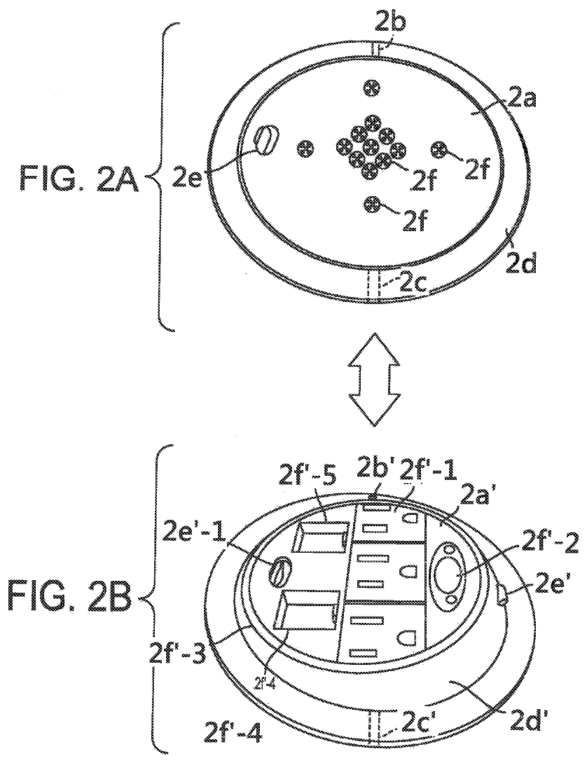

(F1) A power station for desktop installation at a location that is within hand reachable distance while person sitting at a desk, comprising;
From FIGS. 2B, 3B, 4, 6B, 7, 8, 9, 10, 11, 13, 14, 17A to 17D, 18A, 18B, 21 to 24, 30 to 34, 39, 40-49 drawing and background Point (7) detail description show [symbol] at least (a) one USB units, or (b) one outlets, or (c) one electrical power outlet and one USB unit, are assemble with at least one LED unit, to offer multiple power outputs and LED illumination without any digital data delivery hub or other MCU, CPU device,
   said LED illumination including area illumination, or charging/power status indication, or area and charging/power indicator lights, and
   wherein power source for power station is one of housing AC current for different areas select from range 110 to 250 voltage to supply outlet-unit(s) while power station having outlet unit(s), and
   From (Feature 24) detail discussion for circuit work for USB and Outlet and LED light source and optional additional/existing function(s) [symbol] while power station having USB charge function(s), the power station includes built-in or outside AC-to-DC for converting the desire AC current to 1^{st} DC current, and at least one of built-in DC-to-DC circuit change the 1^{st} DC current to at least one of 2^{nd} or more DC current and arrange or distribute or supply the 1^{st} or 2^{nd} or more DC current including separated backup DC battery for time related item while power fail to at least one of
   From (Features 23) details discussion for all additional function(s) [symbol]
   (1) USB charge port(s),
   (2) LED light source,
   (3) other preferred additional function(s) select from
      (a) air flow device,
      (b) audio device,
      (c) other LED(s) for night light or mirror illumination or accent light or color changing light or color selection light or area light or indicator light, charge status light, power status light,
      (d) trigger/sensor/switch/circuitry system or assembly,
      (e) time, alarm, weather, temperature, date, week, month, calendar device to show at least LED or LCD illumination for time display with backup battery for continuously operation for time related function while power fail.
      (f) protection circuitry at least is one of surge protection circuit, MOV protection circuit, leakage current protection circuit, over-heat protection circuit, over-charge protection circuit, short circuit protection system, re-start circuit/system, or other protection circuit.
   at least one of DC current have at least 1.0 A, to allow the at least one USB-unit to have sufficient charge capability to charge other electric, digital-data, audio or video devices in a short time while power station having USB unit(s), or/and
   said circuit supply desired DC current to LED unit(s),
   wherein the at least one LED unit offers area or charging/power status illumination according to pre-determined functions, performance, or effects, and
wherein the power station includes at least one installation kit for preventing, when the power station is put on a desktop or surface at a preferred location, the power station from falling off the desktop or surface as a result of being pulled, moved, or removed by the power station heavy weight of the electric cord or by vibration or by impact strength.
   (F2) A power station, wherein the one of preferred DC output power is one of the following: 1.0 A, 2.1 A, 2.4 A, 3.1 A, 3.4 A, 4.2 A, 4.5 A, 4.8 A, 5.5 A, others, or higher current.
   (F3) From Brief Description FIGS. 18A and 18B details discussed [symbol] A power station, wherein the power station includes at least one additional circuit or electric components selected from a master switch, MOV, surge protection circuitry, overload prevention components, overheating prevention components, re-set or re-start circuit, shut-down circuit, detector-circuit and high voltage components.
   (F4) From (Feature 22) have detail discussion for all additional functions [symbol] A power station, wherein the power station is further or alternative incorporated with at least one preferred additional function(s) or device(s), said function or device being one of
(a) a LED related lights or indicator light or desk lamp,
(b) a time related piece, an alarm/time related piece with built-in backup battery for power fail time keep continuously time operation,
(c) an audio device,
(d) an air flow piece,
(e) an extension cord with a fixing kit to prevent the extension cord from being pulled from the desktop top or surface by a weight of its power cord,
(f) a coffee cup heater,
(g) a key pad or tray or dish,
(h) a speaker or blue tooth audio related device(s),
(i) a wireless transmitting or receiving or talking communication device,
(j) a consumer electric item,
   (F5) From (Feature 23) have details discussion for installation kits [symbol] A power station, wherein said installation kits includes at least one of
(x) a suction cup, air-adhesive piece
(xi) screw, nail, pin, sharp metal piece,
(xii) holder, frame, tray, base, anti-skip pad,
(xiii) Glue, chemical compound
(xiv) double sided tape,
(xv) magnet piece,
(vii) catch, press-n-tight kits
(xvi) hook-and-loop fastener,
(xvii) increase weight element(s).
or
(xviii) desire combination selected from tape, suction cups, adhesive-piece, glue, double side tape, magnetic, catcher, hook-and-loop tape(s), chemical compound, frame, holder, tray, base, anti-skip pad, press-n-tight kits, weight piece, or increasing weight piece(s).
   (F6) From FIGS. 1, 2A, 2B, 3A, 3B, 11, 18A, 18B and discussion [symbol] , A power station, wherein further including at least one of a rotating kit, spin kits, flip-over kits for turning a first surface having at least one of the outlet unit, USB unit, or LED unit to expose at least one hidden surface having at least one of the outlet unit, USB unit, or LED unit.
   (F7) From FIGS. 16A, 16B, 16C, 17A, 17B, 17C, 17D, 18A, 18B and drawing discussion [symbol] A power station, wherein the power station includes a housing designed to fit into or onto, to cover, or to overlay or underlay an existing desktop product(s) in order to save desk space while still providing a power station having DC current charging or supply AC current functions, and without the need for the power station to be positioned on the ground or wall or in a low-profile area where people would have to bend in order to reach the power station.
   (F8) A power station, wherein the power station is installed on desk preferred location(s) where are hand reachable distance or location(s) including desk top, desk side(s), desk edge(s), desk wall(s), under desk board, or desk legs.
   (F9) From (Feature 18) details discussion [symbol] A power station, where the desktop power station USB-ports for output-power to charge other product(s) or input-power to be-charged power station inner rechargeable battery is selected from Type A, or Type C, or Micro or Mini or others specification of USB-port.
   (F10) From (Feature 22) have detail discussion for all additional functions [symbol] A power station, wherein the desktop power station is a LED desktop light or lamp or lighting which has built-in at least one of charging or input-power USB-units, and LED(s) area and/or indicator illumination with or without at least one of additional function(s) selected from (i) outlet(s), (ii) other LED light(s), (iii) Air-flow, (iv) audio, (v) time/date/week/calendar/weather display with or without alarm function(s) powered with back up DC power source or battery for power failure keep continuously time operation
   (F11) From (Feature 22) have detail discussion for all additional functions [symbol] A power station, wherein the desktop power station is a desktop time or alarm time piece or digital time/weather/date/week/calendar display related products or time clock having LED or LCD displayer illumination having built-in at least one of charging or input-power USB-units, and backup battery for power failure time to keep continuously time operation.
   (F12) From (Feature 22) have detail discussion for all additional functions [symbol] A power station, where the desktop power station is a desktop time or alarm clock(s) or digital time/weather/date/week/calendar display related products having built-in at least one of charging or input-power USB port(s) with LED-unit for area(s) and/or indictor illumination.
   (F13) From (Feature 22) have detail discussion for all additional functions [symbol] A power station, where the desktop power station is a desktop cosmetic-mirror products having fixed one side or rotatable more than one side reflect mirror with built-in LED light source(s) for illumination and built-in at least one of USB charging or input-power USB-port(s), and built-in with or without the outlet(s) to supply AC power to AC operated hair or cosmetic device(s).
   (F14) From (Feature 25) have detail discussion for all LED light illumination and functions [symbol] A power station, where the desktop power station is a desktop LED accent light which has desired LED illumination with preferred at least one of functions for color or brightness or timer or trigger-system, and have at least one of color changing, color selection, sleep setting, conductive/dimmer/setting/selective and on-off switch, and built-in at least one of charging or input-power USB-Port(s).
   (F15) From background show the Extension cord or power string discussion [symbol] An extension-cord or power-strip for desktop installation, comprising;
the fixed or extendable or transformable extension-cord or power-strip in preferred geometric shape and construction have at least one or desire combination of
From FIGS. 2B, 3B, 4, 6B, 7, 8, 9, 10, 11, 13, 14, 17A to 17D, 18A, 18B, 21 to 24, 30 to 34, 39, 40-49 drawing and background Point (7) detail description show [symbol]
(a) at least two outlet units,
(b) at least one USB units,
(c) at least one electrical power outlet and at least one USB unit,
and are assemble together with at least one LED unit, to offer multiple power outputs and LED area or indicator illumination without any digital data delivery hub or other MCU, CPU device,
   From (Feature 25) have detail discussion for all LED light illumination and functions [symbol]
   wherein the at least one LED unit offers area and/or indicator illumination according to pre-determined functions, performance, or effects including at least one of area illumination, indicator light, color changing light, color selection light, sleep light, changeable color or/and brightness light, wakeup light or other desire illumination function(s), and
   From background show the Extension cord or power string discussion [symbol]
   wherein the extension-cord or power-strip have desire shape, construction, foldable, extendable, transformable, tilt-able, rotatable, or movable parts, arms, bar those fixed on hand reachable location includes at least one installation kits for preventing, when the extension cord is put on a desk top, sides, walls, underlay or overlay the desk surface, the extension cord from falling from the desk desired location as result of being pulled, moved, or removed by the heavy weight and long length of power supply wires of the extension-cord or power-strip, said installation kits including at least one or desire combination(s) of a suction cup, screw, holder, glue, double sided tape, magnet piece or magnetic with tape or form-tape, fit-and-tight, push tight kits, catch, hook-and-loop fastener, and weight elements.
      (F16) A power station for desktop installation, comprising;
      From FIGS. 2B, 3B, 4, 6B, 7, 8, 9, 10, 11, 13, 14, 17A to 17D, 18A, 18B, 21 to 24, 30 to 34, 39, 40-49 drawing and background Point (7) detail description show [symbol]
      at least two outlet units, or at least two USB units, or at least one electrical power outlet and at least one USB unit, are assembled together with at least one LED unit, to offer multiple power outputs and LED illumination without any digital data delivery hub or other MCU, CPU device,
      Said LED illumination is area illumination and/or charging status indication.
From (Feature 24) detail discussion for circuit work for USB and Outlet and LED light source and optional additional/existing function(s) [symbol]
while power station having USB charge function(s), the power station includes built-in or outside AC-to-DC for converting the desire AC current to 1^{st} DC current, and at least one of built-in DC-to-DC circuit change the 1^{st} DC current to at least one of 2^{nd} or more DC current and arrange or distribute or supply the 1^{st} or 2^{nd} or more DC current including separated backup DC battery for time related item while power fail to at least one of the said USB charging port(s) or USB-unit(s) or LED(s) or additional DC operated function(s), and/or
   the said at least one of desired DC current to the at least one LED offers area or/and indicator illumination according to pre-determined functions, performance, or effects, and
   wherein the power station includes at least one installation kits for securing the power station to a desktop and thereby preventing, when the power station is positioned on the desktop at a preferred location, the power station from falling off the desktop as a result of being pulled, moved, impacted or removed from the desktop by the heavy weight of an electric cord or incoming impact strength or vibration(s), said installation kits including at least one of a suction cup, screw, holder, glue, double sided tape, magnet piece or magnetic assembly, magnetic piece with tape or form-tape, catch, hook-and-loop fastener, and weight element.
   (F17) A hand reachable power station for desktop while person sitting at a desk, comprising;
From FIGS. 2B, 3B, 4, 6B, 7, 8, 9, 10, 11, 13, 14, 17A to 17D, 18A, 18B, 21 to 24, 30 to 34, 39, 40-49 drawing and background Point (7) detail description show [symbol]
   at least two outlets are assembled with at least one LED unit, to offer AC power outputs and LED illumination without any digital data delivery hub or other MCU, CPU device,
   said LED illumination including area illumination, or charging/power status indication, or area and charging/power indicator lights according to pre-determined functions, performance, or effects, and
      wherein power source for power station is one of housing AC current for different areas select from range 110 to 250 voltage to supply outlet-unit(s), and
      From (Feature 24) detail discussion for circuit work for USB and Outlet and LED light source and optional additional/existing function(s) [symbol]
      The power station includes built-in or outside AC-to-DC for converting the desire AC current to 1^{st} DC current, and at least one of built-in DC-to-DC circuit change the 1^{st} DC current to at least one of 2^{nd} or more DC current and arrange or distribute the 1^{st} or 2^{nd} or more DC current including separated backup DC battery for time related item while power fail to at least one of LED unit(s), USB charge port(s), other preferred additional function(s),
         wherein the power station includes at least one installation kit for preventing, when the power station is put on a desktop or surface at a preferred location, the power station from falling off the desktop or surface as a result of being pulled, moved, or removed by the power station heavy weight of the electric cord or by vibration or by impact strength.
         (F18) A hand reachable power station for desktop while person sitting at a desk, comprising;
From FIGS. 2B, 3B, 4, 6B, 7, 8, 9, 10, 11, 13, 14, 17A to 17D, 18A, 18B, 21 to 24, 30 to 34, 39, 40-49 drawing and background Point (7) detail description show [symbol]
at least two outlets are assembled to offer AC power outputs without any digital data delivery hub or other MCU, CPU devic,
   and
   wherein power source for power station is one of housing AC current for different areas select from range 110 to 250 voltage to supply outlet-unit(s), and
herein the power station includes at least one installation kit for preventing, when the power station is put on a desktop or surface at a preferred location, the power station from falling off the desktop or surface as a result of being pulled, moved, or removed by the power station heavy weight of the electric cord or by vibration or by impact strength.
   (F19) A power station for desktop installation, comprising;
From FIGS. 2B, 3B, 4, 6B, 7, 8, 9, 10, 11, 13, 14, 17A to 17D, 18A, 18B, 21 to 24, 30 to 34, 39, 40-49 drawing and background Point (7) detail description show [symbol]
at least two USB units are assembled together with at least one LED unit, to offer multiple power outputs and LED illumination without any digital data delivery hub or other MCU, CPU devic,
Said LED illumination is area illumination and/or charging status indication.
   From (Feature 24) detail discussion for circuit work for USB and Outlet and LED light source and optional additional/existing function(s) [symbol]
   the power station includes built-in or outside AC-to-DC for converting the desire AC current to 1^{st} DC current, and at least one of built-in DC-to-DC circuit change the 1^{st} DC current to at least one of 2^{nd} or more DC current and arrange or distribute or supply the 1^{st} or 2^{nd} or more DC current including separated backup DC battery for time related item while power fail to at least one of LED unit(s), USB charge port(s), other preferred additional function(s),
      the said at least one of desired DC current to the at least one LED offers area or/and indicator illumination according to pre-determined functions, performance, or effects, and
wherein the power station includes at least one installation kits for securing the power station to a desktop and thereby preventing, when the power station is positioned on the desktop at a preferred location, the power station from falling off the desktop as a result of being pulled, moved, impacted or removed from the desktop by the heavy weight of an electric cord or incoming impact strength or vibration(s), said installation kits including at least one of a suction cup, screw, holder, glue, double sided tape, magnet piece or magnetic assembly, magnetic piece with tape or form-tape, catch, hook-and-loop fastener, and weight element.
   (F20) A power station for desktop installation, comprising;
   From FIGS. 2B, 3B, 4, 6B, 7, 8, 9, 10, 11, 13, 14, 17A to 17D, 18A, 18B, 21 to 24, 30 to 34, 39, 40-49 drawing and background Point (7) detail description show [symbol]
   at least one electrical power outlet and at least one USB unit, are assembled together with at least one LED unit, to offer multiple power outputs and LED illumination without any digital data delivery hub or other MCU, CPU device,

Said LED illumination is area illumination and/or charging status indication.
From (Feature 24) detail discussion for circuit work for USB and Outlet and LED light source and optional additional/existing function(s) [symbol]
the power station includes built-in or outside AC-to-DC for converting the desire AC current to 1^{st} DC current, and at least one of built-in DC-to-DC circuit change the 1^{st} DC current to at least one of 2^{nd} or more DC current and arrange or distribute or supply the 1^{st} or 2^{nd} or more DC current including separated backup DC battery for time related item while power fail to at least one of LED unit(s), USB charge port(s), other preferred additional function(s),
   the said at least one of desired DC current to the at least one LED offers area or/and indicator illumination according to pre-determined functions, performance, or effects, and
wherein the power station includes at least one installation kits for securing the power station to a desktop and thereby preventing, when the power station is positioned on the desktop at a preferred location, the power station from falling off the desktop as a result of being pulled, moved, impacted or removed from the desktop by the heavy weight of an electric cord or incoming impact strength or vibration(s), said installation kits including at least one of a suction cup, screw, holder, glue, double sided tape, magnet piece or magnetic assembly, magnetic piece with tape or form-tape, catch, hook-and-loop fastener, and weight element.
   (F21) A desktop item has LED illumination and USB port(s), comprising
At least one LED light source to offer the area illumination, and
The desk top item has at least one circuitry to control the said LED light for color or brightness or timer or trigger-system including at least one of color changing, color selection, sleep setting, conductive/dimmer/setting/selective and on-off switch, and built-in at least one of charging or input-power USB-port(s).
the desk top item has desired LED area illumination and/or indicator light functions.
   From (Feature 24) detail discussion for circuit work for USB and Outlet and LED light source and optional additional/existing function(s) [symbol]
   the power station includes built-in or outside AC-to-DC for converting the desire AC current to 1^{st} DC current, and at least one of built-in DC-to-DC circuit change the 1^{st} DC current to at least one of 2^{nd} or more DC current and arrange or distribute or supply the 1^{st} or 2^{nd} or more DC current including separated backup DC battery for time related item while power fail to at least one of preferred built-in and/or additional device(s) and/or other functions without any digital data delivery hub or other MCU, CPU device(s) select from;
   From (Feature 22) have detail discussion for all additional functions [symbol]
(a) a USB charging current for output through the at least one USB port(s)
(b) LED(s) illumination function is at least one of area, accent, indicator, sleeping, wakeup, timer.
(c) Time, alarm clock related products powered by separated DC battery
(d) LED or LCD time/date/week/month/year/weather display with illuminations powered by separated DC power source.’
(e) Blue tooth audio device(s) or audio related circuitry
(f) Air flow device including fan or bladeless fan or Air-condition or heater
(g) 2^{nd} LED light for offering illumination, charging status, power status.
(h) LED light source for one fixed side/surface or more than one side/surface rotatable cosmetic mirror for lighted objects and reflect lighted image with or without magnify function(s) for N-time magnify (N is any number).
(i) Other DC powered device through USB-ports in preferred USB specification including Type A, C, Micro, Mini or other market available type, or by jack, adaptor, male and/or female plug and/or receiving-ends.
(j) LED light source or DC light source for Desktop reading/working lighting.
(k) Key or objects tray/holder having at least one of charging/power/indicator light.
(l) Camera or video or digital camera with IR help for dark environment take image and/or audio data.
(m) Camera or video or digital camera with LED lighting support brightness to take color image and/or audio data
(n) Desktop items has wireless transmitting and/or receiving system.
(o) Desktop item has motion/moving/radar/vibration/sound/photo sensor for triggering the related device(s) or function(s).
   the said at least one of desired DC current which is same or different with USB charging port(s) needed DC current, to the at least one LED offers area or/and indicator illumination according to pre-determined functions, performance, or effects,

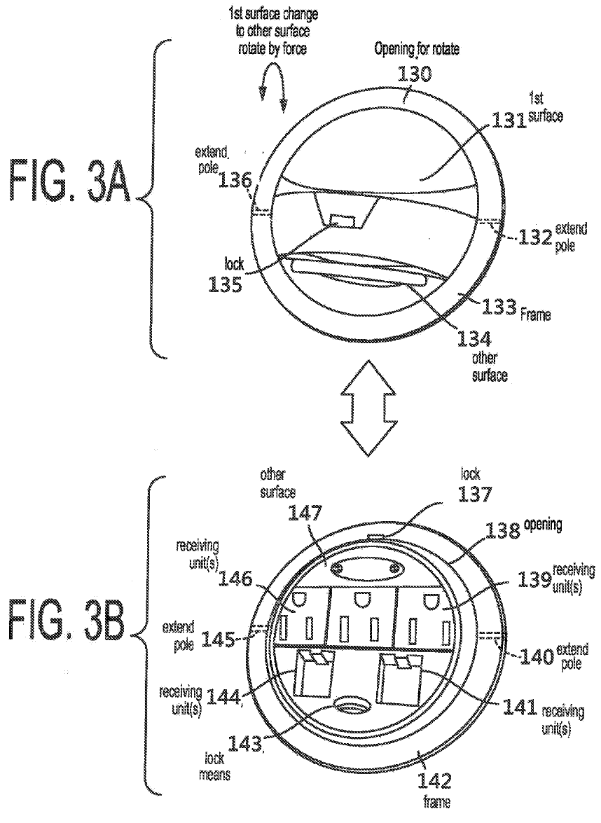

FIG. 1 and FIGS. 2A, 2B shows a multiple surface(s) LED light that is installed in a recess surface of the housing (2d) or surface (2d) and that corresponds to the one disclosed in the inventor's U.S. patent application Ser. No. 12/950,017, and which includes a first surface (2a) having an LED element(s) (2f) installed thereon. When an external force is applied to the LED light to cause it to rotate, as indicated by FIG. 2B, a second surface (2a′) is exposed, as shown in FIG. 2B, and fixed in position by lock kit (2e′-1) (2c) to offer people outlets (2b′) for a power source, an Internet socket (not shown), phone socket (not shown), USB port (2f-5) thereby providing people with additional convenient or additional functions at the same location as the LED light. The multiple surface LED light can continue to rotate to return to the first surface, as indicated by FIGS. 2A, 2B, 3A, 3B, when an external force is again applied to the LED light so that it can be continuously rotated as indicated in the notes included in FIGS. 1, 2A, 2B, 3A, 3B. The LED light may have more than two surfaces and rotate to each of the surfaces successively, with the LED light being provided with poles to enable rotation. The second surface illustrated in FIG. 2B, 3B may not only include power outlets and internet/phone connections, the second surface may include USB ports, digital data storage device ports, memory device ports, charger sockets, jacks, adaptors, and various plug means and other connectors. The shape of the surface is not limited to circular or round one, shape may also include other frame shapes such as hexagonal or multiple edge shapes, and the number of surfaces may for example be six, four, or three as well as the illustrated two sides.

The single location of the multiple surfaces therefore can provide multiple electric applications, as shown in FIGS. 1, 2A, 2B, 3A, 3B, which will save a lot of space, especially for a working table or under cabinet light fixture.

FIGS. 2A, 2B, 3A, 3B show an application of the light device of the first preferred embodiment, in which the multiple surface LED light may be applied to a ceiling, walls, door, floor or even a surface by itself without any other main object, substrate, or housing. The phrase “by itself” means that the multiple surface LED light is directly installed in a building, house, furniture, ceiling, wall, door, closet, or cabinet rather than being provided as a discrete unit as is the case with conventional power strips, LED light fixtures, light devices, and light bars.

As shown in FIGS. 2A, 2B, 3A, 3B, the first surface (2a) has a plurality LEDs or an LED dot matrix array made up of LED sets (2f) installed on the first surface (2a), and two bars including an extended top bar (2b) and low bar (2c) that provide a pivot axis about which the LED light can be rotated. The two extended bars also have an inner channel to enable electric signal delivery from ends of the bars into the LED light. The electric connections of the embodiment of FIG. 2A may correspond to inventor's prior electric connections shown in the parent filed cases, or utilize any other conventional electric signal delivery skill. A lock kit (2e) enables the LED light to be locked in a particular position without changing the surface to another surface. For example, when the LED light is in the position shown in FIG. 2B, if a lock kit (2e) were not provided it would be too easy to rotate the device to a different Surface(s) or position, which could be very dangerous in the case where a prong unit has been inserted into the outlet socket(s) (2f-1). The lock kit (2e) (2e′) (2e′-1) not only provides a locking functions, but also may act as s release kit to enable the LED light to be changed from a first surface to other surfaces as needed.

The other surfaces (2a′) may has the outlet sockets (2f-1), internet sockets (2f-5), phone sockets (2f-4), and/or sensor means (2f-2) to offer people a very convenient LED light with multiple functions when the surfaces are changed.

FIG. 3 shows additional details of the construction of the LED light of FIGS. 2A, 2B of LED light and the manner in which it rotates from the first surface, shown in FIG. 3A, to another surface shown in FIG. 3B, by rotating about the extended poles upon release of the lock kit (2e) (2e′-1) shown therein. The respective surfaces shown in FIGS. 3A and 3B correspond to those shown in FIGS. 2A and 2B.

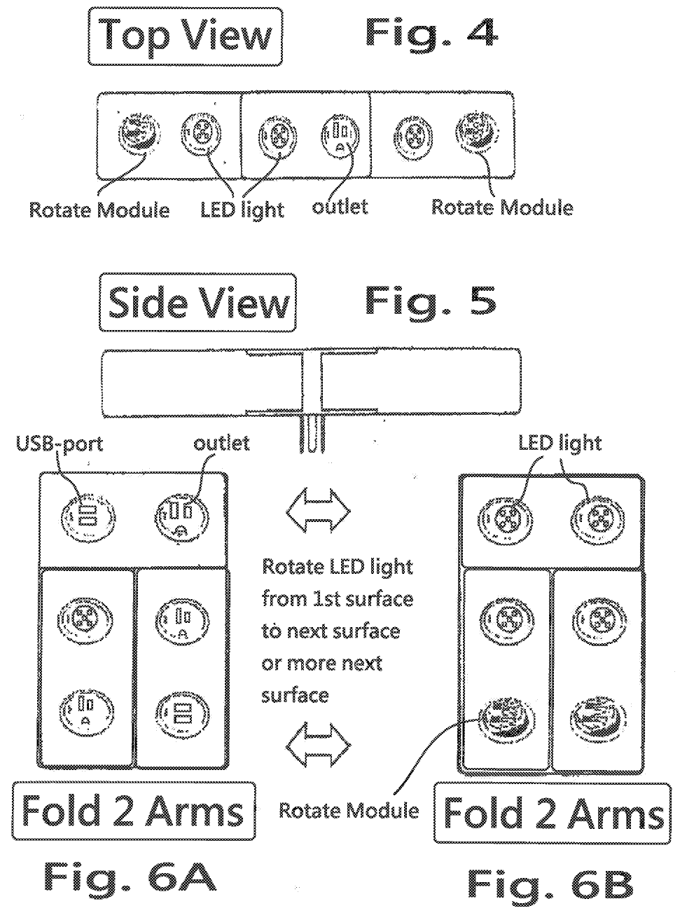

FIGS. 4, 5, 6A, 6B, 7, 8, 9 show the manner in which preferred extendable, changeable, foldable, transformable multiple surface and functions LED lights are applied directly to a ceiling, walls, or the surface of a building or house and also to existing electric products. The said extendable, changeable, foldable, transformable multiple function LED light shown on FIGS. 4, 5, 6A, 6B, 7, 8, 9 also can fit on desktop power station for easily operate the preferred USB-port(s), Outlet-port(s), LED light source(s) with or without additional built-in functions(s) as long as have (1) AC-plug wire to get AC power source and (2) installation kits or sets to install the said extendable, changeable, foldable, flexible, transformable multiple function LED light on the desk top, sides, walls, legs, base for current invention to prevent people from bend body or knee down to get USB-port(s) or/and outlet-port(s). This is big improvement for desk top item or desktop power station of current invention to supply easily way to access the USB-port(s) and/or Outlets-ports on the desk top hand reachable distance. Any of the existing products that do not include the light device of the present invention will become out-of-date. More specifically, FIGS. 4, 5, 6A, 6B, 7, 8, 9 all show LED light bars, or outlet devices, extension cords, or power strips which have been modified to include the multiple surface light devices of the present invention and to be foldable or extendable or transformable as disclosed in the inventor's U.S. Pat. Nos. 7,824,185 and 7,726,841. The present invention differs from the arrangements disclosed in the inventor's prior patents in that the foldable, extendable, retractable, transformable light fixtures disclosed therein are limited to inclusion of outlet units or LED units, whereas the modified foldable, extendable, retractable, transformable light fixtures include light devices that can be changed to USB-port(s) devices on the different multiple surfaces so as to not only offer LED lighting and outlet(s) but also USB-port(s) and other female receiving port(s) or end(s) including internet, phone, motion sensor or other functions. It will be appreciated that the multiple surface LED lights of the current invention may be applied varied without departing from the scope of the current invention. In addition to the foldable, extendable, retractable, transformable devices, the light device of the preferred embodiments may be applied to the power strips, light fixture, and extension cord of the inventor U.S. Pat. No. 7,824,185), the wall outlet device or LED light device has all the said female conductive receiving piece(s) which is including outlet(s) or USB-port(s) and just simple change the plug-in prong to AC-plug wire to get same AC power source with installation-kit(s) to install on desk or table anywhere to become the current invention for desk top, side, wall, edge power station or desk top items. The co-inventor parent filed case including below list which has both LED light source and female receiving conductive end(s) or port(s) including;

U.S. Pat. No. 7,618,150, the foldable device or extendable device of the inventor's
U.S. Pat. No. 7,722,230, the removable device of the inventor's
U.S. Pat. No. 7,726,839, and the transforming device of the inventor's
U.S. Pat. No. 7,726,841.

To make plug-in prong to AC-plug wire and add the installation-kits to install on desk or table top, wall, sides, legs, base or preferred location is very simple modification of parent filed wall plug-in multiple functions LED light or desktop items or existing products will become very useful and practical items because of the addition of multiple functions LED light now is located on hand-reachable distance instead of the original products install on wall or ground which people need bend body or knee down to make operation, which should be make them more valuable for people.

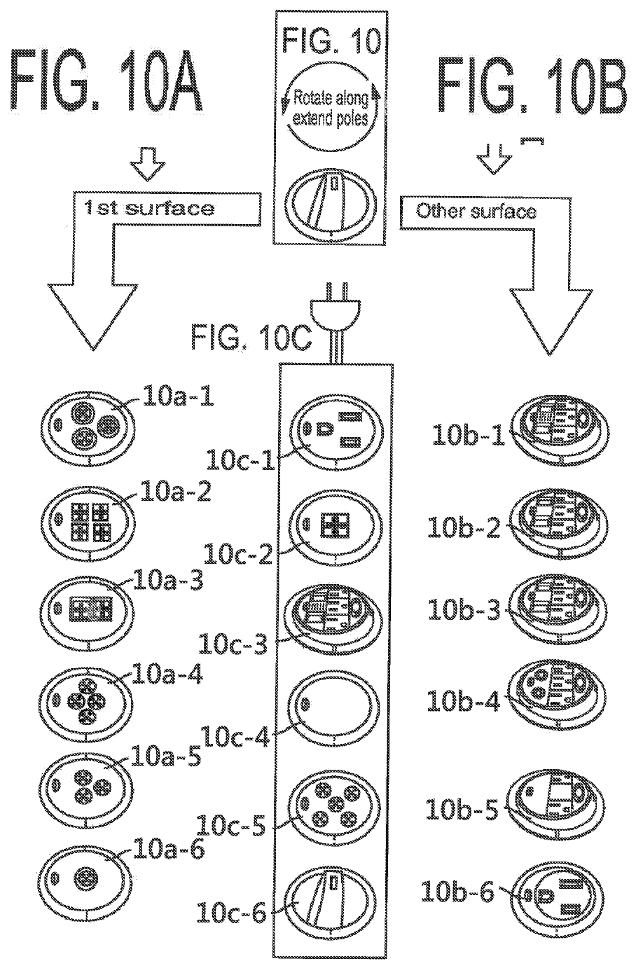

FIG. 10 shows alternative or replaceable or equal functions for desk top, walls, sides, legs, base installation extension-cord or power-strip other existing electric products to which the multiple function LED light device of the present invention may be applied by adding installation-kit or set or assembly to the said multiple functions or multiple surface extension-cord or power-strips with built-in LED area or indicator light for illumination or indicate the charging or on/off status or re-start or surge protection or other protection or warning signals for multiple functions desk or table or side-table ow working table installed extension-cords or power-strips. Although the power-strips have certain required specifications, it is possible to add an LED light to the outlet unit with only a limited change in dimensions because one can use an LED chip having a thickness of a few millimeters so that the multiple function or multiple surface extension-cord or power-strip having built-in LED light including preferred at least one of outlet on surface will have dimensions that are essentially the same as those of the outlet-units in the existing power strip despite the big increase in functions. For example, all power-strips or extension-cords can add the LED elements on a first surface and still keep the original outlet-units of the power-strips or extension-cords to enable the power-strips or extension-cords to become under-cabinet LED light units that allow people to change some of the LED lights into outlet-units other electric devices.

FIGS. 10, 10A, and 10B show different possible arrangements for the first surface (FIG. 10A) and the other surface as (FIG. 10B), with FIG. 10 show a desk or table installed power-strip or extension-cord that utilizes different first and second surface arrangements of the multiple surface LED lights.

FIG. 11 shows another preferred embodiment in the form of a round shape power-strip or extension-cord which has a plurality of the multiple LED lights arrangement (11-2) (11-3) (11-5) (11-6) on preferred surface (11-1) and each of the LED lights (11-2) (11-3) (11-5) (11-6) has LED elements with a different style, thickness, shape, brightness, color, control system, circuit, turn-on/turn-off timing, sensor(s), switch(s), power output end(s) or port(s), and so forth to make preferred number and color LED(s) to have color changing, color selection, brightness adjustment, motion/photo/radar sensor(s), sequential flashing, wireless control, wireless adjustment, wireless setting, built-in camera/storage unit(s), incorporate with wifi and 3/4/5/ or more advanced internet and download APP software to make wireless connections. Each of these multiple LED lights can change from preferred to other surfaces if needed to do so as above discussed on FIGS. 1, 2A, 2B, 3A, 3B or changed related position or orientation as above discussed FIGS. 4, 5, 6A, 6B, 7, 8, 9. And, in particular from surface (11-5) to surface (11-7), from surface (11-6) to surface (11-11), from surface (11-2) to surface (11-9), and from surface (11-3) to surface (11-10). The center unit (11-4) is not a multiple surface LED light. The side drawing shows how the multiple surfaces (11-2) (11-3) (11-5) (11-6) are changed by rotating from (11a) to (11b) to (11c) and to (11d), so that it is clear how to carry out a change from the first surface to another surface by external force, which may be manual or provided by a motor to automatically the design, or change the design by wireless remote control, or by other external force applying mechanisms depending on market requirements.

FIG. 12 show a sealed universal module of the type disclosed in parent U.S. patent application Ser. No. 13/117,227, which extends the principles described in the inventor's U.S. patent application Ser. Nos. 12/502,661, 12/292,580, 12/566,322, 11/498,874, 11/527,629, 12/622,000, and 12/624,621. These applications disclose a sealed-unit with uniform dimensions or shape that fits into uniformly-dimensioned compartments of a variety of LED light devices. The present invention has more features, functions, and effects than those described in the inventor's prior applications since the sealed-units are not only light units or one type of outlet-unit, but also include additional outlet units, such as USB-units, to supply different electric power to different devices. The universal module of the current invention can have any combination of the following parts or accessories: circuit(s), conductive-piece(s), contact-piece(s), receiving-end(s) or port(s), output-ends, input-ends, electric parts and accessories, prong, rotating configuration, cable with an AC plug, cable with a USB-plug, printed circuit(s), flexible printed circuit(s) wires, cables, a digital data cable, a conductive plate, or any related electric parts or accessories available from the marketplace so as to obtain electric power from the AC prong or AC-plug wire, separated USB-cable, or USB related parts and supply it to an outlet-unit's or USB-unit's receiving-port(s), and thereby supply the power to a variety of electric devices.

The universal module may have functions which are equivalent to or the same as the “sealed-unit” for an “LED light device” described in the inventor's issued U.S. Pat. Nos. 7,726,839, 7,726,841, 7,726,869, 7,618,150, and 7,722,230 and U.S. patent application Ser. Nos. 12/073,889, 12/894,865, and 12/003,809, or the “outlet device” described in the inventor's U.S. Pat. No. 7,824,185, in which the sealed-unit is an outlet-unit. Furthermore, the present invention may utilize concepts of the interchangeable sealed-unit or battery-pack described in the inventor's U.S. patent application Ser. No. 12/622,000 and some of the above-listed related patent applications.

The sealed units S2, S12, and S23′ shown on the right side of FIG. 12 each includes pre-designed openings (S2′) (S12′) (S22′) to allow the universal type of the sealed-unit (S2) (S12) (S22), which fit into the openings (S2′) (S12′) (S22′), to be assembled to the night light or accent light or candle light with or without additional functions such as time display, wakeup light, sleep countdown timer light. From Fig. U, the said Sealed unit (S23′) or universal unit assembly with any kid of LED light device (S20) by screws (S23) (S24), welding, sonic sealing, glue, solvent, rivets, catches, or equivalent fixing-kits. The sealed-unit (S2) encloses an LED related circuit (S8) and its components (S9), and prong (S7) (S7′) are sealed within the case (S2). The top of the case has two LEDs (S3) (S4) which are connected with the inner circuit (S8) but none of the LEDs' electric legs can be touched by test equipment to make sure a kid's finger will not touch these live wires to cause a dangerous condition. The LED (S5) uses conductive wires (S6) arranged to be pulled far away from the unit's housing (S2) for other illumination arrangements. The LEDs (S3) (S4) also fit into the LED Light device base opening (S3′) (S4′) and a wall (S2″) will cover the LEDs after assembly with the base housing. After assembly, the LED light beams can pass though the base's opening area (S1) to provide the upper display with good light effects.

From Fig. T, the tube base (S10) has an opening (S12′) to allow the sealed-unit (S12) to be fitted with two or more LEDs at a desired position and orientation, and an arrangement that allows the LED light beams to be emitted from the base top opening (S18) and lower window (S18′) for desired illumination.

The any LED light base (S10) can be any geometric shape including Fig. U rectangular base (S20) may also has a special light arrangement. The LED spot light is directed through a light-medium (S28) to allow the LED light beam to travel within the light-medium (S28) and a majority of light beams to be seen by a viewer from the light-medium (S28) surface in such a way that the viewer will not see any hot spot of cause by the LED light brightness, but rather will see a very soft and even photometric area light for special illumination. From Fig. U LED light rectangular base (S20) has an opening (S22′) that allows the sealed-unit (S22) to be fitted tightly therein and secured with glue, solvent or other adhesive material, sonic sealing, welding skill, catch kits, or hook piece to assembly with the rectangular housing (S20). The LED will fit into the light-medium's thickness to get the best result.

By comparison the current invention for desk top power station with co-pending wall mounted plug-in power station, as shown in following discussion;

FIG. 12, part A, show a module according to a first variation of a first preferred embodiment of the invention includes a cable with a USB-plug (160) and has two built-in USB-unit(s) (161) and two rotatable outlet-units (162) to form a universal module. Each USB-unit (161) has a pre-determined power output determined by inner built-in circuitry and related parts and accessories. The two rotatable outlet-units (162) may be the same as the rotatable outlet-units shown in U.S. Pat. No. 7,824,185, which provides details of how to construct the outlet-unit to rotate.

FIG. 12, part B, shows a universal module according to a second variation of the first preferred embodiment having the same function as the universal module of drawing A, but which differs in that the USB-unit has a cable with a prong-plug (163).

FIG. 12, part C, shows a universal module according to a third variation of the first preferred embodiment with the same function as in drawings A and B, but which uses wall prong (164) to get the power directly by plugging the prong means into an outlet without the cables of part A or part B.

FIG. 12, parts D, E, and F show different input ends of a universal module according to variations of the first preferred embodiment that enable the universal module to meet all market requirements. Part D shows a cigarette plug (165) to allow people to get power while they are driving, Part E shows a connection (166) to another power source, which can include solar power, wind power, chemical power, a generator, a transformer, a solar module, USB-unit(s), or other any kind of available power source, all of which will still fall within scope of the current invention. part F shows an alternative plug (167).

FIG. 12, Parts G, H, I, J, and K, show variations of the first preferred embodiment with different combinations of outlet-unit(s) (168) and USB-unit(s) (169) from 1 to N in number and with a desired power input and power output as discussed above.

FIG. 12, parts Q and R show further variations of the desk or table top power station or extension cord with preferred embodiment that include respective LED light unit and module (170) and (171) having more than one outlet-unit (172), and in which one of the outlet-units (173) can be selected as the master that turns-on or turns-off other outlets.

This desk top power station or power strip on desk or table top with AC-plug wire to install on the top of desk, table, cabinet, side-table of bed and This desk top power station is a very good function for people while people use laptop computer or phone or communication device(s). The master control is very useful for people to use computer system, when turning on a computer, the related printer, scanner, hub, USB-hard disk, speaker, reading light, hard-disk, and other computer-related parts and accessories can all be turned-on and turned off when main master outlet-unit has been activated.

In the variations of the preferred embodiment shown in FIG. 12, parts M, N, Q, and R the desk or table top power station or extension cords or LED light device or other desktop items get power by AC-Plug wire to get the AC current from wall or other outlets instead of parts S, T, U get power from prong. From the Part S, T, U are parent filed case for prong plug-into outlets to get AC power source and supply to the power station, or extension cord, or LED light device or other plug-in electric device which has at least one of USB-port(s) and/or outlet(s). It is simple to change prong to a cable-with-plug or cable-with-USB plug and added the installation-kits as above discuss (Features 23) to make plug-in device become a desk or table top items such desk top power station, LED light, other electric device as Part M, N, Q, R shown the LED desk top light (175) (Part L), or LED accent or color change Tube or cylinder or candle light with preferred time related functions at least for time display or alarm clock with separated DC battery for all time related functions (176) (Part M), or desk top power station or power-strip with holder or/and wire arrangement (177) (Part N), desk top power station or power-strip with LED light source and USB-port(s) and Outlet-port(s) (178) (179) (Part Q and Part R).

For more lower cost, the said Part Q (178) and Part R (179) can just have outlets device with or without LED for charging or on/off indicator light for desk top application to serve as a traditional extension cord for 120 Volt 60 Hz outlets only, or for up-grade model has desired number of USB-Port for upgrade power cord. It is appreciated the FIG. 12 for all preferred embodiments (175) (176) (177) (178) (179) for desk top items or power station or extension cord showing all modules with a cable or without a cable or power cord, or with a direct plug-in to a wall outlet will all still fall within the scope of the current invention.

FIG. 12, parts L (175), M (176), N (177), Q (178), and R (179) show different applications for the desk or table or side-bed table or cabinet power station or power strip/or LED lighting/or LED or LCD illumination alarm clock/or LED lighted cosmetic mirror/or others LED lighted electric device for desk or table top applications or times. These applications are limited examples of the current invention preferred embodiments with any desired combination of USB-unit(s), outlet-unit(s), LED area and/or indicator light illumination, additional function(s) for a variety of electric device(s) or digital data device(s), including indoor or outdoor devices such as a desk lamp (175), desk top color changing LED light has built-in separated backup battery for power fail time to keep time operation is continuously operation for time related functions and (176), desk top power station has at least one of USB and outlet and LED light illumination (177) (178) (179), extension cord or any other electric device(s) or digital data device(s). A major difference between the current invention and all market-available devices is that the current invention provides for all related safety certifications to be obtained for the universal module itself so that the universal module can be directly added into any existing electric device(s) or digital data device(s), with no need to file for other UL, CSA, or ETL certifications, or to provide any additional laboratory test when a product utilizing the universal module enters into a market.

The universal module shown in FIG. 12 has the very important feature of enabling all related safety certifications to be obtained before adding into an existing device, the module having one output-end that can connect with the existing product's power input-end, so as to allow the existing power input-end to connect with the universal output-end, and make it very simple to add the universal module into any existing electric device(s) or digital data device(s) to save a lot of time, money, procedures, applications, and human resources that would be required to file the related safety standard certifications for individual products.

As explained above, the embodiment of FIGS. 12, 13, 14, 15A, 15B, 15C multiple functions LED light have prong or alternative have AC-plug-wire with installation-kit to install the said desk top/wall/sides/base/installed power station or desk top items as current invention which provides at least one having a desired combination of outlet-unit(s) and/or USB-unit(s) and LED light source and built-in with desired power-out-put ends and optional having power-input ends to receive outside DC power and supply the power to built-in rechargeable batteries.

The illustrated of FIGS. 12, 13, 14, 15A, 15B, 15C said outlet-unit(s) or USB-unit(s) of the preferred embodiments of the invention may have any combination of parts or accessories for providing necessary output power and connections, including, as appropriate, circuits, conductive-piece, contact-pieces, receiving-port(s), output-ends, input-ends, electric parts and accessories, prong, rotating assembly, support kit, holder, length or width adjustment kit for holder, LED light unit, or 2^{nd} or more LED light, cable with a plug, cable with a USB-plug, printed circuit, flexible printed circuit, wires, cables, digital data cables, a conductive plate, a transformer, inductors, diodes, capacitors, resistors, transistors, inverters, surge protective circuits, Zener diodes, an IC or integrated circuit, or any related electric parts or accessories available from the marketplace.

FIGS. 12, 13, 14, 15A, 15B, 15C, The outlet-unit(s) and/or USB-unit(s) can incorporate IC and/or other control system such as a switch, motion sensor, infrared remote control, remote controller, timer, time delay, dimmer IC, and/or master control system to control all other outlets of a multiple outlet device, or any IC chip with special functions to cause the outlet-unit(s) or USB-unit(s) to turn-on and turn-off according to a predetermined function, time, duration, or frequency as desired to control all existing electric device(s) or digital device(s) to provide more practical functions than ever before.

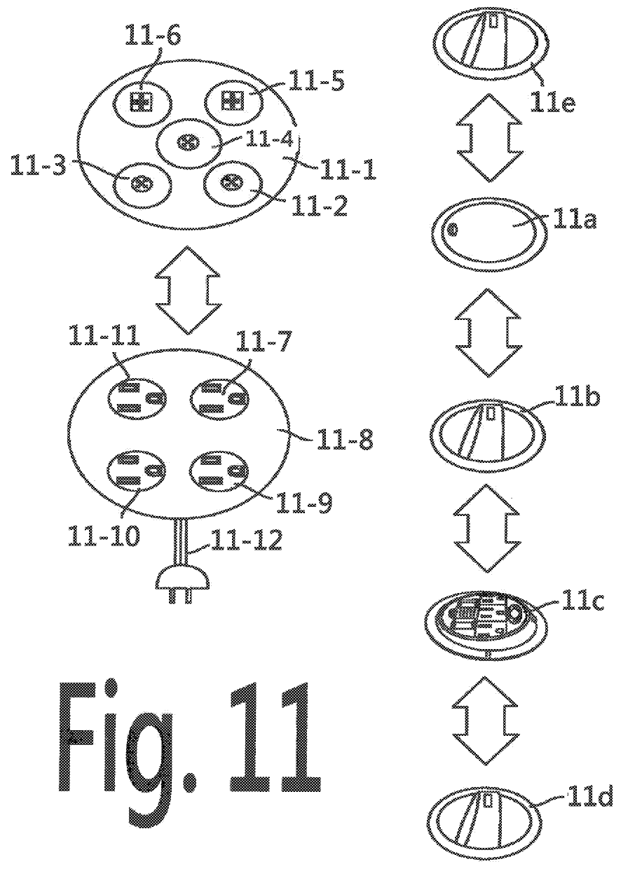

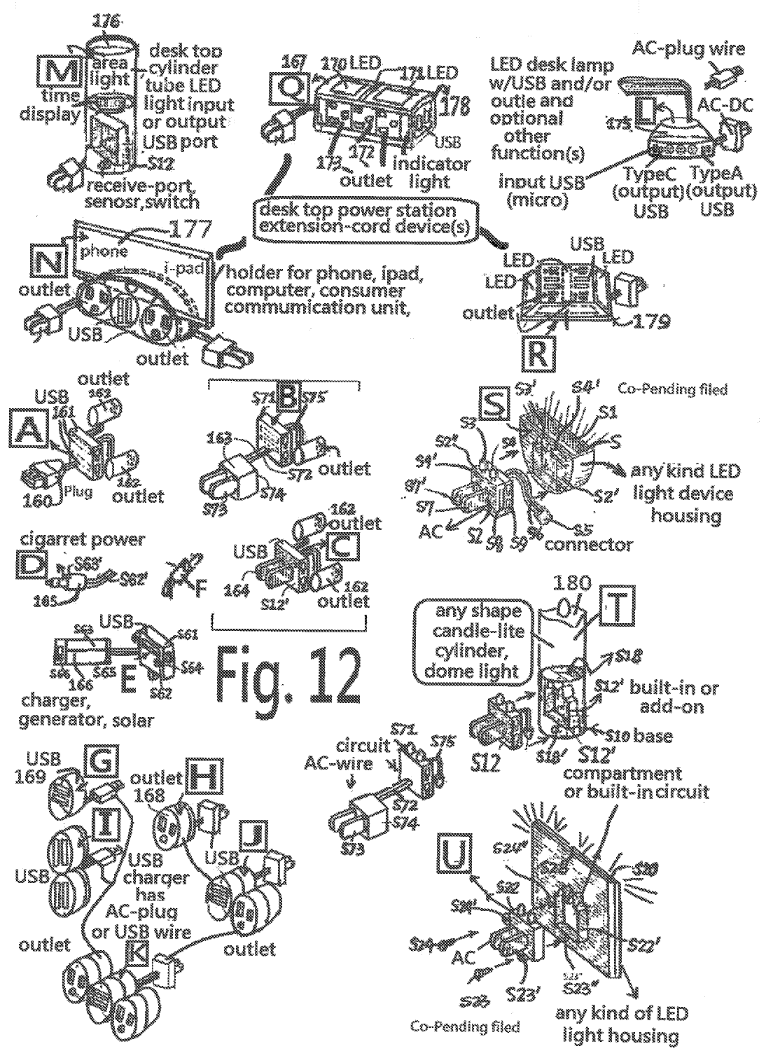

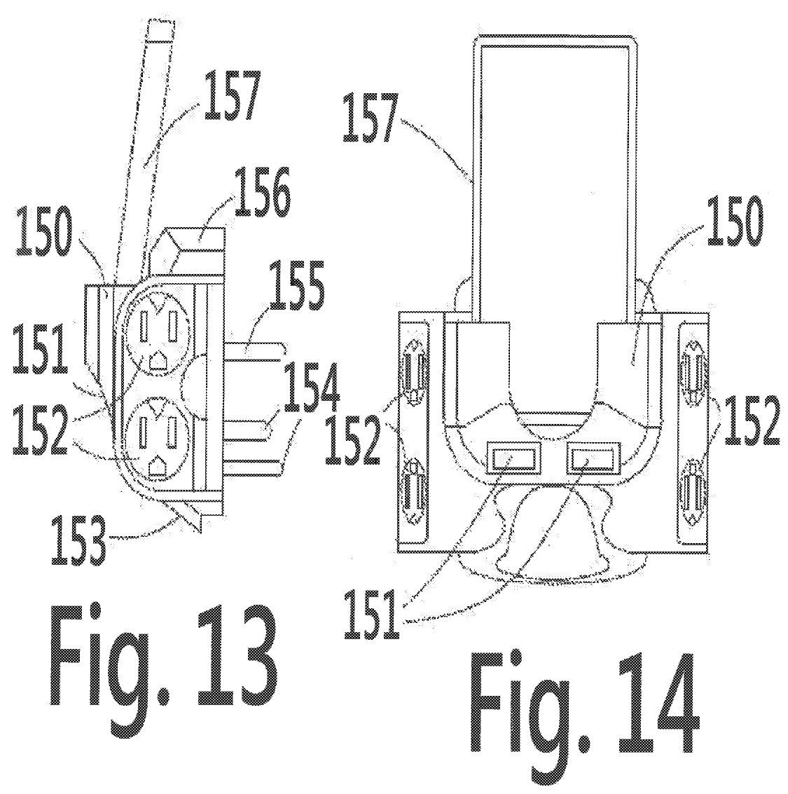

FIGS. 13 and 14 illustrate a multiple functions LED light (150) having built-in outlet-unit(s) (152) or USB-unit(s) (151) and in addition a built-in LED light (153), holder, support (155), prong (154) or alternative AC-plug-wire (not shown) with installation-kit(s) for current desktop power station or wire with a AC-plug for plugging into a wall-outlet, wall-adaptor, or extension-cord (when incorporating cable with a AC plug) to provide a USB-charging current or 120 Volt, 60 Hz AC, or other electric power. The said input power source 110 volt house electricity go though built-in or outside transformer AC-to-DC, and at least one of the DC-to-DC circuit to create the at least one or more than one of DC current which is same or different for supply to USB-charging-ports DC current including the separated DC battery source for time related additional functions' to supply preferred DC current to at least one of USB-charging port, LED light source, Circuit, and optional additional function(s) built-in the said power station, desk top items, power-strips, extension-cord which incorporated with installation-kids to install on desk or table top/walls/sides/edge/legs/base.

FIGS. 15A to 15C illustrate another desktop power station or desktop item in the form of a power-strip which has different low outlet-unit(s) (5a-a), and/or USB-unit(s) (5a-c) on one power-strip, and in which detachable LED-unit (5a-b) can also be plugged into respective lower outlet-unit(s) (5a-a) so the desktop power-strip have outlet, and USB-port, and LED light unit. The said lower positioned outlet(s) (5a-a) have prong or plug openings in the lower outlet-unit(s) to receiving any AC powered LED light unit or other electric products. The said USB-unit(s) (5a-c) to provide DC current to charge other electric products while the separated USB-wire male plug plug-into the USB female receiving-end(s) or port(s). This is one of preferred and a specially designed multiple function power-strip but it should not limited for all alternative or replaceable or equal functions design or construction or configuration of the said desk top/wall/sides/base installed power-strip or power station which has preferred installation-kits or system or assembly to install the said power-strip or power station on desk or table or side-bed.

From FIGS. 15A, 15B, 15C, The multiple function power strip can be powered by a AC-plug wire (164) to get AC power source for AC-outlet supply power and/or for internal AC-to-DC and/or at least one or more than one DC-to-DC circuit to create at least one same of different DC current that for USB-charging ports to supply to DC operated functions including the additional function(s) discuss on above Features 23.

The FIGS. 15A, 15B, 15C that serves as an extension cord or power strip, as shown in Fig. Each of the outlet-unit(s) (5a-a) or USB-unit(s) (5a-c) can be made rotatable if required by the market as taught in the inventor's above-cited issued and pending U.S. patent applications. This allows the universal module to be easily changed from original outlets or LED-sealed units to multiple functions devices.

The desk or table power station or extension-cord of FIGS. 1-14 and 15A-15C may include a master control feature in which turning on or turning off a device connected to the master control outlet-unit turns on and turns off power to all other outlets-units or/and USB-units and/or LED light unit(s). In addition, the desk or table power station or extension-cord can also be turned on and turned off by electric or mechanical switch or sensor, and can have any desired number and combination of LED sealed units, outlet-units, and USB-unit(s) with rotatable features or fixed angle features. In addition, the desk or table power station or extension-cord can be sealed by glue, chemical sealing means, compounds, magnetic piece, magnetic tape, anti-skip pad, increase weight element(s), or a liquid to prevent electric shock from any live wires, and can be included in, for example, a desk lamp, wall outlet, extension cord, power strip, generator, solar power module, wind power device, or transformer device.

FIGS. 16A, 16B, 16C, 17A, 17B, 17C, 17D, 18A, 18B show the desk or table or side-table power station (170) or extension-cord (170) application has installation kits as (Feature 23) discussed for all kind of skill or parts to install the said desk top/walls/sides/edge/leg/base installation power station.

FIGS. 16A, 16B, 16C, 17A, 17B, 17C, 17D desk or table power station (170) or extension cord (170) with installation-kits (not shown) which has big size so can overlay to a smaller-size other product base of existing desktop items, or has openings (173)/groove (173)/ditch (173) to overlay the said smaller-size other products base (not shown) of desktop items which has its own existing function or cosmetic value. Wherein the said power station (170) or extension-cord (170) have built-in Outlets-unit(s) (171) and USB-port (172) on the wall to supply the USB-port(s) charging port to charge other DC operated electric products inner rechargeable battery and also supply AC current to other AC operated products. FIGS. 16A, 16B, 16C, 17A, 17B, 17C, 17D desk or table power station or extension cord also have detail discussion on 1^{st} paragraph of the detail description.

FIGS. 18A, 18B, 19A, 19B, 20A, 20B, 20C show alternative overlay or underlay the desktop power-station or extension-cord with built-in outlets-unit(s) on top surface and/or USB-unit(s) on side-wall. The said desktop power-station can be only outlet-unit(s) or only have USB-unit Same as co-pending parent case (# R-1) U.S. application Ser. No. 14/739,397 filed on Jun. 15, 2015 publication No. 2016-000-3429 publication date on Jan. 7, 2016 now is US patent U.S. Pat. No. 10,184,624 claim LED light device “The said LED light device has LED(s) to offer illumination and has additional function which is at least one conductive receiving ends or ports to supply the power to other electric products” which is CIP of (#R-2007) U.S. application Ser. No. 11/806,285 filed on May 31, 2007. Basing on the parent filed case for Multiple function LED light for Plug-in wall out, the current invention just change the plug-in prong to AC-pluge-wire and add the installation-kit(s) as above discussed (Feature 23) for all kind of installation-kits become current invention scope for desk or table top/walls/sides/edges/legs/base power-station or extension cord.

Further, the co-inventor co-pending filed case (#TTT) U.S. Ser. No. 13/870,253 filed on Apr. 25, 2013 same date with current invention parent filed case (# SSS-2013) now is U.S. Pat. No. 9,559,472 issued on Jan. 31, 2017 which has same desk or table top/walls/sides/edge installation “power station or extension cord for hand-reachable distance have USB-charging-ports only”.

Further, the co-inventor co-pending filed case (# UUU) U.S. application Ser. No. 13/870,447 filed on Apr. 23, 2013 now is U.S. Pat. No. 9,488,364 which cover the desk or table top/wall/sides/edge/legs/base “power station or extension-cord with built-in display or liquid display or stationary compartment or other compartment”.

Basing on the co-inventor for desk or table top/walls/sides/edge/legs/base installation power station or extension-cord for 3 issued US patents (#R-1=parent 2007) (#TTT=2013) (# UUU=2013) as above list details U.S. application Ser. No. and U.S. patent number and claims coverage show evidence the current invention should overcome all US prior arts.

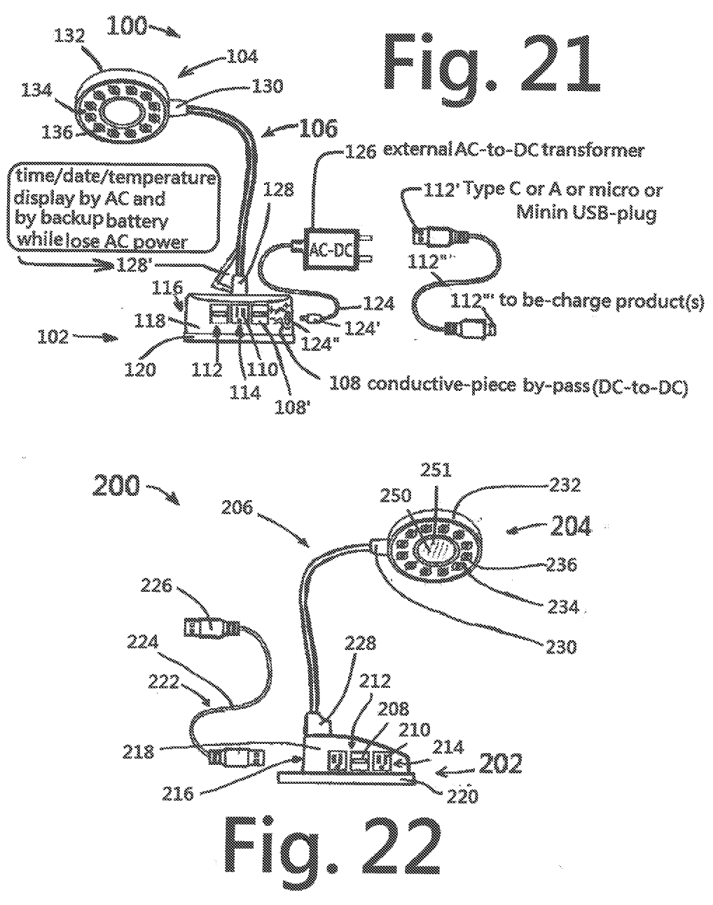

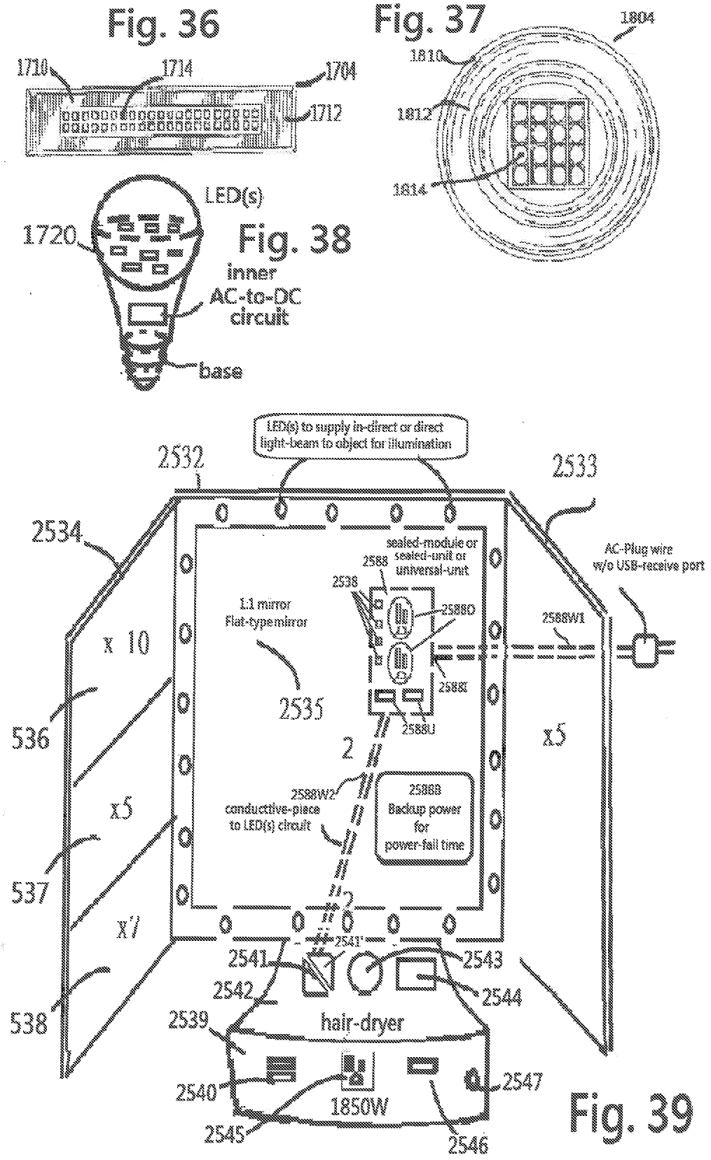

FIGS. 21-49 show various desktop items as previously disclosed in the inventor's parent U.S. patent application Ser. No. 13/161,643 for a “desk top items having USB-unit(s) and/or outlet-unit(s) for Electric or Digital Device(s)”. All the detail description of FIGS. 21-49 can refer to below co-inventor's co-pending filed case and its parent filed date on 2011 as below details for U.S. application Ser. No. and Filed date. It is appreciated all the above filing history parent filed case or co-pending case for all the concepts, spirit, idea, configuration, construction, drawings, discussion should still fall within the current invention scope and claims coverage without limitation. The FIGS. 21 to 49 is identically with all below parent filed case which the 1^{st} parent filed case is U.S. Ser. No. 13/161,643 filed on Jun. 16, 2011 now is U.S. Pat. No. 8,783,936 issued on Jul. 22, 2014 and all CIP filed history including;
(#GGG-11) U.S. Ser. No. 14/951,872 filed on Nov. 25, 2015, which is CIP of
(#GGG-10) U.S. Ser. No. 14/875,675 filed on Oct. 5, 2015 which is CIP of
(#GGG-9) U.S. Ser. No. 14/870,601 filed on Sep. 30, 2015 which is CIP of
(#GGG-8) U.S. Ser. No. 14/834,613 filed on Nov. 10, 2015 which is CIP of
(#GGG-7) U.S. Ser. No. 14/834,823 filed on Aug. 25, 2015 which is CIP of
(#GGG-6) U.S. Ser. No. 14/834,557 filed on Aug. 25, 2015 which is CIP of
(#GGG-5-1) U.S. Ser. No. 14/858,838 filed on Sep. 18, 2015 now is allowanced wait for issued, which is CIP of
(#GGG-5) U.S. Ser. No. 14/833,935 filed on Aug. 24, 2015 which is CIP of
(#GGG-4C) U.S. Ser. No. 14/827,810 filed on Aug. 17, 2015 which is CIP of
(#GGG-4) U.S. Ser. No. 14/827,810 filed on Aug. 17, 2015 now is U.S. Pat. No. 8,931,947 issued on Jan. 13, 2015 which is CIP of
(#GGG-3C) U.S. Ser. No. 14/643,026 filed on Mar. 10, 2015 which is CIP of
(#GGG-3) U.S. Ser. No. 14/144,703 filed on Dec. 31, 2013 which is CIP of
(#GGG-2C) U.S. Ser. No. 14/548,626 filed on Nov. 20, 2014 now U.S. Pat. No. 9,182,111 issued on Nov. 10, 2015 which is CIP of
(#GGG-2) U.S. Ser. No. 14/105,717 filed on Dec. 13, 2013 now U.S. Pat. No. 8,911,137 issued on Dec. 16, 2014 which is CIP of
(#GGG-1C) U.S. Ser. No. 14/548,861 filed on Nov. 20, 2014 which is CIP of
(#GGG-1) U.S. Ser. No. 14/105,607 filed on Dec. 13, 2013 now U.S. Pat. No. 8,915,608 issued on Dec. 23, 2014 which is CIP of
(#GGG-2011) U.S. Ser. No. 13/161,643 filed on Jun. 16, 2011 now is U.S. Pat. No. 8,783,936 issued on Jul. 22, 2014

FIG. 21 is a front view of a desk top item (100) with LED(s) light source (134) inside a light-unit (132) and USB-unit(s) (108′) (112) for charging other electric or digital data product(s) according to a first preferred embodiment of the invention, which has 2 USB-units (108′) (112) and 1 outlet-unit (114) at the front of the base. The first preferred embodiment is a 12 LED (136) USB desk top light device and powered by an outside AC-to-DC circuit (126) or AC-plug-wire similar with FIG. 29 (528AC) or alternative by USB plug-wire (112) (112′) (112″) and includes an adjustment arm on the arm-base (128). Here of the top LED reading light can also be any kind of LED light in geometric shape such as cylinder, tubular, cone, curved, linear shape (as FIG. 12 (175) (176) (177) (178) (179) to offer area illumination so not limited for the reading light with adjustable arms. Further, the said desk or table top/walls/sides/edge/legs/base installation power station or extension cord with installation-kit(s) to install on desk or table anywhere optional add weight-element(s) to increase the base weight so overcome the (1) heavy top LED unit housing and LED light PCB and LED light source (2) the people apply-force while adjust the top LED unit angles or orientation (3) impact strength to the desk or table items (4) earth quake or any moving table or desk (5) heavy long wire or AC cord to pull down the desk or table top items.

FIG. 22 is a side view of the first preferred embodiment of a desk top item (200) has 12 or desire number of LED light source (236) in circle or any geometric arrangement within the LED unit housing of LED unit (232). The FIG. 22 also showing 1 USB-unit (208) and 2 outlet-units (210) (212) on the front side of the base (214) or preferred location of the base or arm-base depend on market required. The LED light source has 12 LEDs (236) in the AC-plug wired as FIG. 6 (528AC) or USB-wired light (2) and is powered from the USB plug-wire (226). The said desktop item is semi-permanently install or arrange on the desk or table top products which Is not portable to other place from time to time and use at none table or desk top product. Not like the US Prior art Daniel put on publication documents for “Power strips with built-in flexible LED light unit” which Daniel can not get US patent right basing on co-inventor's parent filed case of (# UU-2010) already had outlets(s), USB-port(s), permanently LED light or detachable LED light unit(s). So, Daniel only can public his concept and that is same as co-inventor (#UU-2010) filed case, only different is LED light unit has flexible hose to adjust the angle.

FIG. 23 shows a preferred design of a desk or table top item (400) which is a reading or working or

accent light has preferred LED unit including FIGS. 21, 22, 22-1, 23 or FIG. 12 (175) (176) (177) (178) (179) different desk top power station or extension-cord or variety LED lighting including the LED floor light device with preferred shape and configuration or other geometric shape at least including cylinder, tube, speaker, cone, geometric shape LED light as FIG. 12 (175) (176) (177) (178) (179) with desired
height and width or diameter including accent light, candle light, time related accent light
with color selection or color changing or brightness adjustable and other setting, program, time countdown, motion/photos/radar/moving sensor or detector(s) or other additional functions or sensors or wireless controller or wifi incorporate with desired 3/4/5G or more advanced internet and/or download APP software to make desired operation. The said desk or table top items or power-station or extension-cord or power strips as FIG. 23 LED light (400) has 2USB-unit(s) (412) (412′) and an outlet-unit (410) with desire AC or DC or both AC and DC power output-port(s) (410) (412) (412′) to charge electric or digital data device(s). The USB-unit(s) (412) (412′) minimum output current
is 1,000 ma, or higher such as 2,100 or 2,400 or 3,100 ma or more high current to charge electric or digital data device(s) such as an iPhone™ and iPad™ that have different requirement for charging current.

FIG. 24 shows one of alternative design of the desk or table top item (500) or power station or extension cord has built-in LED light source which is COB (Chip on-board LED) to offer area or indicator or area and indicator illumination. The said desk or table top items (500) has 2 USB-units (508)(508′) and 1 outlet-unit (510) install desired locations of desk or table top item (500) contour wall or sides or edge location to allow people to charge or supply power to an iPad™ iPhone™, laptop computer, or other device within the hand-reachable distance of the desk or table or side-bed table or cabinet. While people reading or working or rest or sleep or take a nap, people can use hand-reachable desk or table top power station or extension cord or power strip with installation-kit(s) to get power from the built-in desired number of USB-unit(s) or outlet-unit to charge or supply power to other electric products with desired LED illumination.

The drawing also shows the outside transformer (528) which has built-in AC-to-DC circuit to change wall or outlet AC power source to desired DC current which can be higher than the USB-charge-port needed 5 volt or little higher voltage such as 5.2 Volt DC or same as USB-charge port needed 5 Volt or little higher voltage.

Further, the inside of the desk or table top items or power-station (500) with built-in COB light source to offer LED illumination for any above disused type has at least one DC-to-DC circuit(s) to change the built-in or outside transformer AC-to-DC current (including or separated DC battery for time related products) to at least one same or different DC current specification; to supply the same or different USB-charger needed DC current to at least one of
(i) USB-port(s) (508) (508′) and/or outlet port(s) (510),
(ii) LED light circuit and LED light source (COB or any kind of LED specification), (iii) optional at least one of the built-in desk or table top item additional function(s) (FIG. 34) (Feature 23 have details discussion) including at least one is
(a) fan or air-flow or air related device (FIG. 49),
(b) audio or sound or music related device (FIG. 34),
(c) time or alarm-clock or time display or other time related device(s) those are powered by separated DC battery or batteries not from AC-to-DC circuit (FIG. 34),
(d) mirror or cosmetic mirror with or without LED illumination device (FIG. 34A),
(e) LED reading light, accent light, candle light, color changing light or other related LED light source offer illumination device (FIG. 21,22, 23, 24, and FIG. 12 (175) (176) (177) (178) (179),
(f) 2^{nd} LED light device including at least night light, sleeping light with time countdown or wakeup light functions, or power fail light, or motion/photos/moving/radar/conductive sensor or switch function LED related lighting, lamp, down light, security light, motion sensor light FIG. 12 (175) (176) (177) (178) (179),
(g) all other optional additional function(s) list on above (Feature 23) and other text of current filed text.

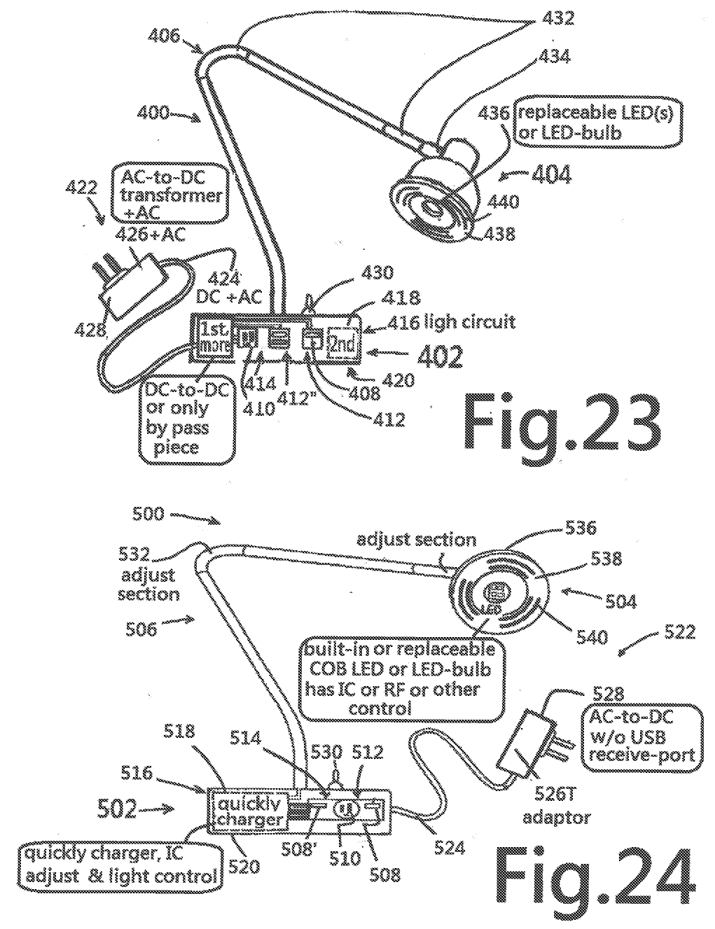

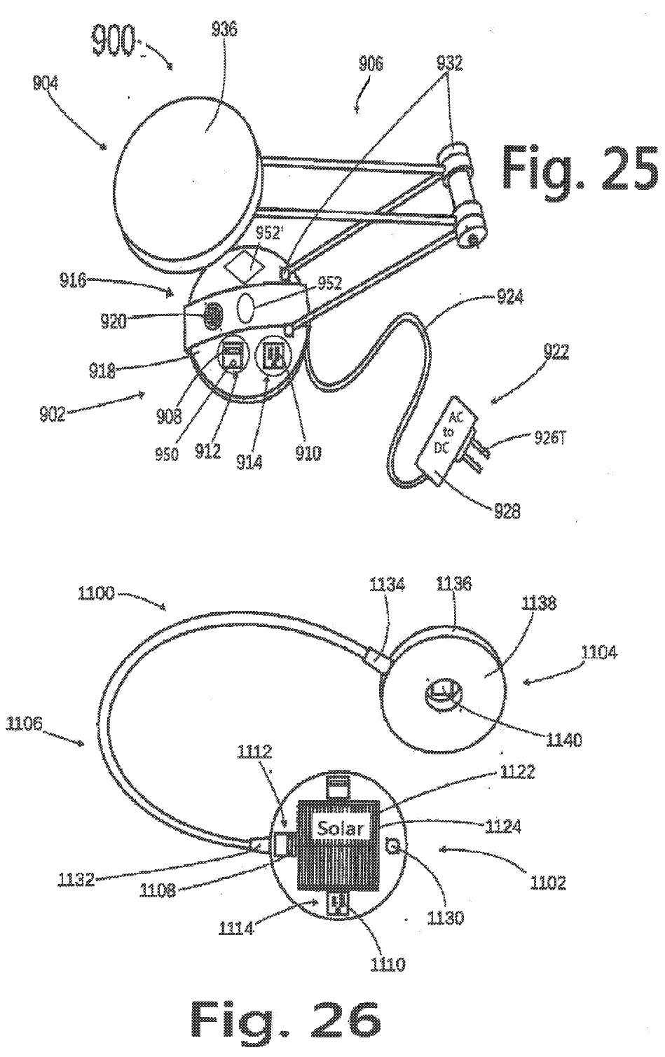

FIG. 25 shows a desk or table or cabinet top LED lighting item in the form of an LED lighting fixture (900) with adjustable arms (932) to enable the LED lamp (900) to be adjusted and moved to a desired height, orientation, direction, and/or angle to get the best illumination to people. The built-in 1 USB-unit (908) and 1 outlet-unit (910) have a lower cost than other above-discussed USB-units and outlet-units because they do not need to be made as compact. The desk or table or cabinet top item (900) is powered the transformer (928) of a UL listed model(s) that receives power from a wall outlet for 110-120 Volt AC current rather than the USB plug and wire of the desktop item shown in FIG. 21. As above discuss for FIG. 24 the built-in or outside transformer AC-to-DC circuit to change AC power source AC current into DC current, and the said desk or table top items has built-in at least one of DC-to-DC circuit(s) to change or arrange or distribution the AC-to-DC circuit DC current or the separated DC battery DC current those are same or different with the USB-charging-port(s) needed DC current; to at least (1) USB-port(s), (2) LED light circuit and light source(s), (3) optional built-in desk or table top items additional DC operated function(s) depend on the said desk or table top items with or without the said built-in additional DC operated function(s).

FIG. 26 shows a desktop item which is powered by a solar power array (1100) and which stores the solar electricity inside rechargeable batteries that have enough power to charge other electric or digital data device(s) though the built-in USB-unit(s) (1112) and outlet-unit (1110) having appropriate circuit means to meet market requirements.

FIG. 27 also shows the desktop item of FIG. 26, which can also be powered by other available power sources including wind power, chemical power, battery power, a generator, a transformer, adaptors, an inverter, an inductor, etc.

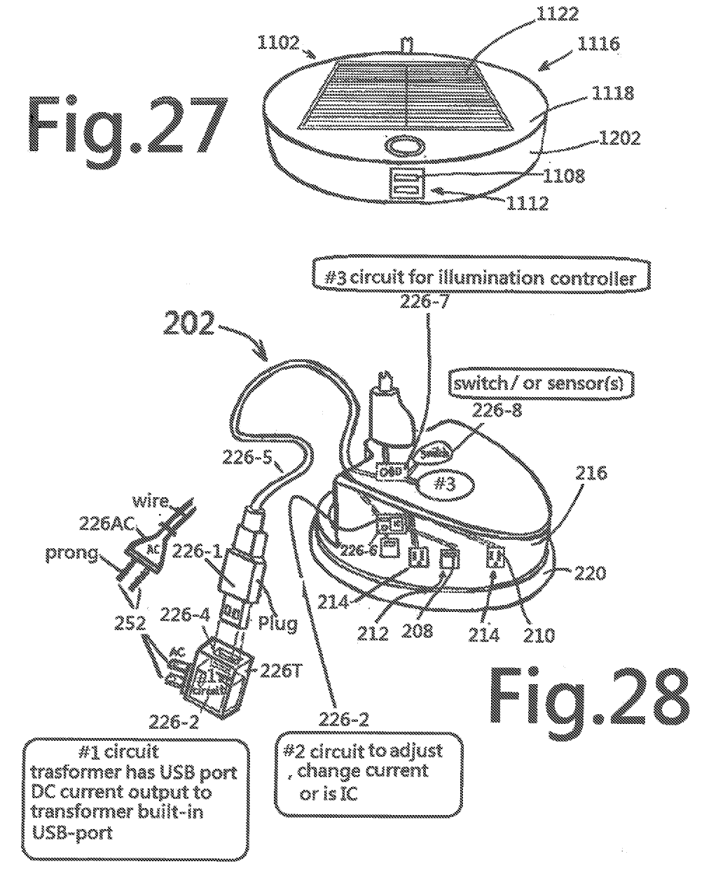

FIG. 28 show detail constructure of above discussed FIG. 22 the said desk top power station in the form of the LED desk lamp (202) which get AC power source from the AC-Plug wire (226AC) or get DC current from the outside transformer have AC-to-DC circuit to change power source AC current into DC current directly to get into LED desk lamp inside at least one of DC-to-DC circuit (circuit #2) which adjust or distribute or change the transformer DC current to same or different with USB charging circuit; to supply to at least one of the (1) USB-port, (2) LED light source, (3) Optional additional function(s) which is at least one of above discussed and show on the (FEATRUE 23). The outside transformer output DC current can directly input the said LED light (202) inside DC-to-DC circuit or go though one of the separated USB Wire (226-5) to connect the LED light (202) built-in USB-input-end to get transformer output DC current into built-in at least one of the DC-to-DC circuit.

From FIG. 28 also show the inside LED light (202) base has built-in at least one of circuit #2 which to adjust, distribution, arrange, change the outside or built-in AC-to-DC circuit created 1″ DC current into same or different with DC current needed for USB-charging-port(s) to supply desired number same or different DC-current to LED light built-in DC operated items, function, device at least is (1) USB charging port(s), (2) LED light source(s), (3) optional additional functions, device which are operated by DC current(s). The Desk top power stating, power strip, LED light device also have the circuit #3 to make proper LED illumination which may incorporate with IC or others DC-to-DC circuit. The LED light also have at least one of switch, sensor, motion/moving/radar/photo sensor(s) to turn on and turn off the said

LED light source for at least one of light effects including area, indicator, power on/off, charging status illumination.

FIG. 28 shows that the base of the desk top item of FIG. 22 may be made thicker or higher to accommodate bigger size electric parts and accessories to save a lot of the cost of super compact, slim, or cute size electric parts and accessories. Furthermore, the thicker or higher base can also accommodate a rotating USB-unit(s) or USB-module that can be rotated from a first surface to a second surface so that the first surface of the USB-module will look nice when the USB-unit(s) or module is not in use. Details of the rotating USB module can be understood from FIGS. 38-42, the details of which are explained in the inventor's co-pending U.S. patent application Ser. No. 13/117,227. It will be appreciated that the details disclosed in the co-pending application may be applied to the illustrated desktop items without departing from the scope of the current invention.

FIG. 29 show the other preferred desk top item or LED lighting (516) with built-in LED light source or detachable/replaceable/screw-in/plug-in LED bulb(s) has all kind of motion/moving/photo/radar/color changing/dust-to-dawn, or other market available function(s) LED bulb or LED tube or LED florescent tube. The LED light (516) has AC-plug wire (528AC) to get AC power source into the LED light (516) and connect with the inner AC-to-DC and at least one of the DC-to-DC circuit(s) to get same of different USB-charging-port(s) DC-current including the separated DC-battery for time related additional function(s); the inner at least one of DC-to-DC circuit(s) supply or distribution or arrange each built-in function for preferred DC-currents. The preferred DC-to-DC circuit examples select from (i) Charging circuit while LED light have built-in rechargeable battery inside for power fail and can be charge by in-put USB-port(s) (508) may in Type A, Type C, Micro USB or Mini USB or other specification USB-unit(s), (ii) IC or controller including all kind of sensor, detectors, switch, remote controller, wireless controller or other control device or system in wired or wireless circuit or system, (iii) AC circuit which has at least conductive piece or delivery kits to deliver input LED light device (516) to built-in outlet(s) (510).

FIG. 30 show the Desk or table top power station or LED light device (902) which have thicker or tall base (918) so can have the rotatable USB-and-Outlet module (1008) which have multiple surface(s) device and each of surface has desired number of USB and/or outlets and/or other female receiving-ends or ports for all kind of the male plug for different electric functions and/or wireless transmitting and/or receiving digital data, or wireless delivery power to other devices, or audio functions; those have details discussion on above (Features 23).

Because the thicker base of the LED light (902) so the switch can be toggle, or rocket, or conductive switch with color selection, color changing, brightness change, sequential flashing, fade-in and fade-out colors, sleep light with countdown timer, wakeup lighting, dust to dawn lighting, or other LED light functions or effects available at market place.

FIG. 31 show the one of desk top power station or LED light device (502) has the Outlet-port(s) (510′) and Outlet-&-USB port(s) module which has built-in desired number and combination of plurality of outlet(s)(510) (510″), USB-port(s) (508) (508′), and other female receiving-end(s) or port(s) (612). Further, the said Outlet-&-USB combination port(s) module (512) which has lock-unit (610) can fixed the multiple surface(s) rotatable power-station assembly to rotate from 1^{st} surface with desired combination for all kind of female receiving-end(s) or port(s) to the other surface with desired combination for all kind of female-receiving-end(s) or port(s). And, the said LED light (516) base (518) has built-in quicky charging system including USB 3.0 announced on 2010 for USB3.0 standard so any US prior art had no such quickly charging system because lack of the USB 3.0 standard yet. The built-in base (518) circuit(s) may include the IC or at least one of the said adjustable or distribution DC-to-DC circuit(s) to supply more than one of the DC-current for each different DC operation DC device(s) and DC functions needed.

From FIG. 32 show the one of alternative or equal functions desk or table top power station or LED light device (500-1) which has one of preferred additional features which is fixed or detachable stationary compartment which can let people to install and storage or put the stationary equipment such as pen, sharpie, pencil, eraser, staple, staple pin, clipper, paper cutter or other stationary kits within, or the have many movable, rotatable trays, drawers, levels, box to let people put necklace, earing, pendent, hair-band, ring or other ladies cosmetic, hair, facial related piece to storage inside the movable, rotatable, divided space(s) of compartment. The said LED light (500-1) has USB-ports (516C) or outlet(s)(516d) arrange on the said anywhere of the said compartment. It is appreciated that the underlay or overlay have other organizer (516b) which may be one of time/date/weather display with or without alarm clock function(s) or other electric function such as morning call, sleep night light with countdown counter, sensors installation. The said overlay or underlay organizer is at least one or desired combination of preferred electric-device to offer preferred electric function such as discussed on the above (FEATURE 23). The said LED light device (500-1) also have desired switch, controller, sensors to get desired functions for built-in preferred night light, 2^{nd} LED light function(s), audio functions, air-flow functions, reflect image with LED light illumination such as lighted mirror, or other time related piece(s) which has its own separated DC battery which is not get from LED light or power station AC power source through AC-to-DC or at least one of DC-to-DC circuit system.

FIGS. 29-31 show desktop items that have a thicker or higher base than the desk top items with LED source(s) of FIGS. 21-28, and rotating USB-modules having a plurality of USB-unit(s) and other receiving means can be added to increase the number of function(s), feature(s), effects, and/or performance(s). The USB-modules of these embodiments have more than 1 surface to enable different surfaces to be exposed for different purposes. The more than 1 surface of the USB-module can be any number from 2 to N.

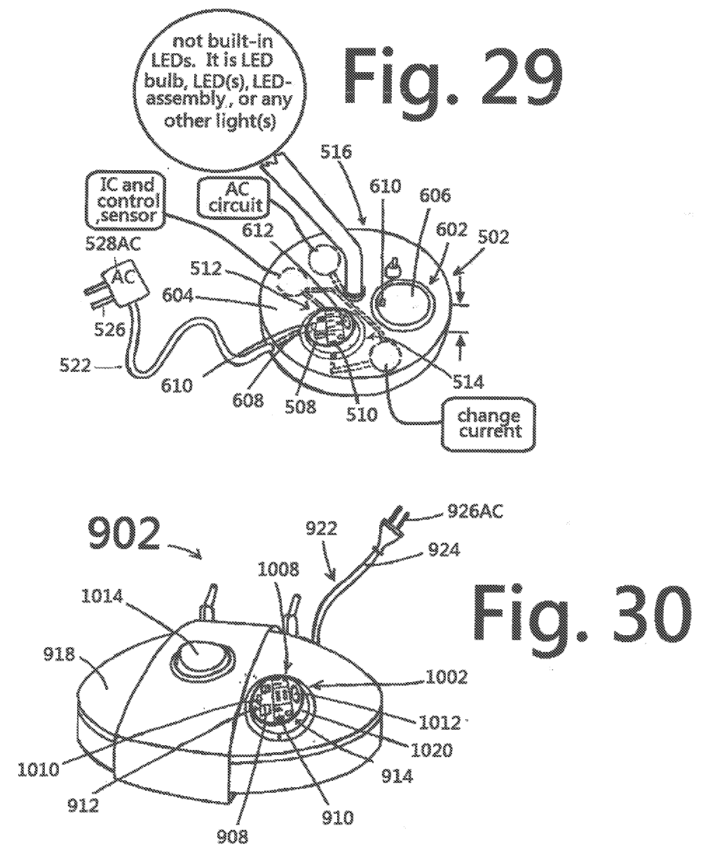

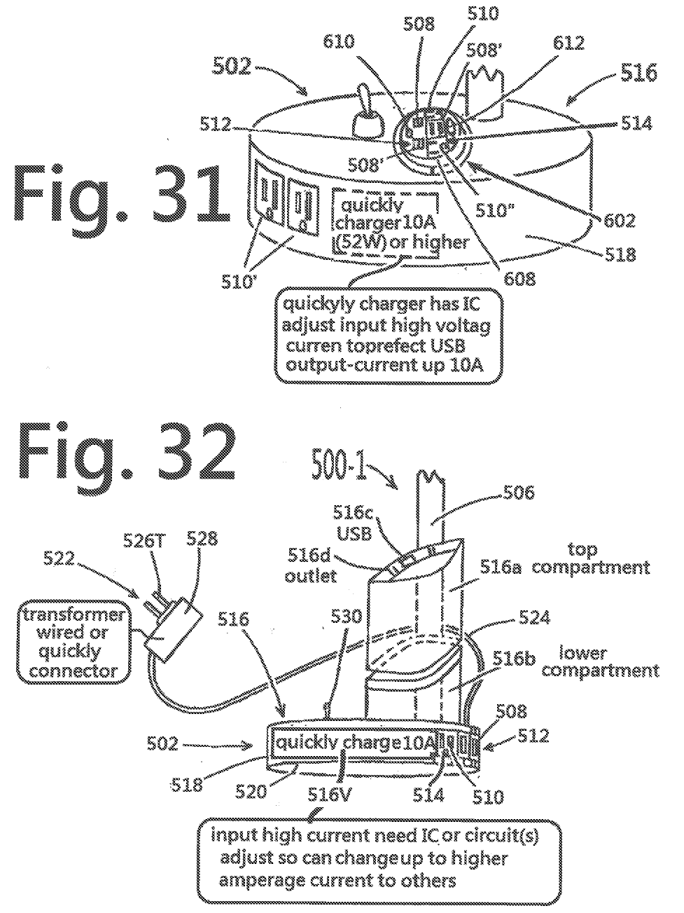

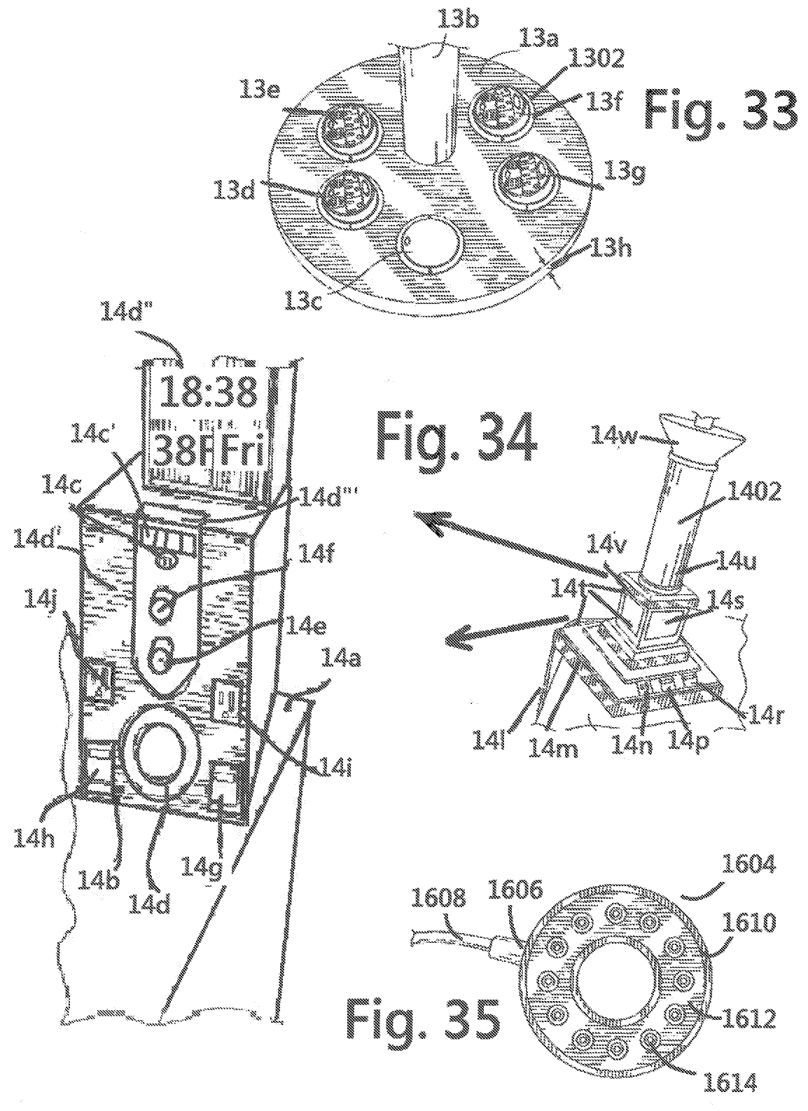

FIG. 33 shows a desk top item (13a) which has a super big base (13h) so that a plurality of rotating USB-Modules (13c) to (13g) can be installed to enable a group of people to charge their electric or digital device(s) at the same time, such as in a train station, bus station, airport, meeting room, hotel lobby etc.

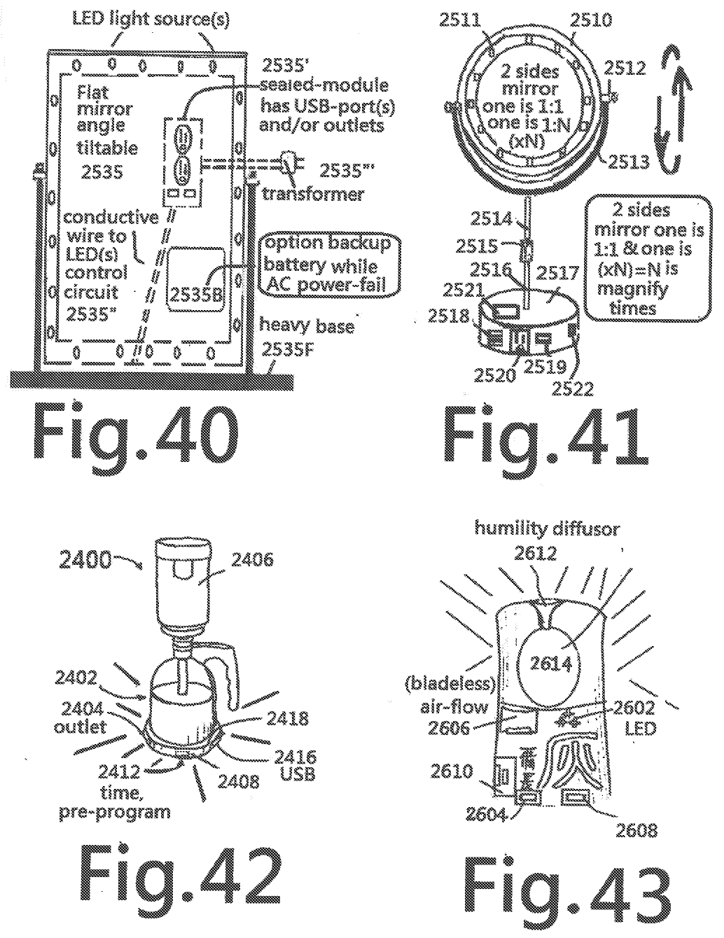

FIG. 34 shows desktop items with LED source (not shown) and USB-unit(s) (14h) (14g) (14p) (14r), USB module(s), or outlet-unit(s) (14i)(14j)(14n) to allow people to charge other electric or digital device(s), the desk top items or power station or LED light device or alarm clock (FIG. 44) or time display related items (14d″) including a radio or Speaker or blade-less air-flow items (14c′), timepiece (14d″) with backup battery to keep continuously operation time related work while power fail, weather station display (14d″), fruit blender (FIG. 48), food machine (FIG. 48), liquid machine (FIG. 42), LED lighting as FIG. 12 (175) (176) (177) (178) (179) or FIGS. 21 to 39, light fixture with detachable or replaceable LED related light source such as LED bulb (FIG. 38), projector and/or time and/or alarm and/or audio combination device or assembly with backup battery to keep continuously operation time related work while power fail (FIG. 47), built-in electric fan (FIG. 49), air-flow device (FIG. 49), built-in bladeless fan device (not shown), mirrors to reflect people image (FIGS. 40, 41, 45, 45-1), heater or any conventional items with LED illumination and built-in desk top items or power station or power strips.

FIGS. 35-38 show different LEDs light source used for LED lighting in the above-discussed desktop items or other LED desk lamps or LED lamps for a desk top for built-in none-replaceable or the detachable/replaceable LED bulb or LED florescent tube or LED light-unit with built-in functions such as color changing LED bulb, Dust to Dawn LED bulb, Radar detector LED bulb, dimmable LED bulb, Brightness adjustable LED bulb, party LED bulbs, or any other LED bulb with built-in additional functions should all fall within the current invention claim scope and coverage for any kind of wavelength for illumination or indicator or status applications should also fall within the current invention scope.

FIGS. 39-41 and FIGS. 45, 45-1 show details of a lighted mirror application with current invention all above features. These lighted are rotatable or non-rotatable cosmetic mirror for desk top or wall mounted mirror(s) with at least one of built-in USB at least one of LED light source in all kind of choice and specification, USB charging-ports, outlet(s), and optional additional functions may select from the above discuss at least from Features 23. The USB ports or Outlets can install on the plastic base of said lighted mirror(s) while the lighted mirror base have space to fit all related parts and accessories of the said USB-charging circuit, outlets metal conductive piece, receiving-end(s) or port(s) with related circuit, DC-to-DC circuits, IC, metal conductive piece, wires for FIGS. 41, 45, 45-1.

While the lighted mirror has no space on base such as FIG. 40 and FIG. 45-1, those lighted mirror(s) base just a heavy metal piece(s) so does not have space to install all parts and accessories related to the USB-Charger and Outlet and all related functions or effects IC or control parts. These metal-piece base lighted mirror incorporated the UL or any lab approval qualified USB-and-Outlet module or finish products to assembled with the mirror back surface by glue, chemical compound, magnetic tape, magnetic piece, double side tape, or other market available tools or kits to assembly the housing or surface of the said wall-mounted or desk top lighted mirror as FIG. 40 and FIG. 45-1. And, AC power input from the USB-and-outlet module AC-plug wire and go through AC-to-DC and at least one DC-to-DC circuit(s) to get desired DC current to connect by conductive-wire or piece to connect with mirror internal LED circuit to get desired light illumination functions for ladies or people makeup.

The said lighted Mirror 40, 41, 45, 45-1 all have built-on USB-charging-port and/or outlets, and the outlets preferred is one can export the 1,850 Watt so people can plug the high power hair-dryer into built-in outlets while work on desk or stand to use the wall mounted lighted mirror which has at leat one 1:1 ratio mirror and magnify-mirror(s) which is built-in or added-on or magnetic attach-on or double side to attach-on the said lighted mirror device which meet the current invention for desk or table or cabinet top items or desk top power station to supply power through USB or outlet port(s) or desk, table, cabinet, wall mounted light mirror having at least one of USB or Outlet to supply power to other device.

FIG. 39 show one of preferred lighted cosmetic mirror which has 22 piece LED light source(s) surround the center mirror to offer sufficient brightness to make in front object(s) to show lighted reflective image with desired magnify radio from (1:1 to 1:N times wherein the N is any number). The none rotatable or change surface lighted mirror has center mirror (2532) having 1:1 ratio to reflect front object(s) image, and two foldable sides mirror (2533) (2534) have desired 1:5 times radio magnify reflect front object(s) image and foldable sides mirror (2534) having 3 different of magnify ratio on top one for (1:10 magnify times) and middle one for (1:5 magnify times) and lower one for (1:7 times magnify times) or other added-on or magnetic-on of detachable N-magnify-times mirrors.

FIG. 39 has a preferred geometric shape base with sufficient inside space to install at least one or any combination of preferred electric parts and accessories select from
(i) USB-Charging-port(s) to supply or charge other DC operated product(s)
(ii) Outlet-ports to supply AC current to other product(s) for cosmetic, hair, dryer related items.
(iii) LED light source for be-reflected object(s) image, area/indicator/status/accent illumination
(iv) 2^{nd} LED or other LED illumination at least is motion sensor, power fail, accent, night, sleeping, wake-up, dust to dawn light functions, effects, performance.
(v) Blue-tooth, audio, music, sound, talking related device(s) or function(s).
(vi) Wireless transmitting and/or receiving device(s) or parts or system.
(vii) Wireless charging system for power, current.
(viii) Wireless communication or delivery of digital data including video, audio, image, stream image, photos by wifi, Z-way, Zigbee through 3/4/5G or more advanced internet and stations.
(ix) Variety of female receiving end(s) or port(s) to accept the input digital data for preferred functions.
(x) Sensor(s), detector(s) at least one of motion/moving/radar/photo/vibration/power fail sensors to trigger preferred functions, operation.
(xi) Remote controller or RF system receiver and/or transmitter to operate mirror and other linkable device(s)

From FIG. 39 have alternative design or configuration to have current invention for desk top power station or desk top items or desk top extension cord which has added-on or assembled-on USB-and/or-Outlet module (2588) which has AC-plug wire (2588W1) to get housing AC electric power source and 2^{nd} conductive-piece or wire to connect lighted cosmetic 22 LED light-source(s) circuitry or circuit(s) to operate the 22 LED(s) for predetermined LED light function at least including for

(a) Color change from cool white to warm white light beam or performance
(b) Brightness adjustment for high-medium-low or continuously changing for any brightness
(c) Sensors or detector or power fail detector or motion/moving sensors to perform desire functions
(d) Connect wifi, blue tooth, Z-way, Zigbee, download APP software, Internet system for functions.
(e) Wired or wireless to get video and/or audio digital data to play or replay or display.
(f) Wireless communication with other phone, ipad, compute device to talking or answer message.
(g) IC or CPU or MCU to perform pre-determined functions, setting, adjustment for functions.

FIG. 39 base (2539) has big inner space to install at least one of (i) USB-port(s) (2540) (2546), (ii) outlet-port(s) or 1,850 Watt outlet(s) (2545), (iii) sensor or detector(s) (2544), (iv) circuit or circuitry or CPU or MCU or IC (2541), (v) speaker or audio or time/date/calendar/weather display (2543), and other pre-determined switch (not shown) or wireless communication, transmitting, receiving, remote controller transmitting and/or receiver, or IR, RF, Blue tooth, wifi wireless controller or transmitter and/or receivrs . . . etc.

From FIG. 40 show the similar with FIG. 30 Alternative or equal function single side lighted cosmetic mirror (2535) which can rotatable to adjust angle but only have one side surface with at least one piece of reflective-mirror(s) pieces. The said at least one of USB and outlets is added-on or magnetic-attach-on or glue-on or screw-on or assembled together with separated USB and/or outlets unit on other side of the mirror surface with 22 LED(s). The front of mirror has 22 LED(s) to offer the sufficient brightness to glow the be-reflected object's image for lighted and shown on mirror surface. The back surface of 22 LED(s) of lighted mirror has optional rechargeable battery to supply DC power to 22 LED(s) to glow up while power failed. The said recharge battery is charged by the USB and/or outlet module which has 2 conductive wires to get AC housing current power source and connect with LED(s) circuitry to operate pre-determined light function(s), performance(s), light effects as market available all skills.

From FIG. 41 show the one of rotatable lighted cosmetic mirror which has more than one mirror(s) on more than one surface(s) and each of the surface mirror has desired (N-times magnify Mirrors) so can change the different magnify times mirror surface(s) to make cosmetic to see more detail for desk top or wall mounted extendable distance lighted cosmetic mirror and both is rotatable to change from 1^{st} surface to next or more surface(s) with different magnify-times of reflected lighted image.

From FIG. 41 which is very similar with FIG. 39 base (2517) has preferred inside space to install at least one of USB for out-put USB preferred is Type A, C or other type USB (2518) and input USB preferred is one of Type A or Type C or Mini or Micro or others Type USB (2519) to charge optional back-up or power-fail recharge battery (not shown), outlets (2520), switch which preferred is conductive tpe (2521), or other female-receiving-port(s) (2522) to arrange connection with other preferred electric device, and wireless devices which same as above all discussion for additional function but without any limitation for any electric or electronic wired or wireless device(s) with pre-determined function(s), effect(s), performance(s) all should be fall within the current an above all discussed co-pending or parent filed case text, drawing, idea, scope, claim coverages.

From FIG. 41 the desk top or wall mounted lighted cosmetic mirror have more than one sides mirror surface(s) has extendable and retractable stem (2514) (2516) with loosen-n-lock kit (2515) or bar or rack or tube to adjust the length or height of the mirror surface(s). It also has the rotating frame or support (2513) which connect with the rotatable mirror rotating-ears, pole, nuts with angle tighten constructure so can hold on preferred angle or tilt angle for each different user. The mirror can be round or rectangular or any geometric shape and size and magnify-times with built-in LED light source or LED-bulb or LED-tube or LED fluorescent tube or LED filament light source(s) on contour or center or underlay or fit within mirror light passing able windows/non-coated area(s).

From FIG. 42 show a desk top power station for suppling liquid device (2400) which has the base (2418) has built-in output Type A or Type C USB-port (2412) and input Type A, C, mini, micro or other type USB ports (2416) and LED or LCD illuminated time/alarm/weather/calendar related device (2412), or outlet (2404) and preferred additional functions device built-in the desk top items here is liquid supplier device so can supply power to other product(s) to meet the current invention scope for desk or table top power station or liquid supplier device.

FIGS. 40 to 49 every device have LED light illuminations to get the area or indicator or status or reflection or project functions or applications.

From FIG. 42 is liquid supplier device which has LED light source (2408) to offer indicator light function with build in 2 USB port (2416) (2404) to allow people to charge electric device while brew the coffee or work at kitchen area.

From FIG. 43 is one of air-purify or humility diffusor (2614) or accent light device (2612) have tube or cylinder or cone or bar shape (2612) with desired LED(s) (2602) to arranged to offer the glow or accent or area light illumination on top portion with desired LED light function, features, effects, performance for all kind of sequential flashing, color changing, color selection, function selection (such as motion or non-motion activate the light), brightness adjustable or changing, fade-in and fade-out, sleep light with time countdown for shut off, wake up light for variable light brightness to wakeup sleeping people, added time display with or without alarm or sound or music sound, radio or blue tooth to play music or sound or audio or digital data, or other features which may refer to above discussed Feature 23. From FIG. 43 show the desk top power station or LED light device or humility/air-freshener/perfume/smell spread device with built-in LED(s) (2602) to offer area or indicator or accent light performance, and the built-in air-flow device to supply variety speed of air-flow from inner motor and fan and show as blade-less air-flow on front of the desk top power station or humility/air-freshener/perfume/smell spread device with built-in USB (2608) (2604) for only output to charge other product(s) or have input to charge built-in for power-fail light or back-up power soruce rechargeable battery which device without AC power source connected. The said device has preferred number of outlet(s) while needed.

From FIG. 44 show one of preferred desk top power station (2902) which has built-in LED or LCD illumination display (18:88) to show at least one of time, am/pm, date, week, month, calendar, weather, alarm, time setting, dust-to-dawn light, night light, count-down time sleep light, wake-up light functions from one unit. The said power station or time related desk top item has time/date/weather functions which is power by the one of AC-to-DC and DC-to-DC distribution or supply one of 1^{st} or 2^{nd} or more DC current(s) for normal time and have built-in separated back-up DC battery power source while power fail time to keep the time related operation continuously working. The said backup battery preferred type is one type of CR2030, CR2032 or LR 44, LR 1154, AA, AAA, or other type of battery so can prevent from AC-power source power failure and stop the time/date/weather display and stop update to show accurate time/date/calendar/weather. One of preferred application for backup battery which will continuously working for time related operation while power fail, after power back, the time display will still keep accurate time. One of other alternative models or application while power fail the display still will show out and power by separated backup battery without stop display time data during power fail. Or/Other alternative or preferred for the operation or display showing during power fail time still should be fall within the current invention scope and claim coverage.

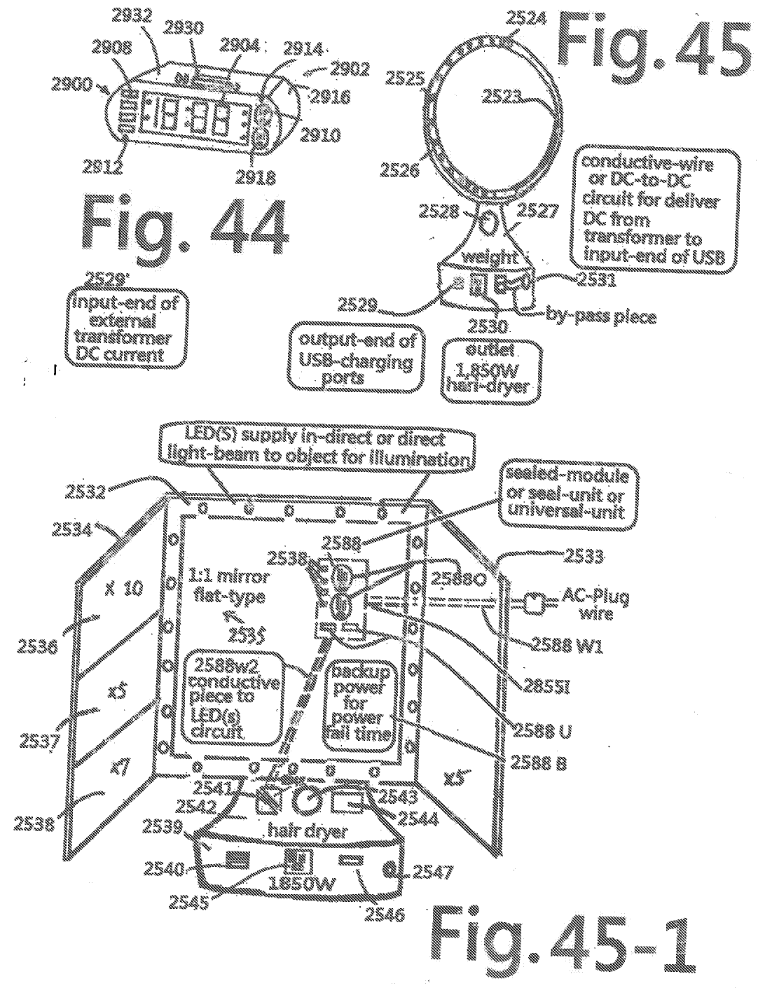

From FIG. 45 is same as FIG. 41 with different base (2527) construction and has built-in at least one of the motion/moving/radar/photo sensor (2528) or detectors (2528) to trigger the LED light source (2525) or Type A or Type C for output current USB (2529) or Type A, C, Mini, Micro USB port for input power USB-port (2529′), or outlet to turn on and turn off under pre-determined functions, effects. The said desk top power station may also it is including at least one of optional outlet (2530) preferred has 1850 or surge/over heat/over time/MOV or other protection circuit(s) to allow people safety to connect with high power consumption device such as hair dryer or heater from the outlet (2530). The said desk top lighted mirror or power station of FIG. 45 with or without the height adjustable can visible on front view. The lighted mirror has more than one rotatable mirror(s) for desired magnify times on each one of mirror and rotatable along the frame (2526) as above FIG. 41 shown.

From FIG. 45-1 has more bigger image to show the same construction of FIG. 39 to see clear for each text.

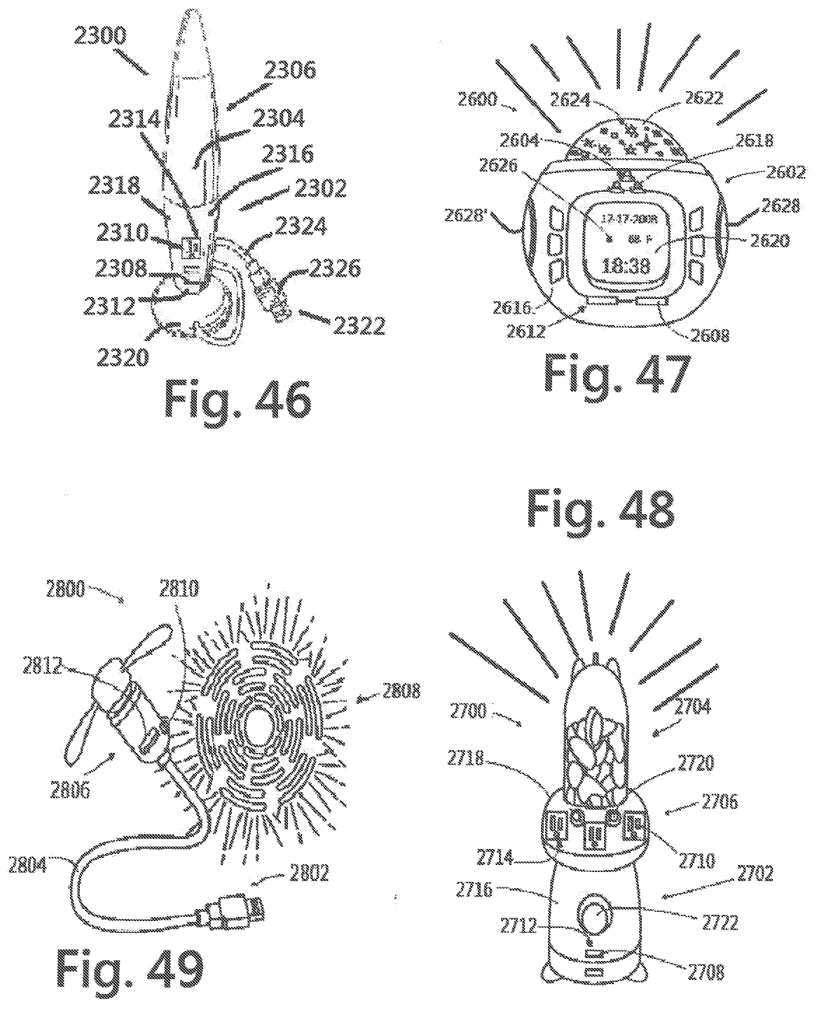

From FIG. 46 show one of alternative desk top LED light or power station (2300) which has top light-area in geometric shape similar with FIG. 12 (175) (176) (177) (178) (179) here is a rocket shape with or without the liquid and glitter or miniature or floating piece within, or it just has some air-bubbles inside of the solid-plastic piece to create multiple times of reflection and/or refraction Within so can create the splendid light-pattern(s) emit out by liquid or air-bubble arrangement(s) as co-inventor parent filed cases for Lava/Glitter/LED light device.

From FIG. 46 the base (2318) of device (2300) has built-in AC-to-DC or at least one of DC-to-DC circuit to get input AC or DC current from conductive wire-assembly, Here is USB-Plug Wire (2322) (2324)(2326) which can get DC power from power source, so only need built-in at least DC-to-DC circuit(s)(not shown) to distribution desired DC current to the said built-in LED light source(s) and the USB-charging-port(s) (2308). The alternative embodiment the device (2300) the wire-assembly use AC-Plug wire so can connect with AC power source to get AC current go through built-in AC-to-DC circuit to get 1^{st} DC current and go through built-in at least one DC-to-DC circuit or conductive-piece to supply or arrange or distribute the same or different DC current which USB-Charging-port(s) needed to LED(s) and other DC operated additional function(s) as above discussion. The said input AC-current also supply to built-in AC outlet(s) (2310) to supply AC current to other products.

FIG. 47 show the variety of desk top power station (2902) have separated backup DC battery to supply power while power fail time for keeping time related operation continuously operation. The said desk top power station with LED (2604) or LCD illuminated time related data display to show at least one of time (18:38), Am/PM (2626), date, week, month, calendar (12-17-2008), weather (68F), temperature (2620) and offer optional alarm, time setting for wake-up, countdown sleep light (2620), night light (2620), wake-up light (2620) as FIG. 44 show. Further, FIG. 47 show the upgrade device which has more built-in additional function including (i) project color image (not shown) or project twinkle star image (2622) or project moving image (2624) at least is one for sea-waving, raining, aurora, galaxy, falling snow, moving or climbing spider with nets, or other market available for fixed, steady, moving, rotating, changeable image or lighted patterns, light beam projection for indoor or outdoor surface including garage door, entrance door, fence, ground, garden, walls, housing, building, Tree of outdoor surface(s), or indoor ceiling, walls, floor, stair, room . . . etc. This project function as co-inventor co-pending parent filed cases including wall plug-in or desk top items with AC-Plug wired or Prong to get AC and/or DC power source as below list cases;
(ii) Blue tooth or wireless connection or pre-record IC for audio, music, sound play or replay or Storage.
(iii) Time setting for reminder, wake-up, sleeping, count-down incorporate with sound, music, light brightness, light color, light effects,
(iv) Time/AM-PM/date/week/month/calendar/weather/temperature display by LED light source or LCD with LED backlight.
(v) Setting (2616), adjustment (2616) the time, AM/PM, date, week, month, year, calendar, weather switch, knob, snoozer button (2616) or other device to keep accurate time.
(vi) Sound, audio, music selection (2616) for pre-record music, sound, audio such as rain, water waving, forest, bird singing, sleeping sound, religion song or reading, pray or other pre-recorded sound, voice, music or audio digital data play or replay.
(vii) Setting, change, selection, adjust for light color, light brightness, sound/audio volume, AM/FM/Shot wave frequency, or other audio and video related device.
(viii) USB input and/or output ports (2608),
(ix) Outlet port(s) (not shown)
(x) Other preferred additional function(s) as all above discussion should be addable into FIG. 44 and FIG. 44-1 desk top items or device(s).

From FIG. 48 show a desk top food supplier or power station (2700) which has built-in LED light source (not shown) and at least one of USB (2708) and Outlet (2710) (2718) with food items within the top container (2704) with food release botton (2720) to get food items.

The power station (2700) has preferred sensor/detector device (2722) to activate the desktop item or desk top power station for pre-determined functioins.

From FIG. 49 shown the one of preferred power station or LED air-flow device (2800) which has soft blade or blade-less fan(s) design to fit into the said preferred geometric housing or desktop items with LED illumination as FIG. 43 (2606) for blade-less air-flow functions. It also similar with FIG. 34 for blade-less air-flow device (14d). The said air-flow cam out from the LED light device FIG. 34 pole or body or frame (14d) or from the LED accent light device as FIG. 43 (2606) for blade-less fan device to get desired different speed of fan for sections-selection or continuously changeable speed for air-flow which may have Air-conditional or heater system to get desired temperatures air-flow while market needed.

I claim:

1. A power station for desk or table or side-bed table or cabinet installation at a location that is within hand reachable distance while person sitting at a desk, comprising;
at least (a) one USB units, or (b) one outlets, or (c) one electrical power outlet and one USB unit, are assemble with at least one LED unit, to offer power outputs and LED illumination without any digital data delivery hub or other MCU, CPU device,
said LED illumination including area illumination, or charging/power status indication, or area and charging/power indicator lights with preferred light functions or effects, and
wherein power source for power station is a housing or building AC current from wire select one from 110 to 250 voltage to supply one voltage current to outlet-unit(s) while power station having outlet unit(s), and
while power station having USB charge function(s), the power station includes built-in or outside AC-to-DC for converting the desire AC current to 1st DC current, and at least one of DC-to-DC circuit to change 1^{st} DC current to 2^{nd} or more DC current(s) to supply or distribute at least one of 1^{st} or 2^{nd} or preferred DC current(s); to LED-unit(s) and at least one of USB-unit(s), additional function(s);
(1) USB charge port(s),
(2) built-in LED light source or detachable/replaceable LED bulb/tube,
(3) at least one of preferred DC operated additional function(s) select from
(a) air flow or air-condition or heater or humility diffusor related device,
(b) audio/music/sound/pre-recorded music or melody related device,
(c) other built-in LED(s) light source including detachable/replaceable LED bulb for night light or mirror illumination or accent light or color changing light or color selection light or area light or indicator light, charge status light, power status light with at least one of multiple color, color changing, color selection, brightness adjustable functions,
(d) DC operated related trigger/sensor/switch/circuitry system or assembly,
(e) time, alarm, weather, temperature, date, week, month, calendar device to show at least LED or LCD illumination for time display with or without backup battery for power fail operation.
(f) protection circuitry at least is one of surge protection circuit, MOV protection circuit, leakage current protection circuit, over-heat protection circuit, over-charge protection circuit, short circuit protection system, re-start circuit/system, or other protection circuit.
at least one of DC current have at least 1.0 A, to allow the at least one USB-unit to have sufficient charge capability to charge other electric, digital-data, audio or video products while power station having USB unit(s), or/and
said circuit supply desired DC current to LED unit(s),
wherein the at least one LED unit offers at least one of area, charging status, indicator, power status, power fail, and motion sensor illumination according to pre-determined functions, performance, or effects, and
wherein the power station includes at least one installation kit for preventing, when the power station is put on a desk or table or side-bed table or cabinet top or surface at a preferred location, the power station from falling off the desk or table or side-bed table or cabinet top or surface as a result of being pulled, moved, or removed by the power station heavy weight of the electric cord or by vibration or by impact strength.

2. A power station as claimed in claim 1, wherein the one of preferred DC output power is one of the following: 1.0 A, 2.1 A, 2.4 A, 3.1 A, 3.4 A, 4.2 A, 4.5 A, 4.8 A, 5.5 A, others, or higher current.

3. A power station as claimed in claim 1, wherein the power station includes at least one additional circuit or electric components selected from a master switch, MOV, surge protection circuitry, overload prevention components, overheating prevention components, re-set or re-start circuit, shut-down circuit, detector-circuit and high voltage components.

4. A power station as claimed in claim 1, wherein the power station is further or alternative incorporated with at least one preferred DC operated additional function(s) or device(s), said function or device being one of
(a) A 2nd LED related lights or indicator light or desk lamp, accent light, reading light, multiple functions, night light, power fail light, motion sensor, and other market available LED light
(b) a time related piece, an alarm/time related piece with or without backup battery for power fail time keep time related function(s) continuously operation,
(c) an audio device,
(d) an air flow piece, a bladeless air flow device, air-condition, and heater air flow.
(e) an extension cord with a fixing kit to prevent the extension cord from being pulled from the desk or table or side-bed table or cabinet top or surface by a weight of its power cord,
(f) a coffee cup heater,
(g) a key pad or tray or dish for storage person carry or pocket items such as key, remote controller,
(h) a speaker or blue tooth audio related device(s),
(i) a wireless transmitting or receiving or talking communication device,
(j) a consumer electric item,
(k) built-in camera with wifi wireless transmitting through 3/4/5G or more advanced internet incorporating with download APP on person phone or computer device(s) to monitoring, setting,
adjustment, selection pre-program function(s).

5. A power station as claimed in claim 1, wherein said installation kits includes at least one of
(i) a suction cup, air-adhesive piece
(ii) screw, nail, pin, sharp metal piece,
(iii) holder, frame, tray, base, anti-skip pad,
(iv) Glue, chemical compound
(v) double sided tape with or without magnetic properties
(vi) magnet piece, or magnetic form tape, Velcro-tape, double side tape,
(vii) catcher, press-n-tight kits,
(viii) hook-and-loop fastener,
(ix) increase weight element(s). and
(x) desire combination selected from tape, suction cups, adhesive-piece, glue, double side tape, magnetic, catcher, hook-and-loop tape(s), chemical compound, frame, holder, tray, base, anti-skip pad, press-n-tight kits, weight piece, or increasing weight piece(s).

6. A power station as claimed in claim 1, wherein further including at least one of a rotating kit, spin kits, flip-over kits for turning a first surface having at least one of the outlet unit, USB unit, and LED unit to expose at least one hidden surface having at least one of the outlet unit, USB unit, or LED unit.

7. A power station as claimed in claim 1, wherein the power station includes a housing designed to fit into or onto, to cover, or to overlay or underlay an existing desk or table or side-bed table or cabinet top product(s) in order to save desk space while still providing a power station having DC current charging or supply AC current functions, and without the need for the power station to be positioned on the ground or wall or in a low-profile area where people would have to bend in order to reach the power station.

8. A power station as claimed in claim 1, wherein the power station is installed on desk preferred location(s) where are hand reachable distance or location(s) including desk or table or side-bed table, cabinet top, side(s), edge(s), wall(s), under board, base, or legs.

9. A power station as claim in claim 1, where the desk or table or side-bed table or cabinet top power station USB-ports for (i) output-power to charge other product(s) or (ii) input-power to be-charged power station inner rechargeable battery or (iii) by-pass input USB-charging needed DC current by conductive-piece to output USB-port(s); is one of the Type A, or Type C, or Micro or Mini or others specification of USB-port.

10. A power station as claimed in claim 1, wherein the desktop power station is a LED desk or table or side-bed table or cabinet top light or lamp or lighting which has built-in at least one of charging or input-power USB-units, and have LED(s) area and/or indicator illumination with or without at least one of additional function(s) selected from (i) outlet(s), (ii) other LED light(s) function(s), (iii) Air-flow function, (iv) audio function, (v) time/date/week/calendar/weather display with or without alarm function(s) powered with separated backup DC power source or battery to keep continuously operation of time related function during power fail time.

11. A power station as claimed in claim 1, wherein the desk or table or side-bed table or cabinet top power station is a desktop time or alarm time piece or digital time/weather/date/week/calendar display related products or time clock having LED or LCD displayer illumination having built-in at least one of charging or input-power USB-units.

12. A power station as claim in claim 1, where the desk or table or side-bed table or cabinet top power station is a desktop time or alarm clock(s) or digital time/weather/date/week/calendar display related products having built-in at least one of charging or input-power USB-port(s) with at least one of LED-unit for area(s) and/or indictor illumination.

13. A power station as claim in claim 1, where the desk or table or side-bed table or cabinet top power station is a desktop cosmetic-mirror products having fixed or rotatable at least one side(s) or mirror(s) to reflect be-reflected object(s) image and having built-in LED light source(s) for illumination the said object(s) and built-in at least one of USB charging or input-power USB-port(s) with or without the outlet(s) to supply AC power to AC operated hair or cosmetic device(s).

14. A power station as claim in claim 1, where the desk or table or side-bed table or cabinet top power station is a desktop LED accent light which has desired LED illumination with preferred at least one or desire combination functions select from (i) color, (ii) brightness, (iii) timer, (iv) trigger-system, (v) color changing, (vi) color selection, (vii) sleep setting or countdown time light, (viii) conductive/dimmer/setting/selective switch, (ix) on-off switch, and (x) built-in at least one of charging or input-power USB-Port(s).

15. An extension-cord or power-strip for desk or table or side-bed table or cabinet top installation, comprising;
At least one of fixed or extendable or transformable extension-cord or power-strip in preferred geometric shape including at least one in a linear, round, sphere, tube, cylinder, cone shape and construction have at least one or desire combination of
(a) at least one outlet units,
(b) at least one USB units,
(c) at least one electrical power outlet and at least one USB unit,
and are assemble together with at least one LED unit, to offer power outputs and LED area or indicator or switch illumination without any digital data delivery hub or other MCU, CPU device,
wherein the at least one built-in LED unit offers area and/or indicator illumination according to pre-determined functions, performance, or effects including at least one of area illumination, indicator light, color changing light, color selection light, sleep light, changeable color or/and brightness light, wakeup light or other desire illumination function(s), and
wherein the extension-cord or power-strip have desire shape, construction, foldable, extendable, transformable, tilt-able, rotatable, or movable parts, arms, bar those fixed on hand reachable location includes at least one installation kits for preventing, when the extension cord is put on a desk or table or side-bed table or cabinet top, sides, walls, underlay or overlay the desk surface, the extension cord from falling from the desk or table or side-bed table or cabinet desired location as result of being pulled, moved, or removed by the heavy weight and long length of power supply wires of the extension-cord or power-strip, said installation kits including at least one or desire combination(s) of a suction cup, screw, holder, glue, double sided tape, magnet piece or magnetic with tape or form-tape, fit-and-tight, push tight kits, catch, hook-and-loop fastener, and weight elements.

16. A power station for desk or table or side-bed table or cabinet top installation, comprising;
at least two outlet units, or at least two USB units, or at least one electrical power outlet and at least one USB unit, are assembled together with at least one LED unit, to offer multiple power outputs and LED illumination without any digital data delivery hub or other MCU, CPU device,
said LED illumination is at least one of following illumination including area illumination, indicator light, charging status light, power on/off light, surge production related light, switch location light.
while the power station having USB port(s) includes built-in or outside transformer AC-to-DC circuit for converting an AC input current into 1^{st} DC current, and at least one of DC-to-DC circuit change the 1^{st} DC current to 2^{nd} or more DC current(s) and arrange or supply or distribute the 1^{st} or 2^{nd} or preferred DC current(s); to at least one of the said USB charging port(s) or USB-unit(s) or LED(s) or additional DC operated function(s), and/or
the said at least one of desired DC current to the at least one built-in LED light-source or detachable/replaceable LED-bulb(s) offers at least one of area, indicator, power on-off, re-star switch, and charging status illumination according to pre-determined functions, performance, or effects, and
wherein the power station includes at least one installation kits for securing the power station to a desk or table or cabinet anywhere and thereby preventing, when the power station is positioned on the desk or table or cabinet at a preferred location, the power station from falling off the desktop as a result of being pulled, moved, impacted or removed from the desktop by the heavy weight of an electric cord or incoming impact strength or vibration(s), said installation kits including at least one of a suction cup, screw, holder, glue, double sided tape, magnet piece or magnetic assembly, magnetic piece with tape or form-tape, catch, hook-and-loop fastener, and weight element.

17. A hand reachable power station for desk or table or side-bed table or cabinet top while person sitting at a desk, comprising;
at least two outlets are assembled with at least one LED unit, to offer AC power outputs and LED illumination without any digital data delivery hub or other MCU, CPU device,
said LED illumination including area illumination, or charging/power status indication, or area and charging/power indicator lights according to pre-determined functions, performance, or effects, and
wherein power source for power station is one of housing AC current by wire select one from 110 to 250 voltage for single voltage to supply outlet-unit(s), and
the power station includes built-in or outside AC-to-DC for converting the desire AC current to desired 1^{st} DC current, and at least one of DC-to-DC circuit to change 1^{st} current to 2^{nd} or other DC current(s) and distribute or supply at least one of 1^{st} or 2^{nd} or other DC current(s); to at least one of LED unit(s), USB charge port(s) if have any, other preferred DC operated additional function(s) if have any,
wherein the power station includes at least one installation kit for preventing, when the power station is put on a desk or table or side-bed table or cabinet top or surface at a preferred location, the power station from falling off the desk or table or side-bed table or cabinet top or surface as a result of being pulled, moved, or removed by the power station heavy weight of the electric cord or by vibration or by impact strength.

18. A hand reachable power station for top of desk, table, side-bed table, cabinet or surface of wall, comprising;
at least two outlets are assembled within power station to offer AC power outputs without any digital data delivery hub or other MCU, CPU device,
and
wherein power source for power station is a housing or building AC current by wire select one from 110 to 250 voltage range to supply outlet-unit(s), and
wherein the power station includes at least one installation kit for preventing, when the power station is put on top of desk, table, side-bed table, cabinet or wall surface at a preferred location, the power station from falling off from top of desk, table, side-bed table, cabinet or wall surface as a result of being pulled, moved, or removed by the power station heavy weight of the electric cord or by vibration or by impact strength.

19. A power station for desk or table or side-bed table or cabinet top installation, comprising;
at least two USB units are assembled together with at least one LED unit, to offer multiple power outputs and LED illumination without any digital data delivery hub or other MCU, CPU device,
Said LED illumination is at least one of area, charging status, indication, re-start, on-off switch, surge protection switch, or others illumination.
the power station includes built-in or outside AC-to-DC for converting the desire AC current to desired 1^{st} DC current, and at least one of DC-to-DC circuit to change the 1^{st} DC current into 2^{nd} or more DC-current(s) and supply or distribute the 1^{st} or 2^{nd} or others DC current(s); to at least one of LED unit(s), USB charge port(s), other preferred DC operated additional function(s),
the said at least one of desired DC current to the at least one LED offers at least one of area, indicator, and multiple color illumination according to pre-determined functions, performance, or effects, and
wherein the power station includes at least one installation kits for securing the power station to a desk or table or side-bed table or cabinet top and thereby preventing, when the power station is positioned on the desk or table or side-bed table or cabinet top at a preferred location, the power station from falling off the desktop as a result of being pulled, moved, impacted or removed from the desktop by the heavy weight of an electric cord or incoming impact strength or vibration(s), said installation kits including at least one of a suction cup, screw, holder, glue, double sided tape, magnet piece or magnetic assembly, magnetic piece with tape or form-tape, catch, hook-and-loop fastener, and weight element.

20. A desk or table or side-bed table or cabinet top, or wall installation item, comprising;
at least one outlet or at least one USB unit, are assembled together with at least one LED unit, to offer power outputs and LED illumination without any digital data delivery hub or other MCU, CPU device,
said LED illumination is at least one of area, charging status, indicator, re-start, power on-off, and surge protection indication illumination.
the item includes built-in or outside AC-to-DC for converting input AC current to 1^{st} DC current, and at least one of DC-to-DC circuit to change 1^{st} DC current into 2^{nd} or more DC-current(s) and offer, supply, distribute the 1^{st} or 2^{nd} or others DC current(s); to at least one of LED unit(s), USB charge port(s), other preferred additional DC operated function(s),
the said at least one of desired DC current to the at least one LED light source or detachable/replaceable LED bulb to offering at least one of area, indicator, and other preferred illumination according to pre-determined functions, performance, or effects, and
wherein the desk/table/side-bed table top, or wall installation item includes at least one installation kits for securing the item install on a desk or table or side-bed table or cabinet or wall, and thereby preventing, when the item is positioned on the desk or table or side-bed table or cabinet or wall surface at a preferred location, the item from falling off the desk or table or side-bed table or cabinet or wall preferred location as a result of being pulled, moved, impacted or removed from the install-position by the heavy weight of an electric cord or incoming impact strength or vibration(s), said installation kits including at least one of a suction cup, screw, holder, glue, double sided tape, magnet piece or magnetic assembly, magnetic piece with tape or form-tape, catch, hook-and-loop fastener, and weight element.

21. A desk top or wall install item has USB charging function; comprising;
at least one of built-in or outside transformer AC-to-DC converting an AC current input current by AC-Plug-wire into 1^{st} DC current and at least one of DC-to-DC circuit to change the 1^{st} DC current into 2^{nd} or more DC current and supply or offer or distribute the 1^{st}, 2^{nd} or others DC-current(s); to at least one of built-in or replaceable LED light source(s), USB-unit(s), additional DC operated device(s) or function, and
the said at least one of 1^{st} or 2^{nd} or more DC current which is same or different with USB charging port(s) needed DC current.
At least one of installation kits or assembly including at least one or desired combination of a suction cup, screw, holder, glue, double sided tape, anti-skip pads, magnet piece or magnetic assembly, magnetic piece with tape or form-tape, catch, hook-and-loop fastener, and weight element; to install the item on top of desk, table, side-bed table, cabinet, or surface of wall.

22. A desk top or wall install item has USB charging function as claim 21, the said item has at least one of LED light source to offer at least one of area(s), indicator, charging status, surge protection, power on-off, and all kind switch on-off illumination, and

23. A desk top or wall install item has USB charging function as claim 21, the said built-in LED light source or detachable LED bulb or element incorporate with at least one circuitry to control the said LED light for color or brightness or timer or trigger-system including at least one of color changing, color selection, sleep setting, conductive/dimmer/setting/selective and on-off switch, and built-in at least one of charging or input-power USB-port(s).

24. A desk top or wall install item has USB charging function as claim 21, the said item has USB port(s) wherein the USB-port(s) without any digital data delivery.

25. A desk top or wall install item has USB charging function as claim 21, the said at least one additional DC operated function select from;
(a) at least one USB port(s) for charging current through USB output-end
(b) LED(s) light source to create at least one of area, accent, indicator, sleeping, wakeup light, timer illumination with preferred light color, brightness, selection, and function.
(c) Time, alarm clock related products powered with backup separated DC battery for AC power-fail still keeping continuously operate time related functions,
(d) LED or LCD time/date/week/month/year/weather display with illuminations powered and while AC power-fail still operate time function by backup DC power source.’
(e) Blue tooth audio device(s) or audio related circuitry
(f) Air flow device including fan or bladeless-fan or desired temperature air-flow device(s)
(g) 2^{nd} LED light for offering preferred at least one of area, charging status, power status, power fail, motion sensor, surge protection illumination.
(h) LED light source for one fixed side/surface or more than one side/surface rotatable and angle adjustment cosmetic mirror for lighted objects and reflect lighted image of be-reflected object(s) with or without magnify function(s) for N-time magnify (N is any number).
(i) Other DC powered device through USB-ports having preferred USB specification including Type A, C, Micro, Mini or other market available type, or by jack, adaptor, male and/or female plug and/or receiving-ends.
(j) LED light source or DC light source for Desktop reading/working lighting.
(k) Key or objects tray/holder
(l) Camera or video or digital camera with IR help for dark environment take image and/or audio data.
(m) Camera or video or digital camera with LED lighting support brightness to take color image and/or audio data
(n) Desktop items has wireless transmitting and/or receiving system.
(o) Desktop item has motion/moving/radar/vibration/sound/photo sensor for triggering the related device(s) or function(s), and
(p) Outlet-unit to deliver input AC housing current through conductive-piece to outlet output-port(s) to supply power to other products.

26. A desk or table or side-bed table or cabinet top, or wall installation item has USB port(s) as claim 22, the said wakeup light is turn on pre-program brightness and/or colors N-minutes before pre-set alarm trigger time.

27. A desk or table or side-bed table or cabinet top, or wall installation item has USB port(s) as claim 22, the said time related product(s) with or without alarm functions has built-in backup battery to keep time related function(s) continuously operation while power fail.

28. A desk or table or side-bed table or cabinet top, or wall installation item has USB port(s) as claim 21, the said item has preferred switch on item body or bottom to make desired functions.
